(19) United States
(12) Patent Application Publication
(10) Pub. No.: US 2026/0273737 A1
(43) Pub. Date: Sep. 17, 2026

(54) MULTI-MODAL ORCHESTRATION SYSTEM FOR HUMAN-ANIMAL-ROBOT COLLABORATIVE TASK EXECUTION

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/078,192

(22) Filed: Mar. 12, 2025

(51) Int. Cl. B25J 9/16; B25J 11/00; B63G 8/00

(52) U.S. Cl. CPC B25J 9/163; B25J 9/1661; B25J 11/0005; B63G 8/001; B63G 2008/004

(57) ABSTRACT

Disclosed embodiments provide a multi-modal orchestration system that enables coordinated adaptive, context-aware task execution between humans, animals, and robotic agents by leveraging advanced neurosymbolic AI, multi-modal sensor fusion, and reinforcement learning techniques. The system integrates SLAM-based environmental mapping, point cloud processing, and dynamic sensor networks to maintain real-time awareness of all agent positions, movement patterns, and behavior states. The system can utilize learned patterns of leadership and followership (derived from natural systems like octopus-fish hunting groups) to optimize collaborative behaviors, while continuously adapting to changing environmental conditions through a sensor fusion pipeline.

### CROSS-REFERENCE TO RELATED APPLICATIONS

Priority is claimed in the application data sheet to the following patents or patent applications, each of which is expressly incorporated herein by reference in its entirety:

None.

### BACKGROUND OF THE INVENTION

### Field of the Art

The present invention relates to the field of collaborative task execution and compound application, human, agentic, robotic and animal workflow specification, management, tracing, analysis, determination, and optimization. More specifically, the invention pertains to systems and methods that utilize dynamic, reflexive and nonergodic neurosymbolic artificial intelligence to enable orchestration for human-animal-robot-computing application collaboration across biological and robotic or physically embodied systems and software entities.

### Discussion of the State of the Art

Humans and animals have shared a symbiotic relationship throughout history, working together in myriad ways that have shaped civilizations and daily life. This partnership often stems from mutual benefit, with humans providing care and shelter while animals assist in sustenance, labor, transportation, companionship, and survival. Horses revolutionized transportation, enabling people to travel faster and over greater distances. Historically, horses were also central to agriculture and even to warfare, pulling chariots and supplies, carrying soldiers, speeding messengers, and serving as a vital component of cavalry units. Additionally, mules have been used for hauling heavy loads in mining, agriculture, and construction, especially in rugged terrains where machinery is impractical or impossible to maintain or operate. In a similar manner, oxen have been critical in farming, pulling plows and carts to cultivate large areas of land, especially before the advent of modern machinery. Dogs have been indispensable in hunting, helping track and retrieve game. Dogs also have been used for guarding livestock, property, and as loyal companions, and for identification tasks not possible for humans (e.g. drug dogs). These partnerships highlight how humans have harnessed the unique abilities of different animals to overcome practical challenges, build societies, and advance practical technologies.

Historically, humans have depended on animals for labor, transport, protection, and companionship, leveraging species-specific strengths in work, exploration, and survival across diverse environments. While these collaborations have significantly advanced human capabilities—from horses revolutionizing warfare and transportation to dogs enhancing hunting and security—they often relied on rudimentary methods of communication and coordination. In modern times, as technological innovations proliferate, the scope and complexity of missions involving humans, animals, and machines have increased dramatically. Missions in fields such as search and rescue, environmental monitoring, law enforcement, and healthcare commonly require a fluid, adaptive synergy between multiple species and technological agents. However, prevailing approaches to cross-species coordination remain fragmented and often rely on ad hoc protocols that do not effectively integrate or optimize interactions among humans, animals, and robotic systems.

At the same time, an explosion of new data sources—from animal vocalizations and neural signals to human speech, text, and gestural inputs—presents both opportunities and challenges. On one hand, wearable sensors, underwater transducers, environmental probes, and robotic interfaces produce rich, continuous data streams capable of guiding nuanced collaborative tasks. On the other hand, the lack of cohesive methods to fuse, interpret, and act on these heterogeneous inputs creates significant barriers to achieving dynamic, real-time orchestration in demanding scenarios. Traditional sensor fusion techniques and artificial intelligence models often fail to capture the full context of cross-species communication due to limitations in species-specific acoustic, gestural, and cognitive modeling. Moreover, existing systems rarely consider environmental variables such as underwater acoustics, rugged terrain mapping, or extreme climatic conditions—all of which can impede communication and coordination for both biological and mechanical agents.

As missions become more specialized—spanning terrestrial, aerial, and aquatic domains—the limitations of current systems become more apparent. Most existing frameworks do not incorporate advanced neurosymbolic AI methodologies, leaving cross-species intelligence sharing rudimentary at best. There is little support for integrated mapping of animal neural signals, refined behavioral models, or the application of large language models that can contextualize both human and animal cues in real time. Consequently, high-stakes operations—like orchestrating emergency response teams with canine units and aerial drones or synchronizing underwater drones with marine mammals for oceanographic research—are hindered by communication lags, misunderstandings, and suboptimal task allocation. These shortcomings underscore a pressing need for a truly unified platform that can handle the complexities of dynamic, multi-modal communication and workflow management across human, animal, and robotic agents, regardless of environmental constraints. There is a need for an integrated, scalable neurosymbolic AI-enabled orchestration system that can unify and optimize real-time collaboration between humans, non-human animals, software applications, and robotic agents by robustly interpreting diverse data streams, managing complex environmental variables, and seamlessly translating cross-species signals into actionable tasks, plans, and workflows with clarity, traceability and increasingly provable optimality to achieve shared goals.

### SUMMARY OF THE INVENTION

Disclosed embodiments provide a system and method for multi-modal, adaptive orchestration for human-animal-robot collaborative task execution. Disclosed embodiments may go well beyond merely training animals to perform tasks, but rather facilitate communication between humans and animals, humans and robots, and/or animals and robots, in pursuit of attaining a goal and/or completion of a task. Although not limited to this use case, disclosed embodiments are well-suited for interaction with sea creatures in ocean or lake environments.

The ocean is home to some of the most intelligent creatures on Earth, with whales, dolphins, and octopuses being prime examples of marine animals that exhibit remarkable cognitive abilities. Cetaceans such as whales and dolphins are renowned for their advanced intelligence, social behaviors, and communication skills. Dolphins demonstrate incredible problem-solving skills, tool use, and social cooperation. For example, some dolphins use sponges as tools to protect their snouts while foraging on the seafloor. Moreover, dolphins can communicate through complex vocalizations and echolocation, forming tight-knit social groups that share knowledge across generations, a behavior akin to cultural transmission. Humpback whales are known for their intricate “songs,” which can evolve over time and even spread across populations. Killer whales (orcas) have been observed teaching hunting techniques to younger members of their pods and exhibit unique dialects within different groups. Whales and dolphins rely on cooperation and communication to hunt and thrive in vast, often unpredictable oceans. Octopuses are solitary yet astonishingly intelligent creatures. They can solve puzzles, escape enclosures, and even use tools like coconut shells for shelter. Octopuses have exceptional short-term memory and can learn through observation, a trait rare in invertebrates. Their ability to camouflage and adapt to their surroundings showcases a high level of problem-solving and situational awareness. Octopuses use their intelligence to evade predators and manipulate their environment.

Disclosed embodiments can harness the vastly untapped resource of marine life intelligence to perform collaborative task execution by facilitating improved interspecies communication and task coordination. Such tasks can include search and rescue, exploration, surveillance, and more. Moreover, multiple species of animals, such as whales, dolphins, and octopuses can collaborate with humans and/or robots on these types of tasks, as well as others.

According to a preferred embodiment, there is provided a system for AI-enabled multispecies coordinated task execution, comprising: a computing device comprising at least a memory and a processor; and a plurality of programming instructions that, when operating on the processor, cause the computing device to: receive non-human animal communication data; process the non-human animal communication data through a machine-learning system, wherein the machine-learning system is configured to: parse the non-human animal communication data to derive one or more linguistic patterns; associate the one or more linguistic patterns with a human sentiment, meaning, or instruction; compute a confidence score corresponding to the human sentiment, meaning, or instruction; in response to the human sentiment, meaning, or instruction exceeding a predetermined threshold: rendering and presenting an audio/visual form of the human sentiment, meaning, or instruction on an electronic display; receiving a set of human communication data in response to the human sentiment, meaning, or instruction; associating the set of human communication data with one or more non-human animal communication patterns; and outputting the one or more non-human animal communication patterns via one or more output elements.

According to another preferred embodiment, there is provided a method for AI-enabled multispecies coordinated task execution, comprising: receiving non-human animal communication data; processing the non-human animal communication data through a machine-learning system, wherein the machine-learning system is configured to: parse the non-human animal communication data to derive one or more linguistic patterns; associate the one or more linguistic patterns with a human sentiment, meaning, or instruction; compute a confidence score corresponding to the human sentiment, meaning, or instruction; in response to the human sentiment, meaning, or instruction exceeding a predetermined threshold: rendering and present an audio/visual form of the human sentiment, meaning, or instruction on an electronic display; receive a set of human communication data in response to the human sentiment, meaning, or instruction; associate the set of human communication data with one or more non-human animal communication patterns; and output the one or more non-human animal communication patterns via one or more output elements.

According to another embodiment, the plurality of programming instructions further includes instructions to receive human communication data that includes directional-based information.

According to another embodiment, the one or more output elements comprise underwater transducers. In one exemplary embodiment, the invention is extended to encompass a comprehensive and advanced multi-domain sensing and communication system that integrates a diverse array of cutting-edge sensor technologies and transducer-like devices across ground, maritime, aerial, and space environments, as well as emerging sensor modalities. For ground-based applications, the system incorporates high-resolution seismic transducers—including geophones and broadband seismometers—for capturing precise vibrational data; ground-penetrating radar (GPR) units and electromagnetic induction sensors for detailed subsurface mapping and mineral exploration; and strain gauges together with MEMS-based accelerometers and gyroscopes for continuous monitoring of structural integrity and dynamic motion. In maritime settings, the system expands beyond traditional hydrophones and sonar arrays by integrating underwater LIDAR units for high-resolution three-dimensional mapping of underwater terrain, multispectral and hyperspectral optical imaging sensors for in-depth analysis of marine ecosystems, and in situ chemical sensors that measure dissolved oxygen, pH, salinity, and chlorophyll concentration, thereby providing comprehensive assessments of oceanographic conditions. For aerial engagements, the sensor suite is further enhanced by deploying Doppler radars, high-resolution LIDAR systems, thermal and multispectral cameras, and atmospheric sensing modules capable of measuring wind speed, humidity, and particulate matter on unmanned aerial vehicles (UAVs) or manned aircraft, which facilitate real-time terrain mapping, obstacle detection, and dynamic situational awareness. In space-based applications, satellite-borne sensors—including hyperspectral imagers, radiometers, space-based LIDAR systems, and cosmic radiation detectors—are integrated to enable high-fidelity remote sensing over vast geographical expanses, supporting climate monitoring, resource management, and exploratory missions. Moreover, the system is further augmented with emerging sensor technologies such as neuromorphic vision and auditory sensors that mimic biological processing, fiber optic sensor arrays for distributed and highly sensitive monitoring, and smart dust or microelectromechanical (MEMS) sensor networks for ultra-high-resolution sensing under diverse and challenging conditions. The true innovation of this embodiment lies in its multi-tiered data fusion and communication framework, which dynamically captures, processes, and integrates heterogeneous data streams from these disparate sensor modalities into a unified, multidimensional environmental model. Advanced algorithms perform cross-domain sensor alignment, spatial-temporal correlation, and adaptive weighting of sensor inputs to achieve comprehensive situational awareness, thereby enhancing interspecies coordination and the orchestration of complex tasks. Furthermore, the system supports both half-duplex and full-duplex communication modes, wherein half-duplex configurations enable energy-efficient alternating transmission and reception—ideal for battery-powered IoT devices and low-bandwidth scenarios—while full-duplex configurations facilitate simultaneous bidirectional data exchange with enhanced bandwidth utilization and reduced latency. In full-duplex mode, advanced techniques such as self-interference cancellation, echo cancellation, adaptive filtering, and spatial isolation using multi-antenna systems are employed, in addition to dynamic spectrum access methods and centralized coordination protocols, to mitigate cross-link interference and optimize spectral efficiency. Additionally, the system incorporates intelligent scheduling algorithms, including reinforcement learning and game theory-based approaches, which dynamically adapt transmission schedules and power control strategies to balance spectral efficiency, power consumption, and latency across dense, multi-entity networks. Cooperative communication protocols and centralized coordination via base stations or software-defined networking further enhance real-time data exchange, ensuring robust performance even in challenging multi-domain operational environments. Collectively, this inventive sensor engagement framework—by leveraging an integrated suite of advanced sensor technologies, sophisticated data fusion, and state-of-the-art communication protocols—represents a significant advancement over traditional transducer-based systems, enabling unparalleled real-time situational awareness, environmental monitoring, and interspecies coordination across ground, sea, air, and space domains.

According to another embodiment, there is provided a simultaneous localization and Mapping (SLAM) system, and the plurality of programming instructions further includes instructions to process directional-based information that is obtained from the SLAM system. According to another embodiment, the SLAM system is enhanced by a multi-domain sensor fusion framework that dynamically integrates directional-based information from a diverse array of sensors. In this embodiment, ground-based sensors—including high-resolution seismic transducers (such as geophones and broadband seismometers), ground-penetrating radar (GPR) units, electromagnetic induction sensors, and MEMS-based accelerometers and gyroscopes—provide detailed subsurface and vibrational data. These sensors deliver precise, high-fidelity information that enables the SLAM system to generate accurate, fine-grained maps of terrestrial features and geological anomalies. This ground data is further enriched through the fusion of strain gauges and other structural monitoring devices, which inform the system about local dynamics and environmental changes, thus improving feature extraction, loop closure, and overall localization accuracy. Moreover, the SLAM system is substantially augmented by the integration of advanced maritime, aerial, and space-based sensor modalities. In maritime environments, underwater LiDAR units, multispectral and hyperspectral optical imaging sensors, and in situ chemical sensors (measuring parameters such as dissolved oxygen, pH, salinity, and chlorophyll concentration) contribute comprehensive three-dimensional mapping data and contextual environmental metrics. Aerial sensors, including Doppler radars, high-resolution LIDAR systems, thermal and multispectral cameras, and atmospheric sensing modules, provide real-time terrain mapping, obstacle detection, and dynamic environmental context from elevated vantage points. For space-based applications, satellite-borne sensors—such as hyperspectral imagers, radiometers, space-based LIDAR, and cosmic radiation detectors—offer macro-level geospatial and climatic data that can be used to calibrate and validate local maps. Additionally, emerging sensor technologies such as neuromorphic vision and auditory sensors, fiber optic sensor arrays, and smart dust or MEMS sensor networks yield ultra-high-resolution data that further refines the SLAM system's ability to detect subtle features and adapt to rapid environmental changes. In conjunction with these sensor technologies, the system employs advanced full-duplex and half-duplex communication modes to optimize the transmission and fusion of heterogeneous data streams. Full-duplex communication, enabled by self-interference cancellation techniques, adaptive filtering, and spatial isolation through multi-antenna configurations, ensures that high-bandwidth, bidirectional data exchange occurs with minimal latency. This capability is critical for real-time SLAM processing, as it allows simultaneous sending and receiving of sensor data from multiple domains without interruption. In scenarios where power efficiency and lower bandwidth requirements are paramount—such as with battery-operated IoT devices—the system may alternatively employ half-duplex communication protocols, ensuring robust data collection while minimizing energy consumption. Collectively, these integrated sensor and communication innovations provide the SLAM system with an unprecedented depth and breadth of environmental data. The fusion of ground, maritime, aerial, space-based, and emerging sensor inputs results in highly accurate, contextually enriched, and temporally synchronized spatial maps. This comprehensive mapping capability not only enhances the system's localization and navigation functions but also improves interspecies coordination and overall task execution by delivering a dynamic, real-time situational awareness framework that adapts to complex, multi-domain operational environments.

According to another embodiment, the plurality of programming instructions further includes instructions to receive additional human communication data, and output the additional human communication data to one or more electromechanical devices. In one exemplary embodiment, the electromechanical devices to which additional human communication data may be output extend well beyond basic actuators, and include a diverse range of devices tailored for various operational domains. For instance, the system may interface with robotic manipulators and articulated robotic arms designed for precision tasks in manufacturing, search and rescue, or interspecies coordination scenarios. Autonomous ground vehicles (AGVs) and mobile robotic platforms—such as unmanned ground vehicles (UGVs) equipped with sensor arrays—can also be integrated, enabling the dynamic execution of navigation and environmental interaction commands. Additionally, aerial platforms like unmanned aerial vehicles (UAVs) or drones may be employed, which can receive directional commands or mission updates in real time, thereby facilitating coordinated aerial maneuvers and surveillance operations. Furthermore, the system may output communication data to underwater electromechanical devices, such as unmanned underwater vehicles (UUVs) or remotely operated vehicles (ROVs), which can respond to nuanced human directives in maritime environments. Beyond conventional robotics, the data may be transmitted to infrastructure control systems, such as smart building actuators (e.g., HVAC systems, automated lighting systems, or dynamic window shading systems) that adjust environmental conditions based on human inputs. In the realm of wearable or assistive technologies, the communication data can also be directed to electromechanical exoskeletons or prosthetic devices, enhancing human performance and rehabilitation efforts. This broad array of exemplary devices illustrates the system's flexibility in orchestrating coordinated actions across multiple domains, ensuring that human communication data is effectively translated into targeted mechanical responses in diverse operational contexts. In one exemplary embodiment, the system further incorporates a broad spectrum of advanced electromechanical devices that extend the interface between human communication data and mechanical actuation across multiple domains. In addition to the previously enumerated collaborative robots (cobots), mobile manipulators, soft robotics, smart prosthetics, advanced exoskeletons, rehabilitation devices, space-based actuators, medical robotics, environmental monitoring devices, neuromorphic sensors, shape memory alloy actuators, and MEMS sensor networks, the system may also integrate the additional exemplary that follow. The system may include autonomous mobile robots specifically designed for complex terrain navigation and dynamic obstacle avoidance in both terrestrial and off-road environments. These devices can operate as unmanned ground vehicles (UGVs) or amphibious platforms that are capable of transitioning between land and water, thereby expanding operational flexibility. Additionally, swarm robotics systems, composed of multiple small-scale, cooperative agents, can be deployed to perform distributed sensing, exploration, and manipulation tasks in environments where collective behavior enhances resilience and task performance. For aerial applications the system may integrate advanced unmanned aerial vehicles (UAVs) equipped with multi-modal sensor suites and robotic manipulators that allow for precision tasks such as package delivery, infrastructure inspection, or even environmental remediation. These aerial platforms may incorporate full-duplex communication modules and real-time data fusion algorithms, ensuring that directional human communication data is seamlessly translated into coordinated flight paths and task-specific maneuvers. The system may also encompass telepresence and augmented reality (AR) interfaces that combine electromechanical actuation with haptic feedback systems. Such devices enable remote operation and intuitive control of distant robotic assets—ranging from medical robots performing minimally invasive surgeries to industrial robotic arms handling hazardous materials—while providing operators with immersive, real-time sensory feedback. In this context, wearable AR headsets integrated with haptic interfaces and gesture recognition further bridge the gap between human intention and robotic execution. In specialized domains such as agriculture and disaster response, the system may be extended to include field-deployable agricultural robots capable of autonomous crop monitoring, harvesting, and targeted chemical application, as well as search-and-rescue robots designed for rapid deployment in post-disaster scenarios. These devices leverage high-resolution imaging, LIDAR, and environmental sensors to adaptively respond to dynamic field conditions, thus enhancing both productivity and safety. For space-based applications, the system may incorporate deployable micro-robots and modular, reconfigurable satellite platforms that enable in-orbit servicing, assembly, and maintenance. These devices operate in the harsh conditions of space by utilizing advanced actuators, such as electrostatic or magnetically actuated mechanisms, and rely on precise full-duplex communication links to synchronize with terrestrial control centers and other autonomous agents. By integrating these additional electromechanical devices and actuators, the system dramatically expands its capacity to translate additional human communication data into nuanced, context-specific mechanical actions. This comprehensive array of devices—spanning ground, sea, air, and space—enables a highly flexible and scalable multi-domain orchestration platform. The enriched data flow and adaptive control afforded by these advanced components significantly enhance real-time situational awareness, precision in task execution, and the overall responsiveness of the system to dynamic human commands and environmental conditions.

According to another embodiment, the plurality of programming instructions further includes instructions to receive additional human communication data and output the additional human communication data to one or more electronic devices.

According to another embodiment, the machine-learning system includes a large language model (LLM) with adaptive neurosymbolic reasoning. According to another embodiment, in addition to incorporating a large language model (LLM), the machine-learning system may integrate several other types of symbolic rules or logic, or neural models, or neurosymbolic models or reasoning pipelines, to enhance its ability to process, interpret, and generate multispecies communication and sensor data. For example, a neurosymbolic reasoning module may be employed, which synergizes the pattern recognition capabilities of deep neural networks with the explicit, rule-based reasoning of symbolic logic systems. This hybrid approach can be particularly effective in scenarios where ambiguous animal signals must be mapped to human-understandable concepts, thereby improving interpretability and robustness in decision-making. In another variant, transformer-based models beyond the conventional LLMs can be integrated to process sequential data streams from heterogeneous sensor inputs. These models leverage advanced attention mechanisms to dynamically correlate language tokens with multispectral sensor data, facilitating the simultaneous interpretation of complex acoustic, neural, and environmental signals. Graph neural networks (GNNs) may also be incorporated to model the relational and hierarchical structures inherent in both human language and animal communication patterns. Such networks enable the system to capture interdependencies among sensor modalities and among agents, thereby providing a richer representation of the multispecies interaction network. Further enhancing the system's capabilities, generative models such as generative adversarial networks (GANs) and variational autoencoders (VAEs) can be used to synthesize realistic training datasets and perform dimensionality reduction on high-bandwidth, noisy sensor data. This not only improves model generalization by augmenting training data but also enables efficient encoding of high-dimensional inputs into compact representations suitable for downstream processing. Reinforcement learning (RL) models, including both model-based and model-free approaches, can be integrated to optimize task orchestration and dynamic decision-making in real time. These RL modules can learn optimal policies for routing communication data to the appropriate electromechanical devices, effectively bridging the gap between interpretation and action. For applications that benefit from bio-inspired processing, spiking neural networks (SNNs) are envisioned as an alternative model, particularly for processing event-driven data from neuromorphic sensors. SNNs mimic the temporal dynamics of biological neural circuits, providing low-latency, energy-efficient computation that is well-suited for real-time applications in complex, dynamic environments. Collectively, these complementary models create a robust, versatile machine-learning architecture that enhances the system's overall capability to handle the diverse and multifaceted data streams required for effective multispecies coordinated task execution.

According to another embodiment, the plurality of programming instructions further includes instructions to generate a directed graph or directed acyclic graph to represent a plurality of reasoning steps or chain of thoughts corresponding to the multispecies coordinated task execution. This may be further embedded or represented in other graphs, hypergraphs or vector representations to enable caching or reasoning learning, caching, forward prediction or precomputation or other analysis or modeling simulation or planning functions.

In one embodiment, the invention incorporates a dynamic, entropy-based patching module into the multispecies orchestration system to process raw byte streams derived from diverse modalities, including acoustic signals, neural activity recordings, haptic sensor outputs, and textual human instructions. This module segments incoming data into variable-length patches based on locally computed entropy metrics, wherein an internal predictive model assesses the information density of each byte sequence. When the predictive model identifies regions of high entropy—indicative of rapid signal fluctuations, complex acoustic modulations, or abrupt changes in neural patterns—the module terminates the current patch and initiates a new one, thereby allocating increased computational resources to segments that require finer-grained analysis. Conversely, in low-entropy regions where the signal exhibits predictable, redundant patterns, longer patches are formed to reduce overall computational load. This adaptive segmentation ensures that the subsequent encoding and transformation processes can optimize resource usage while preserving critical nuances in interspecies communication signals, ultimately enhancing the system's real-time responsiveness and interpretive fidelity. The local encoder, configured to receive the raw segmented patches, utilizes a robust hash-based n-gram embedding mechanism to preserve essential features at the byte level. In this embodiment, each patch is processed to extract salient features through a series of hash functions that map overlapping byte n-grams to fixed-dimension embedding vectors, thereby capturing the inherent statistical regularities of species-specific communication patterns. The encoder further employs a cross-attention mechanism that dynamically weights the importance of each n-gram feature within a patch based on contextual cues drawn from concurrently received environmental sensor data and historical communication logs. By maintaining a high-resolution mapping of acoustic and neural signal characteristics, the local encoder produces patch representations that encapsulate both local and contextual information, thereby ensuring that even subtle shifts in behavioral or emotional states across species are retained for further analysis. Subsequent to local encoding, the system integrates these patch representations into a latent transformer module that performs global processing and inter-modal fusion. This transformer is architected with block-causal attention layers that operate on the reduced patch sequence, thereby decreasing the computational burden while maintaining the necessary temporal ordering for auto-regressive generation. The latent transformer features multi-head cross-attention sub-modules that merge information across different species and sensor modalities, allowing for a unified interpretation of heterogeneous data streams. In addition, the transformer module is configured to interface with a Monte Carlo tree search (MCTS) engine that dynamically explores multiple potential interpretations of the aggregated patch data, using super-exponential regret minimization techniques to iteratively refine decision pathways. This orchestration of latent representations and MCTS-driven policy refinement allows the system to rapidly converge upon optimal task execution strategies, even in scenarios where input signals are highly noisy or ambiguous. The local decoder module is designed to reconstruct species-specific output signals from the latent patch representations generated by the transformer. This module leverages cross-attention networks to selectively integrate context from the global latent space with pre-defined output patterns tailored to the perceptual and cognitive modalities of target species. For example, in marine environments, the local decoder converts patch-based representations into precisely modulated acoustic signals that can be transmitted via underwater transducers, ensuring that the reconstructed signals match the frequency and temporal characteristics required for effective cetacean communication. In parallel, human-directed outputs—such as visual displays or haptic feedback signals—are generated using a similar cross-attention mechanism, ensuring that human operators receive clear, actionable interpretations of animal responses. The local decoder further integrates metadata such as patch entropy, spatial coordinates from an integrated SLAM system, and temporal markers, thus providing a comprehensive, context-rich output that facilitates seamless interspecies coordination and adaptive task execution. In further embodiments, the invention may employ a hybrid patching strategy wherein traditional tokenization is selectively applied to textual data derived from human operators, while raw, byte-level entropy-based patching is reserved for processing non-human animal signals and environmental sensor data. This dual-mode approach ensures compatibility with conventional natural language processing workflows while simultaneously harnessing the superior scalability and robustness of patch-based encoding for high-entropy, noisy, or low-resource inputs. The resultant system is capable of dynamically allocating processing resources in real time, effectively fusing heterogeneous data streams from diverse species and sensor arrays into a coherent, actionable framework for collaborative task execution. By integrating these novel techniques into a unified multispecies orchestration architecture, the invention achieves unprecedented levels of precision, scalability, and resilience in managing and interpreting complex interspecies communication, thereby enabling robust operation in environments characterized by high uncertainty and dynamic signal variability.

In one exemplary embodiment, the invention incorporates a quantum-inspired byte entanglement (QIBE) module that radically redefines the representation of byte-level inputs by modeling each byte as a probabilistic, entangled state rather than a discrete symbol. In this configuration, individual bytes are encoded as complex-valued vectors wherein both the real and imaginary components capture distinct aspects of the underlying signal uncertainty and context. This representation enables the subsequent attention mechanism to operate on complex amplitudes, leveraging principles analogous to quantum superposition and interference. The QIBE module computes attention weights through complex-valued dot products and interference patterns, thereby affording a richer, more nuanced interplay between disparate byte sequences. By encoding uncertainty directly into the representation, the system is better equipped to handle noisy or ambiguous data—such as rapidly fluctuating acoustic signals or subtle variations in neural activity—while dynamically refining its internal state representations during the processing of multispecies communication streams.

Building upon this quantum-inspired foundation, the invention further integrates fractal compression encoding (FCE) techniques to achieve a highly compact and scalable representation of high-bandwidth byte streams. In this embodiment, the raw input is divided into range blocks, each of which is mapped to larger domain blocks using transformation parameters that capture self-similarity and recursive patterns in the data. A dynamically maintained fractal dictionary stores these transformation parameters, enabling the system to encode new input sequences by simply referencing previously learned fractal patterns. The fractal encoder, therefore, not only reduces the overall data redundancy but also provides an adaptive compression mechanism that is sensitive to local structural variations—such as those encountered in the complex vocalizations of cetaceans or the subtle tactile feedback from wearable sensors on animals. This process allows the system to allocate computational resources more efficiently, focusing processing power on segments of the data that exhibit high informational content as determined by the subsequent entropy-based patching module.

In a further inventive embodiment, neuromorphic spiking byte networks (NSBN) are employed to emulate the event-driven, biologically inspired processing of information. Here, conventional artificial neurons are replaced with spiking neuron models, such as leaky integrate-and-fire units, which generate discrete temporal spikes in response to input currents. Byte-level data, processed through either the QIBE or FCE modules, is converted into temporal spike trains that represent the underlying signal in an event-driven fashion. These spike trains are then processed by a layered spiking neural network that employs spike-timing-dependent plasticity (STDP) as its core learning rule, dynamically adjusting synaptic weights based on the precise timing of incoming and outgoing spikes. Such an architecture inherently supports asynchronous, energy-efficient processing and is particularly well-suited for real-time applications where rapid adaptation to dynamic multispecies communication signals is essential. The NSBN module thus enables the system to capture and respond to transient, high-frequency events—whether they be abrupt changes in underwater acoustics or rapid fluctuations in an animal's neural output—ensuring that even the most ephemeral signals are accurately registered and acted upon.

Complementing the aforementioned modules, the invention further incorporates hyperdimensional computing for byte representation (HCBR), which provides a robust, noise-resistant framework for encoding and retrieving information. In this embodiment, each byte is mapped to a high-dimensional binary hypervector, typically of dimensionality on the order of 10,000. Complex operations such as circular convolution and exclusive OR (XOR) are employed to bind and superpose these hypervectors, yielding composite representations that are both distributed and highly resilient to perturbations. An associative memory, implemented as a content-addressable memory system using hypervectors, enables efficient storage and rapid retrieval of frequently occurring byte patterns. Holographic reduced representations are additionally utilized to compress and later reconstruct the original sequences, ensuring that the integrity of the high-dimensional encoding is maintained throughout the processing pipeline. This hyperdimensional approach endows the system with an extraordinary ability to tolerate noise and to generalize from sparse training data, which is particularly advantageous when processing communication signals from species that exhibit inherently variable and under-resourced lexicons.

The overall system architecture is thus a hybrid model that integrates QIBE, FCE, NSBN, and HCBR in a seamless, multi-tiered processing pipeline. Initially, raw byte streams from a variety of sensor modalities—including acoustic signals, neural readings, haptic feedback, and human textual inputs—are processed by the QIBE module to capture probabilistic, entangled representations. These representations are then compactly encoded using fractal compression techniques, which leverage self-similarity to reduce data redundancy while preserving critical signal features. The resulting compact representations are subsequently converted into temporally precise spike trains by the NSBN module, facilitating asynchronous, event-driven processing that mimics biological neural dynamics. Finally, the hyperdimensional computing module transforms these spike-encoded signals into robust, high-dimensional hypervectors, which are stored and retrieved using an associative memory framework to ensure resilience against noise and data corruption.

In combination with a global latent transformer module and a Monte Carlo Tree Search (MCTS) or other scenario or tree exploration and orchestration engine, the integrated system is capable of dynamically fusing and interpreting multispecies signals in real time. The latent transformer operates on the patch-level representations derived from the aforementioned modules, applying block-causal attention mechanisms that maintain temporal ordering while drastically reducing computational complexity. The MCTS, MCTS+RL, or UCT with super exponential regret component further refines the decision-making process by exploring multiple potential interpretations and action sequences, guided by dynamically computed regret minimization metrics. This results in an overall system that not only surpasses state-of-the-art token-based and fixed patching methods in terms of efficiency and robustness but also achieves unprecedented scalability and adaptability across heterogeneous communication domains. By leveraging these novel, quantum-inspired, fractal, neuromorphic, and hyperdimensional techniques, the invention establishes a groundbreaking framework for multispecies orchestration that is capable of handling high-entropy, multi-modal signals with a level of precision and efficiency that exceeds current state-of-the-art models.

The invention is further extended by incorporating a suite of advanced, quantum-inspired and neuromorphic modules that synergistically transform raw byte-level inputs into a robust, high-fidelity representation suitable for multispecies orchestration and heterogeneous communication tasks. In one exemplary embodiment, a Quantum-Inspired Byte Entanglement (QIBE) module is employed to convert discrete byte inputs into a complex vector space. The QIBE module uses separate linear projections to generate real and imaginary components, which are then modulated by a learnable phase parameter. This phase encoding produces a superposition state for each input byte while simultaneously computing an uncertainty metric based on the elementwise product of the projected components. The resulting complex-valued representations inherently capture both the probabilistic nature and the contextual uncertainty of each byte, thus enabling subsequent processing stages to dynamically allocate computational attention where it is most needed. Such an approach is particularly advantageous in scenarios where input signals—such as nuanced acoustic modulations from cetaceans or transient neural activations in service animals—exhibit high variability or noise.

In further embodiments, an Adaptive Fractal Encoder is integrated into the system to realize dynamic, multi-resolution compression of byte-level data. The encoder maintains a fractal dictionary at several scales, with each dictionary entry representing a learned fractal pattern over a specific block size. An adaptive block size is computed by estimating the local entropy of the input sequence; high-entropy regions are segmented into smaller blocks to capture fine-grained detail, while low-entropy regions are aggregated into larger blocks to achieve compression efficiency. The fractal encoder outputs transformation parameters rather than raw data, effectively compressing the signal while preserving its intrinsic structural characteristics. This adaptive fractal approach provides a scalable solution that not only reduces the computational footprint of processing large volumes of data but also enhances the model's capacity to generalize across diverse and previously unseen communication patterns. Complementing these approaches, the invention employs a Hierarchical Neuromorphic Spiking Byte Network (NSBN) that mimics biological neural processing through event-driven, spiking neuron models. In an enhanced NSBN module, each adaptive spiking neuron is designed with a dynamic firing threshold and a homeostatic plasticity mechanism. The adaptive spiking neuron updates its membrane potential based on incoming currents while simultaneously modulating an adaptation current that adjusts its firing threshold. This multi-scale temporal integration allows the system to capture both rapid transient events and slower, sustained signal dynamics. Moreover, the spiking network processes the encoded byte sequences as spike trains, where spike-timing-dependent plasticity (STDP) refines synaptic weights based on the temporal correlation of pre- and post-synaptic spikes. This neuromorphic processing pathway affords energy-efficient, low-latency computation that is especially well suited to real-time applications in complex, dynamic environments. To further bolster noise resilience and representation capacity, the system incorporates an Enhanced Hyperdimensional Computing module. In this embodiment, input bytes are first mapped to high-dimensional binary hypervectors using a series of hierarchical linear projections. These hypervectors are then combined via circular convolution and hierarchical binding operations to yield multi-resolution representations. By integrating an attention-guided memory access mechanism, the hyperdimensional module is capable of robustly storing and retrieving associative patterns even in the presence of substantial noise or corruption. The multi-resolution hypervector encoding not only preserves fine-grained details at the lowest resolution but also captures abstract, global features at coarser resolutions, thereby providing a comprehensive representation of the input signal across multiple levels of abstraction. At the system level, these diverse processing pathways are unified within a multi-modal integration layer that employs adaptive routing and dynamic fusion techniques. A Multi-modalFusion module orchestrates the outputs from the Quantum-Inspired Encoder, Adaptive Fractal Encoder, and Hierarchical NSBN, each of which is implemented within its own dedicated subnetwork. An adaptive router dynamically computes pathway-specific weights based on input characteristics such as local entropy, signal complexity, and modality-specific quality metrics. These weights guide a MultiPathwayFusion module that uses sparse, attention-based mechanisms to combine the outputs from each processing pathway into a single, unified representation. This representation is subsequently fed into a global latent transformer module and a Monte Carlo Tree Search (MCTS) or UCT with super exponential regret or other similar method enabled orchestration and exploration engine, which together facilitate real-time decision-making and task orchestration across multiple species and robotic agents. In further innovative variants, the architecture is extended through novel constructs such as the Byte-State Space Model (ByteSSM) and the Quantum-Mamba Hybrid (Q-Mamba). In the ByteSSM, a selective scanning mechanism driven by an entropy-based gateway is integrated into a state-space model that selectively updates an internal state via linear transformations. This allows the system to capture long-range dependencies at the byte level while filtering out redundant information. In the Q-Mamba variant, quantum-inspired selective scanning is merged with state-space representations and a dedicated quantum interference layer, enabling the system to perform temporal integration over complex, entangled byte representations while preserving phase information. Moreover, the Fractal Byte Retentive Network (FBR-Net) leverages fractal encoding to detect and retain hierarchical byte patterns using a dedicated retentive memory module with gating mechanisms that selectively update stored information based on pattern similarity. Finally, the Neuromorphic Byte Stream Processor (NBSP) and a comprehensive Hybrid Byte Processor architecture integrate these multiple pathways into a cohesive processing pipeline. The NBSP converts raw byte sequences into spike trains that are processed by temporally adaptive integration layers with GPU-optimized spike propagation, while the Hybrid Byte Processor dynamically routes input through the Quantum-Mamba, Fractal Byte Retentive, and Neuromorphic Byte Stream modules. An adaptive router within the Hybrid Processor computes optimal pathway weights, and a fusion module aggregates the resulting outputs via an attention mechanism that is fine-tuned to balance efficiency, robustness, and precision. These integrated improvements and novel architectural variants collectively represent a substantial advance over existing state-of-the-art models. They enable efficient, real-time processing of highly diverse and noisy byte-level inputs from multiple modalities, while providing a robust and scalable framework for interspecies communication and multispecies task orchestration. The disclosed innovations, which leverage quantum-inspired encoding, adaptive fractal compression, neuromorphic spiking dynamics, and hyperdimensional computing, establish a new paradigm for language model architectures that can fundamentally transform the way heterogeneous, high-bandwidth signals are processed and interpreted.

In one exemplary embodiment, the system is extended to incorporate a dynamic, adversarial fact-checking and chain-of-thought (CoT) optimization engine that operates in tandem with the core multispecies orchestration framework. This extension begins by decomposing intermediate reasoning outputs into atomic knowledge elements, each representing a fundamental assertion, concept, or building block of the overall CoT. Each atomic element is evaluated in real time using a combination of lightweight micromodel large language models (LLMs) and deterministic rule-based engines. These evaluations yield multiple metrics, including a confidence score that reflects evidence support, a toxicity index that measures potential harmfulness or bias, and a feasibility score that assesses logical and domain-specific consistency. For example, an element may be processed by a neural fact-checker to compute its confidence probability, while parallel toxicity detectors and symbolic rule engines compute corresponding indices; these are then aggregated via learned weighting factors to produce a composite verification score. Should the score fall below a predetermined threshold, the system dynamically injects verification subgraphs into the overarching CoT hypergraph, routing the questionable atomic element through adversarial refinement routines that may involve external simulation models, symbolic reasoning, or secondary LLM prompts. This mechanism not only mitigates the risk of propagating inaccurate or toxic assertions but also ensures that the final synthesized output is built exclusively from high-confidence, validated components.

In a further enhancement, the system incorporates adaptive reinforcement learning (RL) mechanisms that monitor the outcomes of the adversarial verification process and dynamically adjust gating thresholds and routing policies within the CoT hypergraph. Verified outputs, along with any subsequent modifications, are logged with associated quality metadata in a multi-tiered memory subsystem that supports both ephemeral and rolling caches. Over time, the RL agent learns from historical verification outcomes-identifying, for instance, which atomic assertions consistently require refinement or which suborchestration pathways yield the highest quality corrections. This information is used to update high-dimensional routing tables that index potential compute paths based on latency, resource utilization, energy cost, and past success metrics. By doing so, the system is able to precompute and cache optimal processing routes in a synthetic data pool, enabling rapid retrieval of verified CoT snippets for recurring or similar queries. The integration of RL-driven routing with dynamic caching not only minimizes redundant computations but also fosters an ongoing improvement in the quality of intermediate reasoning steps, effectively reducing hallucinations and mitigating the risk of poisonous information leakage.

Furthermore, the architecture is extended through the incorporation of a high-dimensional hypergraph routing mechanism and a multi-level mixture-of-experts (MoE) framework designed to perform predictive and speculative execution of chain-of-thought pathways. In this embodiment, each node within the CoT hypergraph is assigned an importance score using an iterative algorithm analogous to PageRank, while expert modules—comprising domain experts, task experts, and knowledge keepers-actively advertise their available compute capacity and performance metrics. These expert modules are seamlessly integrated into the hypergraph routing structure, where an expert selection algorithm uses techniques such as softmax over the advertised routing scores to dynamically select the optimal combination of experts for each CoT token or byte or atomic assertion. A speculative execution engine continuously forecasts candidate processing routes by ingesting real-time observability data (such as current latency, CPU/GPU load, and network bandwidth) and computes candidate pathways with associated confidence metrics. The best candidate routes are then precomputed and their partial outputs cached in the synthetic data pool, allowing the system to rapidly execute follow-on tasks with minimal delay. This predictive hypergraph routing not only streamlines the overall inference process but also enables the orchestrator to adapt to shifting system conditions and SLA constraints in a manner reminiscent of network routing protocols like BGP with MANRS enhancements. To further reduce latency and enhance throughput, the system may also be integrated with a specialized chiplet-based concurrency subsystem that supports the co-passing of chain-of-thought instructions and tokenized state caching. In this embodiment, multiple chiplets—each optimized for distinct tasks such as vector arithmetic, memory encryption, or hypergraph traversal—are interconnected via ultra-low-latency photonic links. A specialized communication protocol is implemented for chiplet-to-chiplet state passing, where CoT instructions, partial outputs, and ephemeral expansions are encoded in a compact binary format. This protocol enables real-time synchronization of the state across disparate processing units, allowing for seamless pipelined execution and dynamic state caching that minimizes data movement overhead. In this way, the orchestration engine can leverage the chiplet architecture to rapidly merge and update partial CoT outputs, thereby ensuring that the entire reasoning chain remains coherent, validated, and optimally routed even in distributed, heterogeneous computing environments. Collectively, these enhancements-comprising adversarial fact-checking with dynamic suborchestration, RL-based adaptive routing and caching, predictive hypergraph routing with a mixture-of-experts framework, and specialized chiplet-based state caching-represent a substantial advance over existing CoT models. By selectively incorporating these techniques, the system not only verifies and refines individual atomic knowledge elements in real time but also proactively optimizes the overall chain-of-thought synthesis process. The result is a robust, scalable, and highly efficient platform that ensures the final output is both technically sound and ethically compliant, while dynamically adapting to the inherent variability and complexity of multispecies collaborative tasks.

In one exemplary embodiment, the invention extends its multispecies orchestration framework by incorporating a predictive hypergraph routing module that streamlines inference while dynamically adapting to shifting system conditions and SLA constraints, analogous to BGP Route Conditional Advertisement. In this embodiment, the inference process is modeled as a hypergraph in which nodes represent partial chain-of-thought (CoT) expansions and edges represent possible inference pathways between these nodes. Each node is assigned an importance score via an iterative algorithm similar to PageRank, where the score is derived from both the quality of the reasoning output and the operational metrics of its hosting processing unit (e.g., latency, throughput, and resource load). These scores, together with dynamic performance metrics—such as current compute latency and resource availability—are aggregated in a high-dimensional routing table that is continuously updated in real time. Drawing direct inspiration from BGP conditional advertisement techniques, each processing node within the hypergraph is enabled to “advertise” its current compute capacity, reliability, and expected processing latency as metadata attached to the hypergraph's edges. When system observability data indicates that a primary inference pathway is becoming suboptimal—for example, due to high load or partial node failure—the predictive hypergraph routing module conditions the activation of backup routes. This conditional routing mechanism selectively advertises alternative pathways only when the performance of the primary route falls below a pre-defined threshold, thereby minimizing unnecessary routing table churn and optimizing overall resource utilization. In this manner, the system achieves improved traffic engineering by dynamically steering inference requests along the most efficient and reliable pathways, akin to how network operators leverage BGP to influence inbound traffic flows under varying network conditions. To further enhance this dynamic routing process, a speculative execution engine is integrated into the predictive hypergraph routing module. This engine pre-computes candidate inference routes by simulating alternative CoT pathways using current system metrics, including latency, resource utilization, and historical performance data. The engine evaluates each candidate using a composite cost function—analogous to the metrics used in network routing (e.g., link cost, latency, and bandwidth)—and selects the optimal candidate route for activation. The outputs of these candidate routes are then pre-cached in a synthetic data pool, allowing the orchestrator to seamlessly transition to a backup pathway when a degradation in the primary route is detected. This proactive caching mechanism ensures that the system maintains stringent SLA requirements even under rapidly changing conditions. Additionally, the predictive hypergraph routing module incorporates adaptive timers analogous to the min-wait-to-advertise and max-wait-to-advertise timers used in BGP. These timers control the interval between route advertisements, balancing the need for rapid route convergence with the stability of the overall inference process. By adjusting these timers based on real-time system load and observed latency, the module can prevent premature route withdrawals or unnecessary advertisements, thus further reducing the potential for inference “flapping” and ensuring smoother failover transitions. Moreover, the system supports flexible policy implementation by allowing administrators to define sophisticated routing policies that adaptively modify advertisement conditions based on network topology, workload distribution, and security considerations. For example, in a multi-homed environment, the system can preferentially route inference requests through backup nodes that are geographically or topologically diverse, thereby enhancing redundancy and mitigating localized failures.

Collectively, these mechanisms—dynamic route advertisement, predictive speculative execution, adaptive timer control, and flexible policy-driven routing—enable the predictive hypergraph routing module to optimize the overall inference process. By dynamically steering CoT tokens along optimal compute paths, the orchestrator effectively reduces processing latency, maximizes resource utilization, and ensures that inference quality remains high even in the face of shifting system conditions. This sophisticated, BGP-inspired routing strategy thus provides a robust foundation for large-scale, distributed multispecies orchestration systems, ensuring that both real-time responsiveness and long-term stability are maintained in compliance with stringent SLA constraints.

In one exemplary embodiment, the invention is further extended to encompass not only chain-of-thought (CoT) reasoning within a single autonomous system but also the distributed orchestration of physically enabled AI systems—including robots, human operators, software agents, and compound agentic systems spanning multiple organizations. In this extended architecture, the predictive hypergraph routing module is generalized to serve as a dynamic, high-dimensional routing framework that optimizes both intra-system and inter-system communication, control, and decision-making processes. Nodes in this hypergraph represent discrete units of actionable intelligence, sensor data, control commands, and reasoning outputs, while edges capture potential communication pathways and command relationships across a heterogeneous network of embodied agents, autonomous platforms, and cross-organizational software components.

Drawing inspiration from BGP Route Conditional Advertisement, each agentic node—whether it represents a robot in the field, a human control station, a software-based decision engine, or a composite agentic system—is equipped with a dynamic advertisement mechanism. This mechanism continuously broadcasts key performance metrics such as processing latency, current workload, energy consumption, security credentials, and operational reliability. These advertised metrics are encapsulated as metadata on the hypergraph's edges, allowing the orchestrator to build a high-dimensional routing table that indexes available communication and control pathways. For example, if a fleet of delivery robots in an industrial setting experiences an unexpected surge in local computational load or sensor degradation, the corresponding nodes dynamically advertise reduced capacity, triggering the orchestrator to re-route control commands or delegate processing to alternative nodes, such as a remote supervisory agent or an external partner organization's infrastructure.

To accommodate the scale and diversity of inter-company compound agentic systems, the predictive hypergraph routing module incorporates multi-layered routing strategies that span local, regional, and global levels. At the local level, nodes within a single robot or within a confined organizational unit perform rapid, sub-second routing updates using lightweight, speculative execution engines. These engines precompute candidate routes by simulating alternative command pathways based on real-time sensor feedback, local network conditions, and immediate resource availability. At the regional and global levels, the hypergraph is extended to include nodes representing partner organizations, cloud-based orchestration platforms, and remote expert systems. In these cases, the routing engine leverages advanced reinforcement learning techniques to adjust routing policies dynamically, ensuring that commands and reasoning outputs propagate through the most reliable and efficient channels. This multi-tiered routing framework supports adaptive failover, load balancing, and redundancy across heterogeneous and geographically distributed systems.

Moreover, the system integrates predictive caching and forward compilation mechanisms analogous to those used in high-performance network routing. Here, candidate command sequences and verified reasoning outputs are precomputed and stored in a synthetic data pool, which is accessible across the distributed hypergraph. This caching layer enables rapid reconstitution of verified command and control sequences in scenarios where primary communication pathways become congested or fail. For instance, in a cross-organizational emergency response scenario involving both autonomous drones and human operators, the orchestrator can quickly retrieve and re-deploy pre-verified decision tokens from the cache, ensuring that critical control commands are executed with minimal delay despite network variability.

Furthermore, the system supports flexible policy implementation and secure, multi-homed communications by allowing administrators to define sophisticated routing policies that account for organizational priorities, regulatory constraints, and security considerations. In a compound agentic system, such policies might dictate that sensitive control commands—such as those related to hazardous material handling or critical infrastructure management—be routed exclusively through nodes with enhanced security features or through verified external expert systems. Simultaneously, less critical information can be routed via lower-latency channels, optimizing overall resource utilization. The dynamic, conditional advertisement of routes and adaptive timer mechanisms (analogous to the min-wait-to-advertise and max-wait-to-advertise timers in BGP) further ensure that the entire orchestration framework remains robust and responsive under varying operational conditions.

In summary, this embodiment extends the predictive hypergraph routing paradigm to a distributed, multi-agentic environment that includes robots, human operators, software agents, and cross-organizational platforms. By dynamically advertising compute capacity and quality metrics, precomputing and caching candidate routes, and employing multi-layered routing strategies informed by real-time observability and reinforcement learning, the system provides an adaptable, scalable, and secure framework for orchestrating physically enabled AI systems. This advanced routing architecture not only streamlines the overall inference and command execution processes but also ensures optimal resource allocation, enhanced redundancy, and rapid failover in complex, dynamic operational scenarios, thereby establishing a new paradigm for inter-company compound agentic systems and embodied AI platforms.

In one exemplary embodiment, the invention is extended to incorporate a Hierarchical Signal Decomposition Module (HSDM) and a Reinforcement Learning-driven Cultural Evolution Engine (RLC²E) to enable advanced processing and adaptive interpretation of non-human animal vocalizations, particularly those of cetaceans, in conjunction with human communication data for multispecies orchestration. In this embodiment, the system receives raw high-fidelity acoustic and neural signals from non-human animal sources via an array of underwater transducers, wearable neural interfaces, and supplementary environmental sensors. These signals are first processed by the HSDM, which employs an adaptive segmentation algorithm that computes local entropy metrics to dynamically partition the continuous data stream into variable-length patches corresponding to fundamental sound units, intermediate phrases, and higher-order thematic constructs-mirroring the hierarchical structure observed in humpback whale songs. Each segmented patch is subsequently embedded into a high-dimensional latent space using a hybrid encoding scheme that integrates hash-based n-gram techniques with quantum-inspired byte entanglement methods. This approach captures both the probabilistic context and phase-dependent nuances of the input signals, while self-supervised contrastive learning mechanisms iteratively adjust token lengths and frequency distributions to induce an emergent Zipfian pattern in the representation, thereby enhancing the efficiency and learnability of the encoded vocalizations.

In a further embodiment, the system incorporates the RLC²E, which is integrated with a Monte Carlo Tree Search (MCTS)-based orchestration module to simulate the iterative cultural transmission processes inherent in whale vocal cultures. In this configuration, the RL agent within the RLC²E evaluates the hierarchical token representations provided by the HSDM and reinforces token sequences that exhibit efficiency-driven characteristics and hierarchical consistency. Frequently occurring tokens are rewarded with shorter duration representations in accordance with Zipf's Law of Abbreviation, while emergent patterns that contribute to improved interspecies coordination are positively reinforced. The RL agent constructs directed acyclic graphs (DAGs) representing the evolution of these vocal patterns over successive task execution cycles, and employs probabilistic models—including Bayesian nonparametric methods and transformer-based sequence predictors—to forecast potential cultural drift in vocalizations. These predictive insights are fed back into the orchestration module, enabling the system to preemptively adjust its communication strategies and output parameters, thereby ensuring sustained optimal coordination among human operators, non-human animals, and robotic agents even as the cultural attributes of the animal vocalizations evolve over time.

Additionally, the invention further comprises a Cross-Domain Hierarchical Attention Network (CDHAN) integrated within a multi-modal fusion layer that aligns and correlates the latent representations of non-human vocalizations with concurrently received human communication data and real-time environmental contextual information, such as SLAM-derived spatial maps and sensor-derived physical parameters. The CDHAN utilizes multi-head attention mechanisms to dynamically weigh spectral, temporal, and spatial features across the various input modalities, producing a unified, context-rich representation that is further modulated by cultural evolution metrics generated by the RLC²E. This unified representation is subsequently utilized by a Predictive Cultural Evolution Module (PCEM), which continuously refines multispecies orchestration strategies by proactively adjusting communication protocols in anticipation of emergent song themes and shifting interspecies dynamics. As a result, the system is capable of not only reacting to current communication signals but also preemptively adapting its output to account for anticipated cultural shifts, thereby ensuring resilient, scalable, and efficient collaborative task execution in heterogeneous environments. Collectively, these integrated modules—hierarchical signal decomposition, reinforcement learning-based cultural evolution, cross-domain attention fusion, and predictive orchestration—establish a robust and technically enabled framework that leverages convergent evolutionary principles to transcend existing limitations in interspecies communication and coordinated task execution.

In one novel embodiment, the system is further augmented by an Optimal Communication Modality Selection Module (OCMSM) that dynamically determines the best combination of communication modalities and associated sensor or transducer arrays based on the target species, the intended message, environmental conditions, and the potential influence on non-target animals. In this embodiment, the OCMSM continuously monitors inputs from a wide range of sensors—including audio microphones, high-resolution cameras, chemical and olfactory sensors, inertial measurement units (IMUs), and environmental sensors (e.g., temperature, humidity, ambient noise levels, and light intensity)—and compares these against pre-stored species-specific communication profiles and historical performance data. These profiles capture, for each target species, the sensory modalities (e.g., acoustic, visual, olfactory, or haptic) that are most effectively used in natural communication, as well as environmental factors that may affect signal transmission. For example, in scenarios where the target species is a flight-type baleen whale, the system may determine that low-frequency acoustic signals (e.g., below 100 Hz at reduced source levels) are optimal to avoid detection by predators, as evidenced by studies on acoustic crypsis. Conversely, in a busy urban environment where ambient noise and reverberations could degrade sound quality for canines or elephants, the system might favor visual or olfactory cues, or even a hybrid approach, to convey commands without inadvertently attracting unwanted animals (e.g., preventing a wolf from being drawn to an elk calf). The OCMSM employs a decision algorithm that integrates a multi-dimensional sensor fusion engine with reinforcement learning techniques. In practice, the algorithm uses a combination of multi-armed bandit strategies and neurosymbolic reasoning pipelines to evaluate potential communication modalities based on the current environment and task-specific parameters. For instance, drawing on insights from the “Acoustic Crypsis in Baleen Whales” study, the system can autonomously select a low-intensity, low-frequency acoustic signal when communicating with flight species—thereby mimicking the natural adaptations of blue and fin whales that produce calls below 80 Hz, making them “acoustically invisible” to predators like killer whales. Alternatively, when the intended communication is aimed at a fight species or in a context where long-range transmission is critical (such as coordinating a coordinated rescue or search operation), the module may decide to increase both the frequency and amplitude of the signal, or combine it with a visual or olfactory cue, to maximize clarity and ensure that the message is received without alerting non-target animals. Moreover, the decision algorithm factors in spatial and temporal data derived from integrated Simultaneous Localization and Mapping (SLAM) subsystems, ensuring that the selected modality does not compromise location-specific objectives, such as avoiding areas of high predator density or preventing inadvertent aggregation of non-target species. To execute the determined optimal modality strategy, the system incorporates a Multi-Modal Output Unit (MMOU) that is fully integrated with a versatile array of output devices. This unit includes, for example, underwater transducers with adjustable frequency and amplitude settings, LED or holographic displays for visual output, olfactory dispensers that can release calibrated scent molecules, and haptic actuators capable of delivering tactile stimuli. Each output element is controlled by dedicated driver circuits that receive modulation instructions from the OCMSM, allowing the system to tailor the emission parameters—such as pulse duration, spatial distribution, and energy output—in real time. In one application, when the OCMSM determines that a low-frequency acoustic signal is most appropriate for communicating with a baleen whale under high predation risk, the MMOU activates an underwater speaker calibrated to emit low-intensity calls that replicate natural whale vocalizations, thereby ensuring that the communication remains undetectable by killer whales while still conveying the intended message to conspecifics. In parallel, if the environment suggests that an olfactory cue may further enhance the communication—such as during a coordinated hunt where scent cues play a role in prey localization—the system can concurrently activate a scent-emission module with a controlled release of species-specific pheromones. Finally, the OCMSM operates within a closed-loop optimization framework, where feedback from sensor inputs—such as confirmation of message reception via subsequent animal behavioral changes or changes in environmental conditions—are fed back into the decision algorithm to continuously refine and adjust the communication strategy. This iterative process ensures that the system not only selects the optimal modality combination at any given moment but also adapts over time to changing environmental conditions, evolving species-specific communication needs, and potential interference from non-target organisms. By leveraging insights from acoustic crypsis research and integrating them with a robust, sensor-driven, and learning-based architecture, this embodiment represents a significant advance in multispecies communication orchestration, enabling precise, context-aware, and dynamically optimized interspecies interaction. According to another embodiment, there is provided a non-transitory, computer-readable medium comprising programming instructions for an electronic computation device executable by a processor to cause the electronic computation device to: receive non-human animal communication data; process the data through a machine-learning system, wherein the machine-learning system is configured to: parse the non-human animal communication data to derive one or more linguistic patterns; associate the one or more linguistic patterns with a human sentiment, meaning, or instruction; compute a confidence score corresponding to the human sentiment, meaning, or instruction; in response to the human sentiment, meaning, or instruction exceeding a predetermined threshold: rendering and presenting an audio/visual form of the human sentiment, meaning, or instruction on an electronic display; receiving a set of human communication data in response to the human sentiment, meaning, or instruction; associating the set of human communication data with one or more non-human animal communication patterns; and outputting the one or more non-human animal communication patterns via one or more output elements.

The system relates to systems and methods for multispecies, multi-modal, full-duplex communication. In particular embodiments, the system implements advanced orchestration techniques for processing and integrating various input modalities including neural interfaces, sensor fusion, simultaneous localization and mapping (SLAM) integration, and dynamic communication routing. The system extends traditional AI-driven communication architectures by incorporating partial output streaming, aggregation-aware routing, and distributed prompt-aware scheduling across multiple modalities. Unlike conventional systems that process data in monolithic chunks, the present system enables continuous, real-time interaction between multiple participants, including animals, humans speaking different languages, or combinations thereof. The system builds upon and extends token streaming principles to encompass animal neural decoding, multi-modal sensory data, human language, and interspecies semantic embeddings. Each pipeline stage processes not only textual tokens but also streams of sensory data, neural feature vectors, partial embeddings of animal intentions, and multi-modal representations including audio snippets, visual icons, and haptic patterns.

In the present system, intermediate representations are treated as a series of “quanta” analogous to tokens in a text stream. The animal-to-human translation stage processes animal neural signals incrementally, streaming partial “intention vectors” or preliminary interpretations of the animal's intent downstream as soon as they become available. Similarly, the human-to-animal feedback stage processes spoken language or textual commands token-by-token or phrase-by-phrase, enabling continuous translation into neural stimulation patterns for the animal.

The sensory integration and fission stages merge multiple sensory inputs, such as visual context from the environment or olfactory cues from animal-mounted sensors. Partial embeddings of these senses are streamed and aggregated as they become available, rather than waiting for complete sensory “frames.” This approach significantly reduces latency and enhances interactive fluidity.

The system implements sophisticated aggregation-aware routing to ensure that partial outputs destined for aggregation stages follow prescribed paths. For example, when animal neural signals (A) and human textual instructions (H) both feed into a shared semantic representation layer(S), the system's aggregation-aware routing interface allows developers to specify the granularity at which different sensory or neural “tokens” must be combined. This might involve aggregating three partial scent signatures from the animal's neural decoding with one partial human instruction before passing to a decision-making stage. Correctness across species and modalities is maintained through careful orchestration of partially formed neural embeddings and linguistic tokens. The routing rules ensure consistent aggregation of the correct partial outputs, preserving semantic fidelity even as data streams continuously and asynchronously.

The system employs advanced load balancing and distributed prompt-aware scheduling to handle complex heterogeneous data streams. Unlike traditional text-only prompts, the system processes animal neural “queries” (e.g., neural patterns indicating confusion or stress), environmental cues, and multilingual human requests. Each “prompt” can vary significantly in complexity and length, from rapid bursts of neural signatures to slower human speech and intermittent but data-intensive sensory updates. The scheduler can detect when certain pipeline stages, such as neural decoding or sensory integration units, become overloaded with complex prompts. In response, it can redistribute these prompts across multiple instances of a particular stage, ensuring low-latency responses. For example, when multiple animals are communicating simultaneously with a team of humans, the system can scale out decoding instances, routing partial embeddings to the least-loaded instance that can still aggregate results correctly.

A key feature of the system is its implementation of enhanced contextual orchestration through sliding time windows. This approach integrates multiple input modalities over time, dynamically adapts decision-making complexity, and improves interaction quality and response accuracy, particularly in high-stress or dynamically changing environments. The system maintains a set of sliding time windows capturing data streams from multiple modalities, including: neural signals from animal-wearable electrodes; vocalizations captured by on-collar microphones; and gestural and body posture data from inertial sensors or camera-based vision systems. Each modality has different temporal characteristics and reliability profiles. The system leverages these windows and adaptive lookback/lookahead strategies to continuously refine its interpretations of the animal's cognitive and emotional states.

The system implements several key sensor interface components: neural Interface: Utilizing non-invasive electrodes or tattoo-based sensors that stream low-latency neural signals from the animal's scalp; vocalization unit: incorporating microphones and audio processing modules to capture and classify various vocal patterns such as barks, whines, and growls; and gestural tracking: employing lightweight IMUs on collars or harnesses, and potentially stereo camera systems, to track body posture, tail position, ear orientation, and movement patterns.

The system maintains separate sliding window buffers for each modality: neural buffer: combines a short-term buffer (e.g., last 1-2 seconds of EEG-like signals at a high sample rate) with a longer-term state tracker (e.g., last 30-60 seconds) summarized into low-dimensional embeddings; audio buffer: maintains recent audio frames (e.g., last 2-3 seconds) at high fidelity for detailed spectral analysis, plus a rolling 30-second history of reduced spectral embeddings to capture long-term vocalization trends; gestural/movement buffer: stores high-frequency kinematic data for the last few seconds to detect sudden changes, plus a downsampled history over several minutes to identify repetitive patterns or “baseline” behavior.

A fusion layer periodically (e.g., every 100 ms) aligns and merges the modality-specific buffers using timestamps to ensure cross-referencing of neural, vocal, and gestural events. This produces a unified representation or “context embedding” capturing both immediate signals and aggregated longer-term patterns.

The Adaptive Decision-Making Module (ADM) applies lookback and lookahead strategies to determine how much historical and predictive information to use. It employs dynamic branching factors—controlled by computational resource availability and scenario complexity—to refine interpretations. The system can integrate MCTS/UCT-like algorithms or heuristic controllers in this module.

The system is particularly effective in high-stress environments such as search-and-rescue operations. In these scenarios, the system: performs short-term neural and audio fusion to detect sudden spikes in neural activity associated with stress and match them against audio patterns indicating distress; maintains long-term gestural baselines to compare immediate movement changes against typical patterns, enabling detection of unusual behaviors such as tail dropping or ear flattening; implements adaptive decision complexity, increasing lookback periods in worsening conditions to ensure no recent cues are missed; and generates appropriate actions, such as alerting handlers or stimulating the animal's training pathways via gentle neural stimulation patterns to calm or refocus attention.

The system also excels in therapeutic settings, such as with therapy dogs in hospitals, where it can: monitor short-term micro-expressions through brief neural/vocal changes over 2-3 second windows to detect rising anxiety; compare against longer-term patterns using a 30-second trailing window of calm baseline signals to confirm outlier events; implement dynamic branching to explore multiple interpretations of ambiguous signals, distinguishing between fear, excitement, and confusion.

The system implements several technical optimizations: computational efficiency: uses ring buffers for sensor data, enabling O(1) updates as the window slides forward and computes running averages, spectral features, and embeddings incrementally. Adaptive parameter updates: employs a policy network trained offline on diverse scenarios to dynamically set lookback/lookahead lengths and branching factors and monitors resource usage to adjust complexity based on system load. Noise Robustness: implements multi-modal cross-checking to compensate for noisy signals in any single modality and uses long-term windows to distinguish meaningful behavioral changes from sensor glitches.

The system is designed to scale to multiple animals or agents, with each agent's data stream managed separately while global decision-making factors consider inter-agent interactions. The architecture can be combined with other modules such as ALTO-like partial output streaming, InferLine provisioning, and MCTS-based scheduling to form a holistic system that optimizes across entire multi-agent multi-modal communication networks. Through this comprehensive approach combining sliding time windows, adaptive lookback/lookahead, and dynamically modulating decision complexity, the system provides a robust, context-sensitive, and resource-aware framework for interpreting transient and evolving emotional or behavioral signals. This enables improved guidance, better interaction quality, and more effective management of high-stress or complex environments where rapid, nuanced understanding is paramount.

In one exemplary embodiment, the SLAM system incorporates an advanced ground point separation mechanism using a modified RANSAC approach. The system maintains a three-dimensional information matrix of size 16×1800×3, where the first channel stores point coordinates, the second channel flags ground points, and the third channel records clustering results. Ground plane fitting is performed by iteratively sampling points from the last three LiDAR rows at columns 300, 900 and 1500 with random offsets up to 200 positions, enabling robust plane estimation even in uneven terrain. Points within 0.2 meters of the fitted plane are classified as ground points, with this threshold being configurable based on local vegetation characteristics. The system further implements a sophisticated breadth-first clustering algorithm for non-ground points. For each point, neighboring points in the same row and column are evaluated, with points within 0.15 meters being grouped into the same cluster. A cluster is considered valid if it contains more than 50 points, or if it appears in four consecutive columns with at least 30 points each, indicating a likely vertical structure such as a tree trunk. To ensure robust visual tracking, the system employs a sliding window blur detection mechanism that monitors Laplacian variance values across 30 consecutive camera frames. Frames with variance values below 30% of the window average are classified as blurred and excluded from visual processing. Visual tracking resumes once 15 consecutive frames exceed the stored average variance threshold, ensuring stable feature extraction and matching. The semantic segmentation subsystem incorporates quality control through a multi-frame consensus approach. Detected objects maintain confidence scores based on detection frequency across frames. Objects whose boundaries overlap or are within 0.3 meters in both X and Y directions are merged, with their semantic labels determined by majority voting across all associated detections. This approach helps mitigate both false positives and missed detections while maintaining consistent object identity across frames.

According to another embodiment, the SLAM system integrates an advanced ground point separation and object clustering framework. In this embodiment, a three-dimensional information matrix of dimensions 16×1800×3 is maintained, wherein the first channel stores point coordinates, the second channel contains ground point flags, and the third channel records clustering results. The system performs ground plane fitting by iteratively sampling points from the three lowermost LiDAR rows at specified columns (300, 900, and 1500) with randomized offsets up to 200 positions. This approach enables robust plane estimation even in environments with uneven terrain. Points falling within a configurable threshold (such as 0.2 meters) of the fitted plane are classified as ground points. For non-ground points, the system implements a breadth-first clustering algorithm that evaluates neighboring points in the same row and column, grouping points within 0.15 meters into clusters. A cluster is validated if it either contains more than 50 points or appears in four consecutive columns with at least 30 points each, characteristics typically indicating vertical structures such as tree trunks or poles. The system further incorporates quality control through a multi-frame consensus approach, where detected objects maintain confidence scores based on detection frequency across frames. Objects with overlapping boundaries or within 0.3 meters in both X and Y directions are merged, with semantic labels determined through majority voting across all associated detections, thereby reducing both false positives and missed detections while maintaining consistent object identity across frames.

According to another embodiment, the system incorporates a byte latent architecture for processing raw sensor data streams. A local encoder maps input byte sequences into expressive patch representations using lightweight transformer layers, where patches are dynamically sized based on the entropy of the next-byte prediction. The encoder incorporates hash n-gram embeddings that map byte n-grams via a hash function to an index in an embedding table, enabling efficient representation of recurring patterns in the sensor data. A global latent transformer then processes these patch representations using block-causal attention masks, enabling the system to maintain temporal dependencies while significantly reducing computational complexity compared to processing individual bytes. A local decoder converts patch representations back into byte sequences through a series of cross-attention and transformer layers, where the decoder uses byte representations as queries and patch representations as keys/values, with multi-headed attention to enable robust reconstruction. The architecture includes an entropy-based patch segmentation system that identifies boundaries based on entropy estimates from a small byte-level language model, enabling dynamic allocation of computational resources based on the complexity and information density of different segments of the input stream. The system further incorporates specialized multi-headed cross-attention modules that enable information flow between the global latent space and byte-level processing, with patch representations serving as queries and byte representations as keys/values in the encoder, and vice versa in the decoder. This approach enables efficient processing of raw sensor data by allocating more compute to complex regions while using lightweight processing for predictable sequences.

### BRIEF DESCRIPTION OF THE DRAWING FIGURES

FIG. 1 shows an exemplary environment in which a system for multi-modal orchestration for human-animal-robot collaborative task execution can be used, in accordance with one or more embodiments.

FIG. 2 is a block diagram illustrating components of a system for multi-modal orchestration for human-animal-robot collaborative task execution, in accordance with one or more embodiments.

FIG. 3 is a block diagram illustrating details of a neural interface component, in accordance with one or more embodiments.

FIG. 4 is a block diagram illustrating details of a translation processing unit, in accordance with one or more embodiments.

FIG. 5 is a block diagram illustrating details of a multi-species output unit, in accordance with one or more embodiments.

FIG. 6 is a block diagram illustrating details of a multi-species collaboration layer, in accordance with one or more embodiments.

FIG. 7 is a block diagram illustrating details of a large language model (LLM) or other AI, symbolic reasoning, or neurosymbolic orchestration system, in accordance with one or more embodiments.

FIG. 8 is a block diagram illustrating details of a Simultaneous Localization and Mapping (SLAM) system, in accordance with one or more embodiments.

FIG. 9 is a block diagram illustrating an exemplary training system for multi-modal orchestration for human-animal-robot collaborative task execution, in accordance with one or more embodiments.

FIG. 10 is a flow diagram illustrating an exemplary method for multi-modal orchestration for human-animal-robot collaborative task execution, in accordance with one or more embodiments.

FIG. 11 is a flow diagram illustrating processing non-human animal communication patterns, in accordance with one or more embodiments.

FIG. 12 is a flow diagram illustrating SLAM processing in accordance with one or more embodiments.

FIG. 13 is a flow diagram illustrating an exemplary method for training a system for multi-modal orchestration for human-animal-robot collaborative task execution, according to one or more embodiments.

FIG. 14 illustrates an exemplary computing environment on which an embodiment described herein may be implemented, in full or in part.

FIG. 15 is a block diagram illustrating a partial output stream processor designed as a multi-layered system that contains diverse input sources.

FIG. 16 is a block diagram illustrating a specialized stream handler representing a sophisticated real-time processing system consisting of three parallel but interconnected processing pathways.

FIG. 17 is a block diagram illustrating a MCTS or UCT with super exponential regret dynamic scheduling system.

FIG. 18 is a block diagram illustrating an enhanced contextual orchestration system with sliding time windows.

FIG. 19 is a block diagram illustrating a hierarchical multi-modal aggregation and distributed prompt-aware scheduling system.

FIG. 20 is a flow diagram illustrating an exemplary method for a multi-layered stream processing system.

FIG. 21 is a flow diagram illustrating an exemplary method for a specialized stream handlers system.

FIG. 22 is a flow diagram illustrating an exemplary method for a MCTS/UCT dynamic scheduling system.

FIG. 23 is a flow diagram illustrating an exemplary method for an enhanced contextual orchestration system.

FIG. 24 is a flow diagram illustrating an exemplary method for a hierarchical multi-modal aggregation and distributed prompt-aware scheduling system.

FIG. 25 is a block diagram illustrating an advanced transformer-based multi-modal fusion module.

FIG. 26 is a block diagram illustrating a neuromorphic co-processor module for event-driven processing.

FIG. 27 is a block diagram illustrating a biological computing interface module.

FIG. 28 is a block diagram illustrating a quantum planning and optimization engine.

FIG. 29 is a flow diagram illustrating an exemplary method for an enhanced contextual orchestration system.

FIG. 30 is a flow diagram illustrating an exemplary method for an operation of a neuromorphic co-processor module for event-driven processing.

FIG. 31 is a flow diagram illustrating an exemplary method for an operation for a biological computing interface module.

FIG. 32 is a flow diagram illustrating an exemplary method for the operation of a quantum planning and optimization engine.

The drawings are not necessarily to scale. The drawings are merely schematic representations, not intended to portray specific parameters of the disclosed embodiments. The drawings are intended to depict only typical embodiments of the invention and therefore should not be considered as limiting in scope.

### DETAILED DESCRIPTION OF THE INVENTION

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to use in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “cetacean” refers to a marine mammal belonging to the order Cetacea, which includes animals like whales, dolphins, and porpoises. These creatures are fully aquatic and are characterized by their streamlined bodies, lack of hind limbs, and adaptations for life in the water, such as flippers, tail flukes, and blowholes for breathing at the surface.

As used herein, “directed acyclic graph” (DAG) is a representation of information and relationships, where each primary unit of information makes up a “node” or “vertex” of the graph and the relationship between two nodes makes up an edge of the graph. Thus, a DAG is a graph data structure that consists of nodes (vertices) connected by directed edges, where the edges have a direction and the graph contains no cycles. DAGs can represent decision trees, skill trees, or level progression in a game. DAGs can represent causal relationships or dependencies in Bayesian networks, enabling probabilistic inference. DAGs are a foundational concept in computer science and mathematics, offering a clear and structured way to model systems with dependencies while avoiding cycles.

As used herein, “large language model” (LLM) is a type of artificial intelligence model, typically based on deep learning, that is designed to process, understand, and generate human language. These models are trained on massive datasets of text, enabling them to predict the likelihood of sequences of words, understand context, and produce coherent and contextually relevant responses. Variants include a range of attention and attentionless approaches such as Transformers, Mamba, Hyena, Titans, Megolodon, or DeepSeekR1 that have varying degrees of pre-training, fine tuning and reasoning capabilities. It should be appreciated that token-based, byte-based (e.g. byte latent transformers) or other variants can also be used by system. It should also be appreciated that Large Action Models, Large Behavior Models, Large Experience Models, or multimodal models (e.g. combining video or audio or text or other specialized data such as genomics or multiomics or other specialized data sets) may also be used by system in similar fashion to the LLM examples contained herein. Disclosed embodiments can harness the vastly untapped resource of marine life intelligence to perform collaborative task execution by facilitating improved interspecies communication and task coordination. Such tasks can include search and rescue, exploration, surveillance, and more. Moreover, multiple species of animals, such as whales, dolphins, and octopuses can collaborate with humans and/or robots on these types of tasks, as well as others. It should be appreciated that token-based, byte-based (e.g., byte latent transformers), or other variants can also be used by the system. Token-based models segment input data into discrete tokens, typically words or subwords for text processing, enabling efficient processing of language patterns through attention mechanisms. Byte-based models, such as byte latent transformers, operate directly on raw byte sequences rather than tokenized inputs, conferring advantages in processing cross-lingual content, handling out-of-vocabulary terms, and managing multimodal data without requiring separate tokenization pipelines for each modality. These byte-level architectures can be particularly advantageous when processing animal vocalizations that do not conform to human linguistic structures, as they can capture patterns in raw acoustic signals or neural recordings without imposing predetermined segmentation boundaries. Additionally, the system may implement hybrid architectures that leverage both token-level and byte-level processing to capitalize on their respective strengths-using token-based approaches for well-structured human communications while employing byte-level processing for less structured animal vocalizations and environmental sensor data.

As used herein, “simultaneous localization and mapping” (SLAM) is a technique where a robot or device or data processing system can simultaneously build a map or world representation of an unknown or partially observed environment and determine, refine or estimate its position within that map or space or world representation. SLAM is well-suited for autonomous navigation in scenarios where pre-existing maps or space characterizations are unavailable.

### Conceptual Architecture

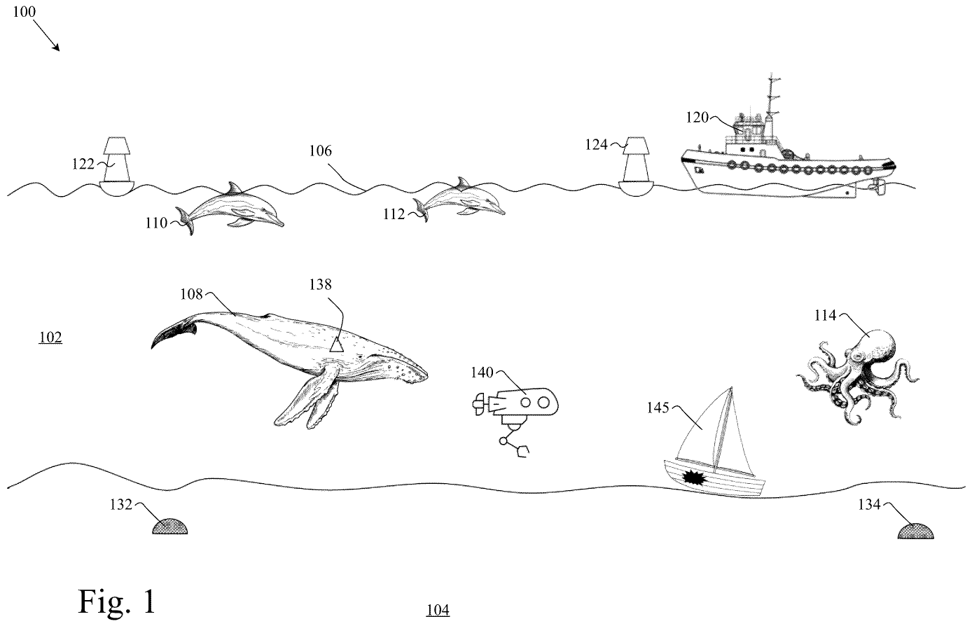

FIG. 1 shows an exemplary environment in which a system for multi-modal orchestration for human-animal-robot collaborative task execution can be used, in accordance with one or more embodiments. Environment 100 can include a large body of water 102. However, disclosed embodiments are not limited to use in aquatic environments. Some embodiments may interact with land animals and/or flying animals and may be used in environments involving aquatic, land-based, and/or above-ground environments. Large body of water 102 can include an ocean (e.g., Pacific Ocean, Atlantic Ocean, etc.), a sea, (e.g., Mediterranean Sea, Baltic Sea, etc.), a lake (e.g., Lake Superior, Lake Victoria, etc.), a river (e.g., Mississippi River), a gulf (e.g., Gulf of Mexico), a bay (e.g., Hudson Bay), a strait (e.g., Bering Strait), a fjord, an estuary, a man-made reservoir, and/or other suitable large body of water.

The environment 100 can include one or more buoys, indicated as 122 and 124 in environment 100. In one or more embodiments, the buoys (122, 124) float on the surface 106 of the body of water 102, and can include a variety of equipment for sensing, receiving, storing, and/or transmitting data, as well as one or more output devices. The buoys can include one or more atmospheric sensors. The atmospheric sensors can include a wind speed sensor, wind direction sensor, air temperature sensor, air humidity sensor, barometric pressure sensor, solar radiation sensor, microphone, and/or other suitable atmospheric sensors.

The buoys can include one or more water-based sensors. The water-based sensors can include temperature sensors (to measure surface water temperature), salinity sensors (to determine the salt content of the water), pH sensors (to measure acidity/alkalinity), dissolved oxygen sensors (to monitor oxygen levels for aquatic life), and/or turbidity sensors (to measure water clarity). The water-based sensors may include wave height and direction sensors to measure ocean swell and surface conditions, current velocity sensors (to track underwater currents), tide and sea level sensors, and/or chlorophyll sensors (to estimate plankton levels and water productivity). The water-based sensors may include underwater microphones to detect underwater sounds from aquatic life and/or marine craft. The buoys can include one or more meteorological sensors, such as rain gauges and/or lightning detectors.

The buoys can include a variety of communication equipment, such as satellite transmitters (e.g., Iridium) for long-range communication. The buoys may include cellular modems, suitable for communication within areas of network coverage. The buoys may include radio transmitters to enable short-range transmission for local stations or vessels. The buoys may include Wi-Fi and/or Bluetooth modules to support local data access when in close proximity. The buoys may include GPS receivers to track buoy position and movement. Other communication systems may be present on the buoys in one or more embodiments. The buoys can include a wide variety of output devices, including, but not limited to, signal lights, audible alarms, underwater speakers, out-of-water speakers, and/or digital displays. The buoys can include a variety of computing devices, such as embedded microcontrollers, edge processors, data loggers, and/or other suitable computing equipment. In one or more embodiments, the buoys may include AI-based edge devices for advanced tasks such as detecting patterns, identifying marine life, and/or predictive analysis.

The environment 100 may further include one or more seafloor detection devices, that are located on seafloor 104, indicated at 132 and 134. Each seafloor detection device (132, 134) can include a seismometer, hydrophone array, and a wide range of other sensors and technologies for monitoring vibrations, seismic activity, and underwater sounds. The seafloor detection device can include a broadband seismometer for capturing a wide range of seismic frequencies. The seafloor detection device can further include a short-period seismometer to focus on high-frequency vibrations. The seafloor detection device can further include one or more accelerometers for measuring ground accelerations for vibrations caused by earthquakes, underwater landslides, or human-made activities such as drilling.

The hydrophone array within the seafloor detection devices can enable detecting soundwaves from marine mammals such as whales and dolphins. Other sounds may also be detected by the hydrophone array. These sounds can include sounds from underwater explosions, ship noise, or submarine movements. One or more hydrophones within the hydrophone array may be tuned for capturing low-frequency sounds from large marine animals and/or geological events. The seafloor detection devices may further include a current meter to track underwater currents that may result from tectonic and/or seismic activity.

In one or more embodiments, the seafloor detection devices may be communicatively coupled to one or more surface devices, such as buoys (122, 124), and/or ship 120. The communicative coupling can include cables, such as copper cables, fiber-optic cables, or the like, between a seafloor detection device and a buoy. The communicative coupling can include wireless communication such as RF-based communication and/or acoustic modems that can transmit data via sound waves to nearby surface buoys, ships, or other underwater devices.

The environment 100 can include ship 120. Ship 120 can contain one or more computing devices, such as a data server, virtualized computing environment, and/or other computing devices for enabling and/or supporting the multi-modal orchestration system of disclosed embodiments. Additionally, ship 120 can provide long range communication to one or more remote servers, via the Internet. In one or more embodiments, ship 120 may be equipped with satellite communication (SATCOM). In embodiments, the ship 120 can be equipped with a satellite antenna. The satellite antenna can enable a connection with a geostationary satellite and/or a low-Earth-orbit (LEO) satellite, that in turn relays data to a ground station connected to the internet. The ship 120 may further be equipped with a cellular transceiver to utilize a cellular network when within the range of coastal areas.

Within the body of water 102, a wide variety of aquatic life may be present. The aquatic life can include one or more dolphins/porpoises, indicated at 110 and 112. These can include the Bottlenose Dolphin (Tursiops truncatus), Common Dolphin (Delphinus delphis), Dusky Dolphin (Lagenorhynchus obscurus), Harbor Porpoise (Phocoena phocoena), Spectacled Porpoise (Phocoena dioptrica), Orca or Killer Whale (Orcinus orca), and/or other varieties of dolphin/porpoise. These intelligent and diverse marine mammals contribute significantly to marine ecosystems and hold a special place in human culture and scientific research. Each species has its unique adaptations to its habitat, from the open ocean to coastal regions and even rivers. In embodiments, communication between the dolphins/porpoises for the multi-modal orchestration system of disclosed embodiments may be accomplished by sending acoustic signals to the dolphins/porpoises and/or receiving acoustic signals from the dolphins/porpoises via buoys (122, 124) and/or seafloor detection devices (132, 134).

The aquatic life within body of water 102 can include one or more octopus/squid, indicated at 114. The octopus can include a Common Octopus (Octopus vulgaris), Giant Pacific Octopus (Enteroctopus dofleini), Mimic Octopus (Thaumoctopus mimicus), and/or other types of octopus. The squids can include a Giant Squid (Architeuthis dux), Colossal Squid (Mesonychoteuthis hamiltoni), Common Squid (Loligo vulgaris), and/or other types of squids. Both octopuses and squids are among the most intelligent invertebrates, exhibiting behaviors that suggest advanced cognitive abilities, such as learning, problem-solving, and communication. In particular, octopuses have been known for their ability to solve complex puzzles, such as opening jars, navigating mazes, and manipulating objects in creative ways. Octopuses like the common octopus (Octopus vulgaris) have demonstrated learning through observation and trial-and-error. Additionally, some squids can learn to avoid predators by associating specific cues (like the presence of certain predators) with danger. These traits and abilities can be used for enabling multi-modal orchestration for human-animal-robot collaborative task execution.

The aquatic life within body of water 102 can include one or more whales, indicated generally at 108. The whales can include Baleen whales (Mysticeti) and/or toothed whales (Odontoceti). The Baleen whales can include the Blue Whale (Balaenoptera musculus), Humpback Whale (Megaptera novaeangliae), Fin Whale (Balaenoptera physalus), Minke Whale (Balaenoptera acutorostrata), and/or other varieties of Baleen whale. The toothed whales can include a Sperm Whale (Physeter macrocephalus), Beluga Whale (Delphinapterus leucas), Narwhal (Monodon monoceros), and/or other types of toothed whale.

The environment 100 may include one or more marine life wearable electronic devices, such as indicated at 138, affixed to whale 108. The marine life wearable electronic device 138 can include one or more sensors, such as a GPS receiver. The GPS receiver may obtain geolocation data for the whale 108 at times when the whale surfaces. The marine life wearable electronic device 138 may further include one or more acoustic positioning sensors for using triangulation with other devices, such as buoys (122, 124) and/or seafloor detection devices (132, 134) to determine a relative position. The marine life wearable electronic device 138 may further include an accelerometer and gyroscope for tracking movement data, including swimming behavior, diving depth, and/or orientation.

Since whales may communicate via sound, and some whales use echolocation to navigate and find prey, the marine life wearable device 138 may include sensors to detect these sounds or transmit sounds to communicate with the whale 108. The sensors can include a hydrophone to detect vocalizations from the whale (such as songs, calls, or clicks) and record ambient underwater sounds. The marine life wearable device 138 may further include a transducer configured and disposed to emit sounds or vocalizations that can be heard by the whale, facilitating communication and/or behavioral studies. In embodiments, the transducer is tuned to output sounds in frequencies that whales can hear and interact with. In one or more embodiments, the marine life wearable device 138 may further include a haptic module. The haptic module can enable the marine life wearable device 138 to provide tactile feedback to the whale. The haptic vibrations can be delivered through components such as a waterproof vibration device that creates a physical sensation, in order to provide feedback to the whale.

The acoustic communication with whale 108 can include complex vocalizations and communication methods. These sounds can serve various purposes, including navigation, identification, mating, and social interactions. The types of sounds whales produce and the patterns they follow depend on the species, as different whales communicate in different ways. The sounds can include ‘songs.’ These songs are complex, long sequences of sounds that often repeat in patterns and can last for several minutes to hours. Male humpback whales are especially known for their songs, which may be used for mating purposes. The songs consist of different “themes” that are repeated in a specific order and may change over time. The songs can carry for miles underwater, allowing males to attract females or compete with other males.

The sounds can include clicks. The clicks can be short, sharp sounds that are used primarily for echolocation (a form of biological sonar). By emitting clicks and analyzing the returning echoes, whales can navigate and detect prey. In some species, clicks are used for communication, especially in social species like orcas and dolphins, where they may serve to coordinate group behavior or signal social intentions. The sounds can include low-frequency sounds. The low-frequency sounds vary from low-frequency moans and grunts to more intense roars, which are thought to be used for communication over long distances. The sounds are often very deep and can travel hundreds of miles across the ocean. The sounds can include non-vocal sounds, such as tail slaps. Some whales, such as humpback whales, may use physical slaps of their tails (flukes) or pectoral fins to produce sounds that may be used for communication, signaling aggression, or coordinating with others in their group. In one or more embodiments, the sound patterns, and corresponding animal behaviors may be stored in a database or other suitable format to serve as training data for one or more machine learning systems to facilitate interspecies communication between humans and/or one or more non-human animal species.

The marine life wearable device 138 further includes a power source, such as a rechargeable or replaceable battery. In some embodiments, the marine life wearable device 138 may be a disposable device with a one-time use sealed battery, such as a lithium-ion battery. In one or more embodiments, the marine life wearable device 138 may be affixed via a strap to the tail fin, or other appendage of the whale. In embodiments, the strap can be comprised of a biodegradable material that dissolves or decomposes over time, enabling the marine life wearable device 138 to fall off the whale after a period of time, such that the device does not cause any permanent discomfort for the whale. In some embodiments, the marine life wearable device 138 may be affixed via a biodegradable adhesive. The biodegradable adhesive can include a starch-based adhesive and can be formulated to wear off after a period of time, enabling the marine life wearable device 138 to fall off the whale, such that the device does not cause any permanent discomfort for the whale.

The environment 100 may further include an autonomous underwater vehicle 140. The autonomous underwater vehicle 140 can be an electromechanical device that includes an onboard computer for receiving commands and/or data from ship 120, buoys (122, 124), marine life wearable device 138, and/or seafloor detection devices (132, 134). Embodiments can include receiving additional human communication data, and outputting the additional human communication data to one or more electromechanical devices, such as autonomous underwater vehicle 140. Embodiments can include receiving additional human communication data, and outputting the additional human communication data to one or more electronic devices, such as a remote computing device located on ship 120.

The types of tasks performed by the multi-modal orchestration for human-animal-robot collaborative task execution can include search and rescue, exploration, surveillance, and/or other suitable tasks. Environment 100 can include a shipwreck 145. As an example, to determine the precise location of the shipwreck, size of the debris field of the shipwreck, and/or other information, a collaborative task involving humans (e.g., on ship 120), robots (e.g., autonomous underwater vehicle 140), and non-human animals (e.g., whale 108, octopus 114, and/or dolphins 110, 112) can be executed by using AI-enabled interspecies communication techniques, along with Simultaneous Localization and Mapping (SLAM) techniques enabled by sensors, satellite receivers, radar, lidar, RF-based triangulation, and/or other suitable techniques, as will be further described in the description for the figures that follow.

In one exemplary embodiment, the SLAM subsystem is radically enhanced through the integration of a hybrid, multi-modal sensor fusion architecture that unifies deep-learning-based feature extraction with advanced geometric optimization and uncertainty-aware data association techniques. Building upon the core ideas of AirSLAM and SP-SLAM, the system employs a unified point-line network (PLNet) that concurrently detects both keypoints and structural line features under varying illumination conditions, thereby ensuring robust performance even in the presence of dramatic lighting changes. This deep network is augmented with a tri-plane encoding strategy that efficiently captures scene appearance data while preserving geometric fidelity, enabling dense 3D mapping with minimal memory overhead. The extracted features are then fused with inertial and other sensor inputs via lightweight matching algorithms—such as those inspired by LightGlue—to enable real-time visual-inertial odometry, which continuously refines camera pose estimates without relying on traditional keyframe selection.

Simultaneously, the system leverages a plane-based optimization framework reminiscent of the Eigen-Factors approach, where raw 3D point cloud data from LiDAR or RGB-D sensors is aggregated into a compact summation matrix that captures point-to-plane residuals at linear complexity. By decoupling plane estimation from trajectory optimization through a bilevel formulation, the SLAM subsystem achieves rapid convergence and enhanced accuracy even in complex, cluttered environments. Moreover, the incorporation of Bayesian inference techniques—integrating Random Finite Set (RFS) theory—allows the system to model feature uncertainty probabilistically, thereby eliminating the need for heuristic-based data association. This unified approach ensures that ambiguous or occluded features are handled in a statistically robust manner, significantly reducing localization drift and map inconsistency.

Further advancing these capabilities, the SLAM subsystem integrates uncertainty-aware sensor fusion mechanisms that explicitly model the noise characteristics of diverse sensor modalities. For instance, radar measurements are processed using a polar-coordinate uncertainty model that transforms measurement covariances into Cartesian coordinates, while visual sensors benefit from adaptive weighting schemes based on real-time confidence estimates derived from deep-learning predictions. These uncertainty-aware residuals are incorporated into a weighted least-squares optimization framework that dynamically adjusts the influence of each sensor input according to its reliability, ensuring robust performance even in adverse conditions such as low-light, high-dynamic-range, or noisy sensor environments.

In addition, the SLAM framework is further empowered by a multi-modal integration layer that synchronizes data streams from heterogeneous sources—including visible and infrared cameras, acoustic sensors, underwater LiDAR, and electromagnetic sensors—into a coherent spatial-temporal model. Advanced cross-attention mechanisms are employed to correlate features across modalities, yielding a unified representation that is then used to construct and continuously update a dense, real-time map of the environment. This layer also supports a predictive relocalization strategy, wherein a scene-dependent junction vocabulary and directed acyclic graph (DAG) representation of reasoning steps enable rapid recovery from localization failures. As new data is incorporated, the system dynamically refines both the map and the corresponding agent poses, ensuring seamless adaptation to changes in the operational environment.

Collectively, these enhancements—encompassing adaptive deep feature extraction, plane-based bilevel optimization, uncertainty-aware fusion, and multi-modal data integration—yield a SLAM subsystem that not only overcomes the limitations of conventional approaches but also surpasses state-of-the-art systems in terms of accuracy, robustness, and computational efficiency. By integrating these advanced techniques into the multispecies orchestration framework, the invention achieves unprecedented situational awareness and real-time mapping performance, thereby enabling robust, scalable, and resilient coordinated task execution across diverse domains such as terrestrial, maritime, aerial, and space environments.

In one exemplary embodiment, the SLAM subsystem is radically reengineered to integrate a hybrid, multi-modal data fusion pipeline that not only overcomes the limitations of current visual SLAM systems in dynamic environments but also exceeds the capabilities of DVDS and advanced LiDAR-visual-inertial semantic mapping approaches. In this embodiment, the system first deploys a dual-phase dynamic object exclusion mechanism that simultaneously processes visual and LiDAR inputs using a multi-task deep neural network framework. This framework leverages state-of-the-art image classification, object detection, and semantic segmentation algorithms to filter out transient, moving objects from static scene elements prior to feature extraction. By doing so, the system isolates reliable features even in environments with heavy occlusions, low-texture regions, or rapidly changing illumination, thereby preventing dynamic interference from corrupting downstream optical flow estimation and point cloud registration.

Once dynamic objects are removed, the filtered data is fed into an enhanced transformer-based feature aggregation module—termed the Dispersive Transformer (DisFormer)—which builds on the concept of Top-K Sparse Attention (TKSA) and Mixed-Scale Feed-Forward Networks (MSFN). DisFormer is designed to extract robust, high-dimensional feature representations from both dense visual frames and sparse LiDAR scans by selectively focusing on the most informative signal components while discarding redundant information. This novel transformer module is seamlessly integrated with a gated recurrent unit (GRU) that iteratively refines pose estimates through dense bundle adjustment, effectively combining temporal information with deep semantic cues to continuously update camera and sensor trajectories in real time.

Further distinguishing this embodiment, an object-level semantic mapping layer is incorporated to handle complex, natural environments such as forests, urban scenes, and industrial settings where GNSS signals are unreliable. This layer employs innovative cluster-block data structures that perform object-level segmentation and tracking; for example, in forested environments, individual tree trunks are segmented from LiDAR point clouds and associated with semantic labels obtained from corresponding visual data. These object-level features are then incorporated into a global optimization framework that minimizes mapping drift by enforcing consistency constraints across multiple frames and sensor modalities. This robust semantic mapping capability not only enhances localization accuracy but also provides rich contextual information that can be used for subsequent interspecies coordination and task execution.

To ensure the system operates in real time on embedded platforms, advanced uncertainty-aware sensor fusion techniques are deployed. Each sensor input—whether visual, LiDAR, inertial, or radar—is assigned a dynamically computed confidence score based on its noise characteristics and environmental conditions. These confidence metrics modulate the weighting of individual sensor contributions within a weighted least-squares optimization framework, thereby enhancing robustness to sensor noise, illumination changes, and partial occlusions. By leveraging GPU-based acceleration and efficient inference engines, the entire SLAM pipeline is optimized for low latency, enabling continuous, real-time mapping and localization even under challenging dynamic conditions.

Collectively, these innovations yield a SLAM subsystem that not only filters dynamic elements and robustly extracts discriminative features using novel transformer-based methods but also integrates object-level semantic understanding and uncertainty-aware sensor fusion into a unified, adaptive mapping framework. This comprehensive approach significantly reduces pose estimation errors and mapping drift, while also providing the high-fidelity, context-rich spatial data necessary for coordinated task execution across heterogeneous domains—including terrestrial, maritime, aerial, and even space environments—thereby setting a new benchmark for real-world SLAM performance.

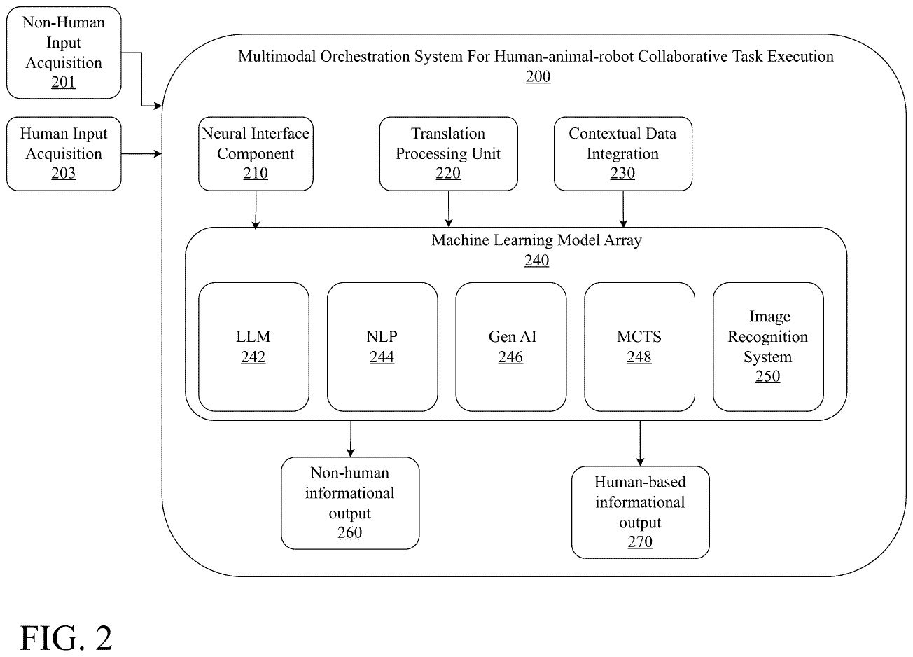

FIG. 2 is a block diagram illustrating components of a system for multi-modal orchestration for human-animal-robot collaborative task execution, in accordance with one or more embodiments. System 200 can receive as input, non-human input acquisition 201, and human input acquisition 203. The non-human input acquisition 201 can include input from animals. The input can include audio input. The audio input can include vocalizations such as songs, clicks, chirps, groans, roars, and the like. The audio input can include phonemes and/or words, such as from certain species of birds that are capable of mimicking and producing phonemes from human languages. The audio input can include non-vocal sounds such as tapping or banging sounds from tapping limbs, appendages, or the like. The non-human input acquisition 201 can further include visual information such as sign language gestures, such as may be performed by various primates. The human input acquisition 203 can include spoken language, text input, sign language, and/or other suitable input. The non-human input acquisition 201 and human input acquisition 203 are input to the system for multi-modal orchestration for human-animal-robot collaborative task execution 200, and the resulting output can include a non-human informational output 260, and a human-based informational output 270, thereby facilitating interspecies communication.

The system 200 can include a neural interface component 210. The neural interface component 210 can enable the detection of nuanced neural responses from animals that indicate social, emotional, and environmental interactions. The animals can include land animals, such as horses, cats, and dogs. The animals can include aquatic animals, such as whales, dolphins, fish, octopus, and squid. The animals can include birds and other flying animals. In embodiments, the neural interface component 210 may be coupled to the animals to obtain signals indicative of emotional states, and/or other communication patterns.

The system may include phylogenic trees, pangenome graphs, or other methods to incorporate evaluation of genomic or multiomics data whenever available. Below is an exemplary embodiment that builds upon and surpasses prior ideas by integrating multiomics and phylogenomic data into the communication orchestration system. In this embodiment, an optimal multiomics and Phylogenomic Communication Orchestration Module (OMPCOM) is introduced. This module is designed to ingest not only the heterogeneous environmental and behavioral sensor data described previously (e.g., acoustic, olfactory, visual, and haptic signals) but also genomic and multiomics information that can be derived from available databases, field-deployed genomic sensors, or even prior ex vivo sequencing of target species. By leveraging advanced data structures such as pangenome graphs and indexing methods like the Graph Burrows-Wheeler Transform (GBWT), the system can rapidly match haplotype segments and evaluate genetic markers that correlate with sensory modalities and communication preferences. In practice, OMPCOM first receives raw multiomics data—ranging from whole-genome sequencing reads to transcriptomic and proteomic profiles—from target animals or representative samples thereof. A dedicated Genomic Data Integration Engine (GDIE) constructs pangenome graphs that capture the full spectrum of genomic variation for the species under consideration. Using GBWT-based algorithms, the system performs efficient haplotype matching to identify key genetic variations, such as allelic variants of olfactory receptor families, auditory sensitivity genes (for example, genes modulating low-frequency hearing thresholds), or vision-related opsin proteins. In parallel, the system builds phylogenetic trees from these haplotype datasets to infer evolutionary relationships and kinship, which can serve as proxies for shared sensory preferences or communication behaviors among individuals and subspecies. By establishing these genomic “communication profiles,” the system can predict the modalities that are likely to be most effective for each target animal or group. Once the genomic profiles are established, OMPCOM fuses this data with real-time environmental and behavioral sensor inputs using a neurosymbolic fusion engine. For instance, if the genomic data reveal that a particular subpopulation of whales possesses genetic markers indicative of heightened low-frequency hearing sensitivity and an evolved propensity for acoustic crypsis (as demonstrated in flight species that call below 80 Hz), then the system will favor the use of low-intensity, low-frequency acoustic signals when communicating with those individuals. Conversely, if genomic markers suggest that certain terrestrial animals, such as domesticated cattle or elephants, have a predisposition for robust olfactory reception due to expansive receptor gene families, the system may select calibrated scent emissions as the primary communication channel in environments where auditory cues are compromised by urban noise. The decision algorithm employs reinforcement learning techniques in a multi-armed bandit framework to weigh the expected utility of each communication modality—considering factors such as environmental noise, predation risk, and even the potential for inadvertent aggregation of non-target species—and updates its modality-selection policy dynamically as additional multiomics and contextual data become available. Furthermore, OMPCOM may be operated in an open, partially open or within a closed-loop feedback system. After a communication event, behavioral responses (e.g., changes in movement patterns, physiological responses measured via wearable biosensors, or even genomic stress markers captured through rapid point-of-care assays) are analyzed to refine both the genomic profiles and the modality selection policy. This iterative process is supported by adaptive caching of frequently observed genomic subgraphs and phylogenetic motifs, which are stored using run-length-compressed indices (e.g., via GBWT) to ensure near-linear space complexity even when operating at biobank scale. The integration of these genomic data structures not only enhances the precision of interspecies communication but also enables the system to adjust for evolutionary pressures—for example, by detecting shifts in haplotype frequencies that may correlate with changes in communication efficacy due to environmental stressors like noise pollution or habitat fragmentation. By combining environmental sensor fusion, real-time SLAM-derived context, and the cutting-edge processing of multiomics data through pangenome graphs and phylogenetic analyses, this embodiment achieves a truly interdisciplinary approach. It leverages computational genomics methods to inform and optimize multispecies communication strategies, thereby surpassing traditional modality selection systems. This innovative integration enables the orchestration system to adaptively choose between acoustic, olfactory, visual, and haptic outputs with unprecedented precision, ensuring that messages are delivered in a form that maximizes reception by the intended species while minimizing unintended interactions—whether in a busy urban environment, a predator-dense ocean, or a field setting where evolutionary histories dictate distinct sensory preferences.

The system 200 can include a translation processing unit 220. The translation processing unit 220 can utilize machine learning models which are trained to correlate neural patterns of animals to known behaviors, vocalizations, and intentions. The system 200 can include a contextual data integration module 230. The contextual integration module 230 can combine modalities (such as neural signals, vocalizations, gestural data, and/or scent vectors) in a multi-modal fusion layer. A sliding time window provides temporal alignment, associating changes in scent concentration with concurrent neural or behavioral shifts. The outputs of the neural interface component 210, translation processing unit 220, and/or contextual data integration model 230 are input to machine learning model array 240.

Machine learning model array 240 may include one or more machine learning models, neural networks, and/or other systems for processing and interpreting input data. The machine learning model array 240 can include a large language model 242. The large language model (LLM) 242 can be trained for specific animals (e.g., species-specific or even individual-specific) and can ingest continuous streams of neural population data recorded across multiple tasks and states. These models go beyond simple language: they become multi-modal encoders of animal neural signals, motor outputs, observed behaviors, and contextual cues. By structuring training data to include “high-incentive” versus “neutral” tasks, the LLM can learn when the animal's neural signature deviates from its optimal preparatory patterns. In embodiments, the machine-learning system includes a large language model (LLM).

The machine learning model array 240 can include a natural language processing (NLP) module 244. The NLP module 244 can enable the conversion of human speech to animal-understandable patterns. The NLP module 244 can include NLP pipelines that parse human language into semantic tokens. These tokens can then be mapped onto a species-specific “neural command embedding space.” For whales, this might involve converting a request such as ‘swim to the surface’ into a neural stimulation pattern, along with an auditory output pattern such as a song or pattern of clicks. For canines, this might involve converting a request like “Fetch the red ball” into a neural stimulation pattern plus a subtle auditory or tactile cue that aligns with the dog's pre-trained internal representations of the action “fetch” and the visual concept “red ball.”

The system 200 can include a translation processing unit 220. The translation processing unit 220 can utilize machine learning models which are trained to correlate neural patterns of animals to known behaviors, vocalizations, and intentions. The system 200 can include a contextual data integration module 230. The contextual integration module 230 can combine modalities (such as neural signals, vocalizations, gestural data, and/or scent vectors) in a multi-modal fusion layer. A sliding time window provides temporal alignment, associating changes in scent concentration with concurrent neural or behavioral shifts. The outputs of the neural interface component 210, translation processing unit 220, and/or contextual data integration model 230 are input to machine learning model array 240.

Machine learning model array 240 may include one or more machine learning models, neural networks, and/or other systems for processing and interpreting input data. The machine learning model array 240 can include a large language model 242. The large language model (LLM) 242 can be trained for specific animals (e.g., species-specific or even individual-specific) and can ingest continuous streams of neural population data recorded across multiple tasks and states. These models go beyond simple language: they become multi-modal encoders of animal neural signals, motor outputs, observed behaviors, and contextual cues. By structuring training data to include “high-incentive” versus “neutral” tasks, the LLM can learn when the animal's neural signature deviates from its optimal preparatory patterns. In embodiments, the machine-learning system includes a large language model (LLM).

The machine learning model array 240 can include a natural language processing (NLP) module 244. The NLP module 244 can enable the conversion of human speech to animal-understandable patterns. The NLP module 244 can include NLP pipelines that parse human language into semantic tokens. These tokens can then be mapped onto a species-specific “neural command embedding space.” For whales, this might involve converting a request such as ‘swim to the surface’ into a neural stimulation pattern, along with an auditory output pattern such as a song or pattern of clicks. For canines, this might involve converting a request like “Fetch the red ball” into a neural stimulation pattern plus a subtle auditory or tactile cue that aligns with the dog's pre-trained internal representations of the action “fetch” and the visual concept “red ball.”

The machine learning model array 240 can include a generative artificial intelligence (Gen AI) module 246. The Gen AI module 246 can enable supplementing training data with synthesized data, such as vocal data (e.g., canine vocalizations or whale codas), where the vocal data is created with properties such as number and regularity of signal units (clicks, barks), spectral means, and/or amplitude envelopes. The Gen AI module 246 can include a generative adversarial network (GAN), such as WaveGAN, InfoGAN, fiwGAN, and/or other suitable GAN.

The machine learning model array 240 can include a Monte Carlo Tree Search (MCTS) module 248. The MCTS module 248 can enable adaptive, look-ahead scheduling decisions. Instead of applying fixed heuristics or static load-balancing, disclosed embodiments can simulate and/or evaluate multiple future states of the pipeline before choosing the next action. By repeatedly exploring and exploiting different pipeline routing decisions (e.g., which specialist model to send partial outputs to, or how to scale certain pipeline segments), MCTS can minimize the cumulative regret over time, converging toward near-optimal scheduling policies that are robust to changing conditions, input distributions, and latency constraints. In one or more embodiments, the MCTS module 248 can enable enhanced resource allocation, such as allocating more GPUs, selecting specialized hardware accelerators, and/or adjusting batch sizes downstream.

The machine learning model array 240 can include an image recognition system 250. Image recognition system 250 may utilize machine learning to identify objects and gestures in images and video clips. The training can include obtaining a large dataset of labeled images or video clips that include the objects and/or gestures that are to be identified. Using techniques such as convolutional neural networks (CNNs), relevant features from the images are automatically extracted. A machine learning model (e.g., a deep learning model) is trained on the extracted features. Once trained, the model can be used to predict the presence of objects or gestures in new, unseen images and/or video clips. The images and/or video clips can include images of non-human animals exhibiting facial expressions, performing gestures, and/or other interpretable behaviors. Image recognition system 250 may further utilize Haar cascades for object detection. One or more embodiments can include training the Haar cascade classifier using a combination of positive samples and negative samples. The training process can include selecting the most relevant features and creating a cascade of classifiers.

The machine learning model array 240 can include, as an output, non-human informational output 260. The non-human informational output 260 can include audio output. The audio output can include species-specific audio waveforms such as clicks and songs for cetaceans, growling and/or barking sounds for canines, and so on. In an aquatic environment such as depicted in FIG. 1, the audio output may be provided by underwater speakers or other suitable transducers. The non-human informational output can include visual output, such as flashing lights, and/or patterns rendered and presented on an electronic display that is visible to the animals that are participating in the system and/or method for multi-modal orchestration for human-animal-robot collaborative task execution.

The machine learning model array 240 can include, as an output, human-based informational output 270. The human-based informational output 270 can include visual information such as text and/or symbology. The human-based informational output 270 can include audio information. The audio information can include synthesized speech, tones, and/or other sounds to convey information identified by the machine learning model array 240. Referring again to the example depicted in FIG. 1, for investigation of the shipwreck 145, the non-human informational output 260 can include audio waveforms that may be interpreted by a whale 108 to swim to a location proximal to the shipwreck 145. The whale 108 may then output audio vocalizations in response to viewing the shipwreck. The output audio vocalizations can be translated by the system 200 to human-based informational output 270 for interpretations by humans. In this way, the non-human informational output 260 and the human informational output 270 can work in tandem to enable human-animal-robot collaborative task execution.

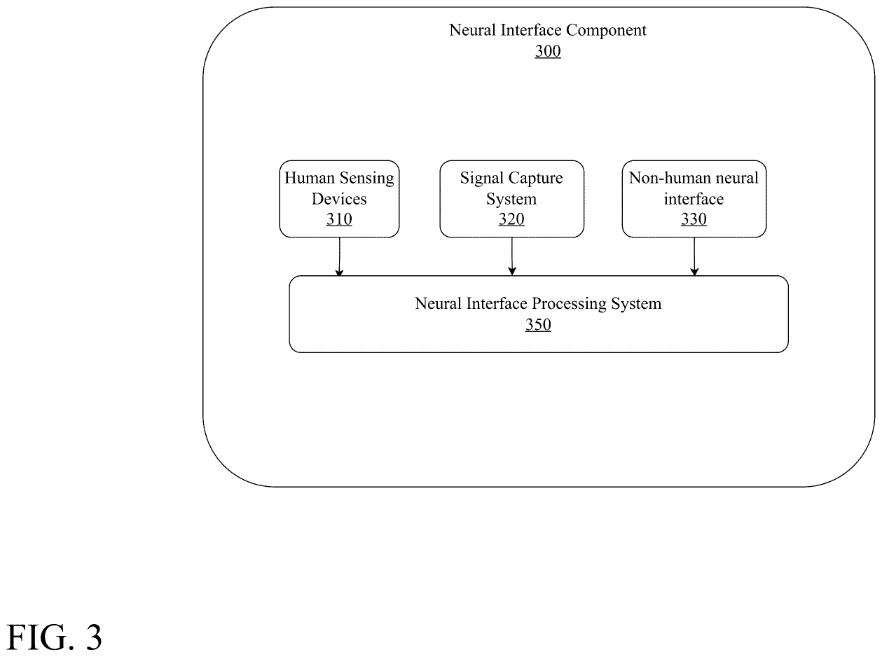

FIG. 3 is a block diagram illustrating details of a neural interface component, in accordance with one or more embodiments. Neural interface component 300 may be similar to neural interface component 210 of FIG. 2, and can include one or more human sensing devices 310. The human sensing devices 310 can include wearable sensors, such as pulse sensors, brainwave monitors, and the like. The human sensing devices 310 can further include cameras, microphones, and/or other sensors for obtaining cognitive state information from a human. The data received by the human sensing devices may be used with NLP module 244 to extract additional context and sentiment, meaning, or instruction from humans participating in human-animal-robot collaborative task execution.

Neural interface component 300 can include a signal capture system 320. The signal capture system 320 can include one or more sensors for capture of neural and physiological signals without distress, adjusted for the physical characteristics of animals, such as cetaceans. In embodiments, neural sensors are embedded within wearable and/or attachable devices suited for underwater and open-ocean deployment. In embodiments, the neural interface includes components tailored to the species' specific anatomy, such as the head or dorsal regions in whales, and made from materials that ensure durability and comfort even in the deep-sea environment.

Neural interface component 300 can include a non-human neural interface 330. The non-human neural interface 330 can include non-invasive sensors that can detect and measure animal brain activity without causing discomfort. These sensors capture neural signals associated with emotions, intentions, and responses to stimuli. The non-human neural interface 330 can further include implanted sensors. Embodiments can include surgically implanting sensor probes inside an animal's brain. In embodiments, this technique can be used in place of a non-invasive sensor package, and can yield additional control and benefits that include the ability to record specific thoughts, evaluate mental state, and other aspects outside of the direct intent to communicate. This also enables capturing the animal's sensory data such as vision and scent. This allows human/animals to not only communicate freely, but opens additional options for working animals. For example, a dog must pass extensive training before it can sniff drugs. With disclosed embodiments, the training may be drastically shortened by reading the animal's brain patterns directly and identifying targeted substances via this data. As part of the training, the non-human informational output 260 (of FIG. 2) may produce a signal to cause happiness or the notion of correctness as a positive reward and drastically speed training times and animal willingness.

The output of the human sensing devices 310, signal capture system 320, and non-human neural interface 330 can be input to neural interface processing system 350. Neural interface processing system 350 can include an AI-based processing unit that analyzes and interprets vocalization data, behavioral cues, and environmental contexts to foster bidirectional communication between humans and non-human animals. Disclosed embodiments can be well-suited for applications ranging from enhancing human-animal interactions for conservation to advancing scientific understanding of animal languages, particularly in highly social and intelligent species such as sperm whales. Furthermore, disclosed embodiments can enable the use of environmental and behavioral metadata integration, as well as robust machine learning frameworks, allowing creation of an adaptable model for studying communication across various species, making disclosed embodiments adaptable to diverse animal communication needs beyond cetaceans, such as canines, primates, and other species.

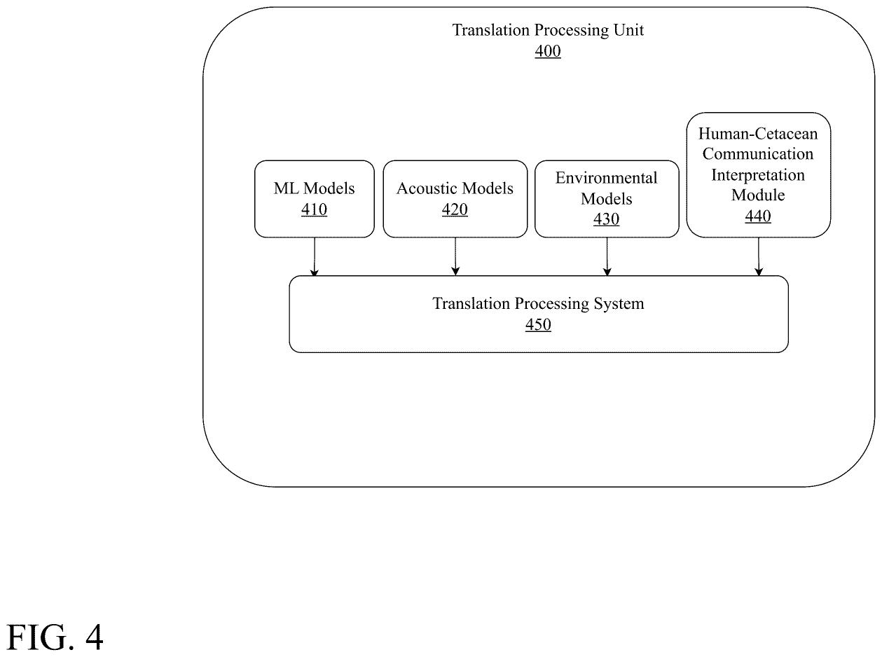

FIG. 4 is a block diagram illustrating details of a translation processing unit, in accordance with one or more embodiments. Translation processing unit 400 may be similar to translation processing unit 220 of FIG. 2, and can include one or more machine learning models 410. In embodiments, the machine learning models 410 can be trained to identify patterns in vocalization, such as codas, tempo, rhythm, ornamentation, and contextual variations like rubato. This training enables disclosed embodiments to decode structured and nuanced elements of cetacean communication, potentially revealing hierarchical or associative structures similar to human language. The translation processing unit 400 can include one or more acoustic models 420. The acoustic models 420 may enable replication of fricative production. This includes adjusting tongue position, airflow velocity, and constriction points. The translation processing unit 400 can further include one or more environmental models 430. The environmental models 430 can include probabilistic models to capture the uncertainty and variability inherent in fricative sound production and perception. The translation processing unit 400 can further include a human-cetacean communication interpretation module 440. In embodiments, the human-cetacean communication interpretation module 440 can enable mappings between humans and cetaceans. As an example, the clicks, songs, and codas of whales can be processed via machine learning, and mapped to human sentiment, meaning, or instructions, such as danger, affection, joy, aggression, curiosity, and/or cooperation. In embodiments, the human sentiment, meaning, or instruction can be derived from animal outputs, such as sounds made by animals, gestures made by animals, facial expressions made by animals, and so on. The danger may be represented by high-pitched whistles, rapid clicks, and/or abrupt calls. Affection may be represented by soft clicks, whistles, and/or low-pitched moans. Joy may be represented by rapid clicks, whistles, and/or varied, upbeat vocalizations. Aggression may be represented by loud, forceful vocalizations, grunts, or low-frequency rumbles. Curiosity may be represented by short bursts of clicks. Cooperation may be represented by repetitive clicking patterns. In general, cetacean sounds may be catalogued and correlated to a behavioral context.

The translation processing system 450 receives input from the ML models 410, acoustic models 420, environmental models 430, and human-cetacean communication interpretation module 440. The translation processing system 450 can be configured to convert animal neural patterns into human-comprehensible language, conveying the emotional state, intentions, and/or needs of the animal. The translation processing system 450 can further be configured to translate human speech into neural signals or cues that are meaningful and understandable to animals, allowing the animals to comprehend specific commands or sentiment, meaning, or instructions directly. In embodiments, the translation processing system 450 may be configured to produce spoken translations of animal communications, thereby allowing humans to understand an animal's emotions or needs. For instance, the system might translate a dog's neural signals into phrases like “I am hungry” or “I'm feeling anxious.”

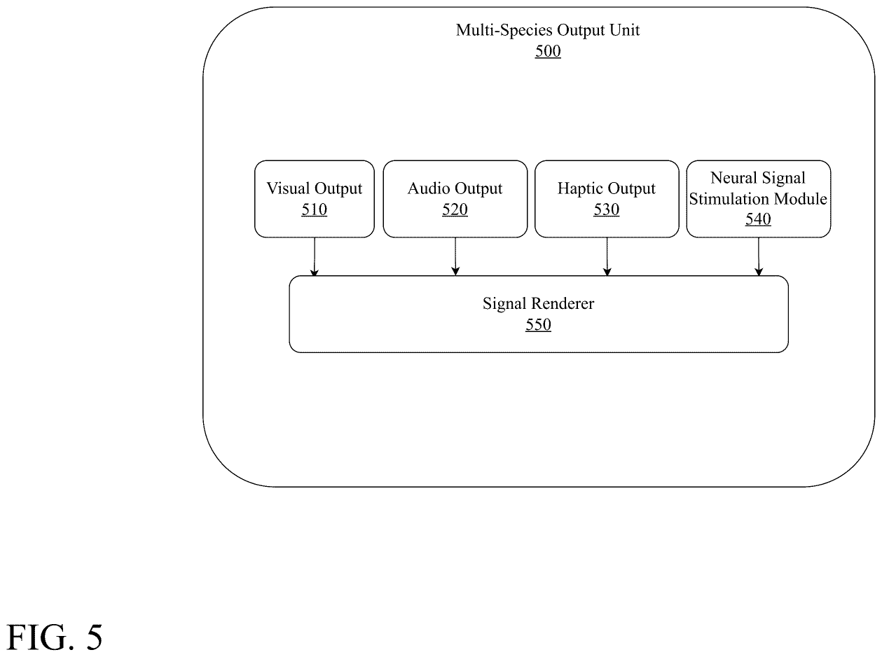

FIG. 5 is a block diagram illustrating details of a multi-species output unit 500, in accordance with one or more embodiments. The multi-species output unit is an innovative computerized system designed to facilitate communication between humans and animals by integrating multiple sensory modalities for output. The visual output subsystem 510 processes and assembles video and image data for output on an electronic display. The visual output is tailored to the perceptual capabilities of the target species, ensuring that animals or humans can interpret the visual signals effectively. The audio output subsystem 520 can be configured to generate audio waveforms that can be output through speakers or other audio devices. The audio output can include species-specific sounds, such as vocalizations, frequencies, or tones, enabling communication in a form recognizable by the intended animal. The haptic output subsystem 530 generates and modulates signals to drive vibratory devices, creating tactile sensations that can be detected via wearable sensors or directly on the animal's skin. The haptic feedback can convey information such as alerts, directions, or emotional cues. The neural signal stimulation module 540 can include electrodes capable of monitoring and interacting with brainwaves of an animal. It can record neural activity and deliver carefully modulated stimulation to influence or reinforce specific neural patterns. This capability offers potential for advanced applications, such as training, behavior modification, or facilitating direct neural communication. The signal renderer module 550 serves as the central decision-making unit, determining the most appropriate output device for each signal. It integrates the outputs from the visual, audio, haptic, and neural modules and ensures that the signals are delivered in a coherent and species-appropriate manner. In embodiments, the multi-species output unit 500 may be integrated into, or communicatively coupled with, non-human informational output 260 and/or human-based informational output 270.

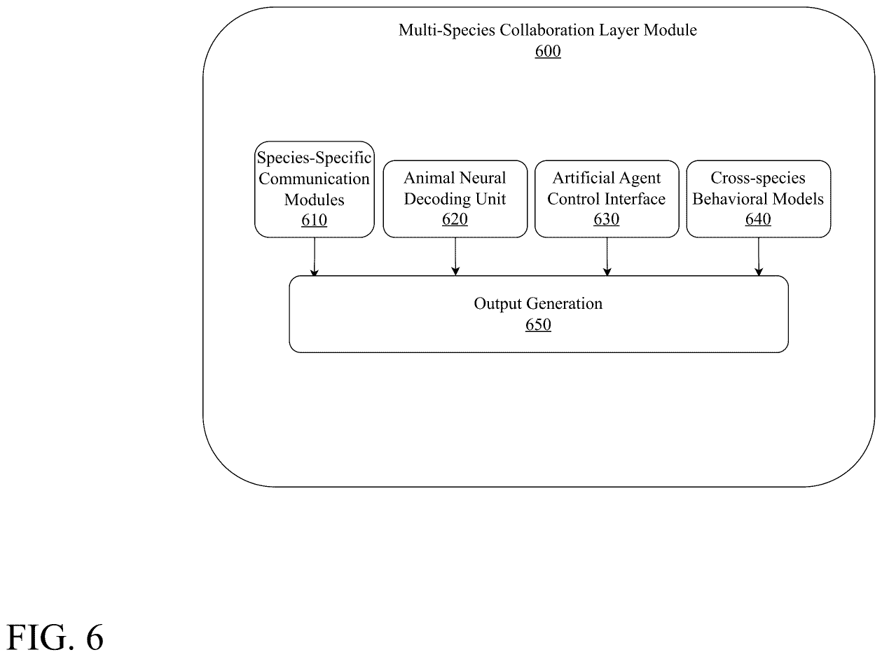

FIG. 6 is a block diagram illustrating details of a multi-species collaboration layer module 600, in accordance with one or more embodiments. The Multispecies Collaboration Layer (MCL) builds on the foundational capabilities of neural interfaces, multi-modal sensory processing, and language modeling techniques, extending them to facilitate purposeful, synchronized interaction across species or between animals and machines. Its key functions are to understand interspecies “vocabularies,” align goals, and orchestrate collaborative tasks. The MCL module 600 can include one or more species-specific communication modules 610. In embodiments, each participating species (e.g., dogs, elephants) or artificial agent (e.g., a drone) has its own communication interface and representation layer.

The MCL module 600 can further include an animal neural decoding unit 620. The animal neural decoding unit 620 can be configured to extract interpretable “meaning vectors” from the animal's neural signals and observed behavior. As an example, for a dog, neural patterns plus posture/vocalization cues can produce a “conceptual state embedding” representing intentions and emotional states. The MCL module 600 can further include an artificial agent control interface 630. For a drone, sensor data (LIDAR, camera, GPS) and command frameworks are translated by the artificial agent control interface into abstract action representations (e.g., “search pattern initiated,” “altitude adjustment needed”). The MCL can further include one or more cross-species behavioral models 640. These models can utilize a library of known behavioral cues and tasks common to various species (e.g., “move towards scent,” “alert upon detection of target”) to produce standardized action and intention descriptors.

The MCL module 600 further includes an output generation module 650 that receives input from the species-specific communication modules 610, animal neural decoding unit 620, artificial agent control interface 630, and/or cross-species behavioral models 640. The output generation module 650 then generates an appropriate output signal, which can include a video signal, audio signal, haptic signal, and/or other bioelectrical signal for conveying sentiment, meaning, or instruction and/or meaning among humans and non-human animals. The output generation module 650 can output data in a wide variety of digital and/or analog formats, including pulse code modulated (PCM) audio, raw video formats, compressed video formats, and/or other suitable formats.

In embodiments, the Multispecies Collaboration Layer can be configured to provide a unified, context-driven platform enabling animals of different species, as well as robots and/or drones, to collaborate effectively on shared tasks. By creating and refining interspecies dictionaries, using ML models to align intentions, and carefully timing and routing these concepts through a shared task representation space, the MCL module 600 can enable synchronized, purposeful action. This can profoundly enhance capabilities in wildlife conservation, service support, and environments where diverse species and agents work in concert to achieve common goals. In embodiments, the MCL module 600 can be integrated with, or communicatively coupled to, system 200 of FIG. 2.

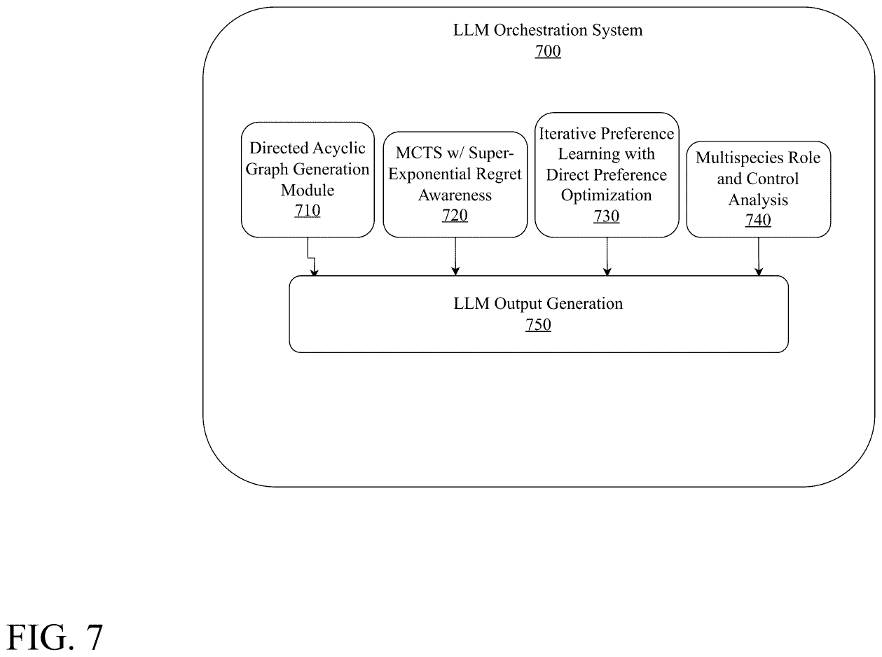

FIG. 7 is a block diagram illustrating details of a large language model (LLM) orchestration system 700, in accordance with one or more embodiments. In embodiments, LLM orchestration system 700 may be integrated with, or communicatively coupled to, LLM 242 of FIG. 2. LLM orchestration system 700 can include directed acyclic graph (DAG) generation module 710. The DAG generation module 710 can create a DAG representing complex workflows in which nodes are reasoning steps, and edges represent transitions from one partial solution to another. In some embodiments, each node encodes the current state of the environment, such as position and behavior of animals, humans' textual instructions, and/or robot sensor readings. The DAG's expansions can correspond to MCTS-like searches over possible reasoning paths, guided by previously described methods (e.g., embedding caches, semantic KGs, preference learning). Embodiments can include generating a directed acyclic graph to represent a plurality of reasoning steps corresponding to the multispecies coordinated task execution.

The LLM orchestration system 700 can include MCTS w/Super Exponential Regret Awareness module 720. In this context, “super-exponential regret” refers to the phenomenon where certain algorithms, specifically the Upper Confidence bounds applied to Trees (UCT) and its variants like AlphaGo's Monte Carlo Tree Search (MCTS), can experience regret that grows at a super-exponential rate under specific conditions. Regret, in this setting, measures the difference between the actual performance of the algorithm and the optimal performance it could have achieved. This module 720 may adjust model parameters to reduce or minimize regret, thereby improving performance. The adjustments made by module 720 can include modifying exploration-exploitation tradeoffs (e.g., fine-tuning of exploration constants in UCT).

The LLM orchestration system 700 can include iterative preference learning with direct preference optimization module 730. In embodiments, each node's expansions produce step-level preference data: which partial expansions yield better outcomes (improved translation quality, correct interpretation of animal signals). After collecting these preferences (through MCTS expansions and intermediate verification from debate steps), module 730 can apply Direct Preference Optimization (DPO) to refine the LLM's underlying policy. Over multiple cycles, on-policy sampled data enable the LLM's decision-making to improve at picking high-value expansions from the start. This reduces reliance on brute-force exploration and counters the conditions leading to super-exponential regret.

The LLM orchestration system 700 can include multispecies role and control analysis module 740. In embodiments, module 740 can model agents as having different influence roles, which can dynamically encourage certain agents to lead expansions in known-productive directions. Moreover, module 740 can be configured to let other agents anchor or block suspicious expansions (such as an octopus punching unhelpful fish), which are translated into immediate pruning of subgraphs in the reasoning DAG.

The LLM orchestration system 700 can include an LLM output generation module 750 which receives as input, outputs from the directed acyclic graph generation module 710, MCTS with Super Exponential Regret Awareness module 720, include iterative preference learning with direct preference optimization module 730, and/or multispecies role and control analysis module 740. The output from the LLM output generation module 750 can include information for human consumption, such as textual information, knowledge-based outputs, and/or structured data. The output from the LLM output generation module 750 can include information for robot consumption, such as commands, sensor data, and/or other command and control information. The output from the LLM output generation module 750 can include information for animal consumption, such as audio waveforms intended for interpretation by animals, such as tones and/or click patterns for cetaceans, tones and/or sounds for canines, and so on. Other signals for representation in visual and/or haptic domains may also be output by LLM output generation module 750 in some embodiments.

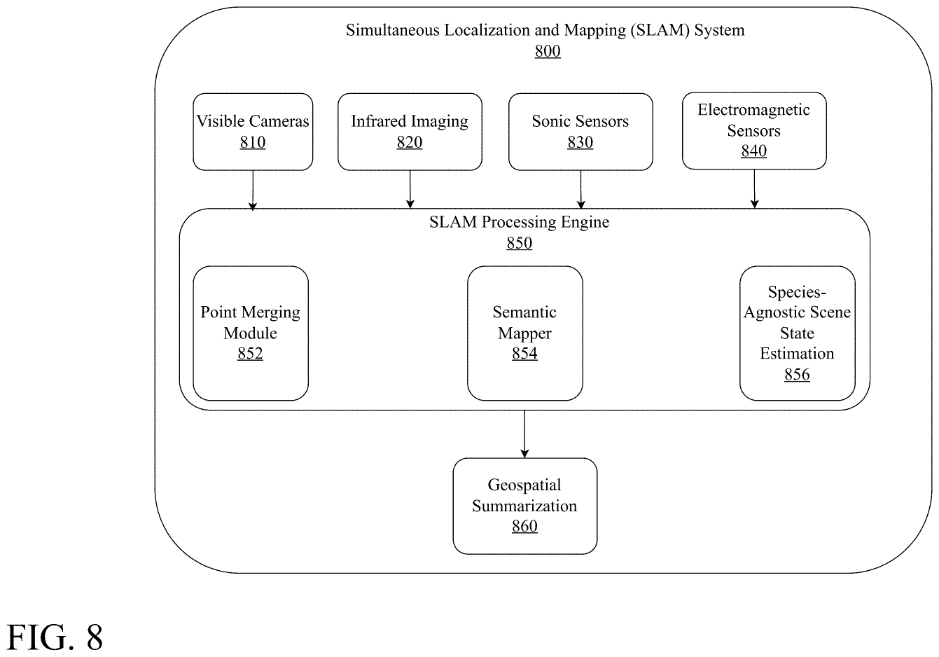

FIG. 8 is a block diagram illustrating details of a Simultaneous Localization and Mapping (SLAM) system 800, in accordance with one or more embodiments. In embodiments, SLAM system 800 may be integrated with, or communicatively coupled to, system for multi-modal orchestration for human-animal-robot collaborative task execution 200 of FIG. 2. System 800 can include visible cameras 810, infrared imaging sensors 820, sonic sensors 830, and/or electromagnetic sensors 840. The visible cameras 810 may be configured to detect light in the visible spectrum (roughly 400-700 nanometers), which is the range of light perceptible to the human eye, and capture colors and details as humans see them, relying on external light sources (e.g., sunlight or artificial lighting) to illuminate a scene. The visible cameras can include wide-angle cameras, telephoto cameras, and so on. The infrared imaging sensors 820 can be configured to detect light in the infrared spectrum (beyond 700 nanometers), which is invisible to the human eye. In some embodiments, the infrared imaging sensors 820 can include thermal cameras that can capture emitted heat radiation from objects, even in complete darkness, without requiring external illumination. The sonic sensors 830 can include microphones and/or hydrophones. The microphones can include dynamic microphones, condenser microphones, electret microphones, and/or other suitable types of microphones. The hydrophones can include piezoelectric hydrophones that use piezoelectric materials to detect pressure changes in water caused by sound waves. The hydrophones can include vector sensors that measure both sound pressure and particle motion within water. The hydrophones can include a hydrophone array that includes multiple hydrophones arranged in a specific geometry to detect sound from multiple directions.

The electromagnetic sensors 840 can be configured to detect and measure electromagnetic fields or properties, such as electrical conductivity, magnetic fields, and electromagnetic radiation. The electromagnetic sensors 840 can include fluxgate magnetometers, suitable for detecting magnetic anomalies from seafloor rocks, or identifying metallic objects like shipwrecks or submarines. The electromagnetic sensors 840 can include proton precession magnetometers that can measure the magnetic field based on the precession of protons in water or a fluid. In one or more embodiments, the electromagnetic sensors can include optically pumped magnetometers, electric field detectors, capacitive sensors, electromagnetic induction sensors, and/or other suitable types of electromagnetic sensors.

The inputs from visible cameras 810, infrared imaging sensors 820, sonic sensors 830, and electromagnetic sensors 840 can be input to SLAM processing engine 850. SLAM processing engine 850 can include a point merging module 852. In embodiments, the point merging module 852 can include functions and instructions for combining multiple data points that correspond to the same real-world feature. This helps refine the map, reduce noise, and improve localization accuracy. SLAM processing engine 850 can include a semantic mapper 854. In embodiments, the semantic mapper 854 can include functions and instructions for enabling humans to interpret animal emotional states or intentions through augmented reality interfaces linked to embeddings and semantic mapping. The semantic mapper 854 may further include a Semantic Alignment Agent that can refine cross-domain mappings accordingly. Moreover, SLAM processing engine 850 can further include a species-agnostic scene state estimation module 856. In embodiments, the species-agnostic scene state estimation module 856 can include functions and instructions for utilizing data from visible light cameras to determine color and depth of a scene, enabling a 3D reconstruction of an environment. The species-agnostic scene state estimation module 856 can further include functions and instructions for utilizing data from ultraviolet (UV) and/or hyperspectral sensors, which can provide benefits as some animal signals might be visible only in UV or certain spectral bands, revealing hidden patterns (like UV-reflective markings on fish or subtle changes in an octopus's skin). The species-agnostic scene state estimation module 856 can further include functions and instructions for utilizing data from lidar scanners that produce high-resolution point clouds for both indoor and outdoor environments. In one or more embodiments, radar can complement lidar in poor visibility conditions. The species-agnostic scene state estimation module 856 can further include functions and instructions for utilizing data from sonic and/or acoustic sensors to capture vocalizations from a wide variety of animals. Embodiments can further utilize beamforming and/or signal processing in order to locate sound sources and/or identify distress calls, barks, or other meaningful vocal patterns in non-human animals.

The output of the SLAM processing engine 850 can include a geospatial summarization 860. The geospatial summarization 860 can include data that can be rendered and presented on an electronic display to show features such as a map panel that indicates animal locations, terrain features, and environmental conditions. One or more embodiments can further include icons representing animals that are updated in real-time, displaying status indicators such as color-coded stress levels, activity patterns, and the like. The data output of geospatial summarization 860 can include data in a variety of raster, vector, and/or other suitable formats.

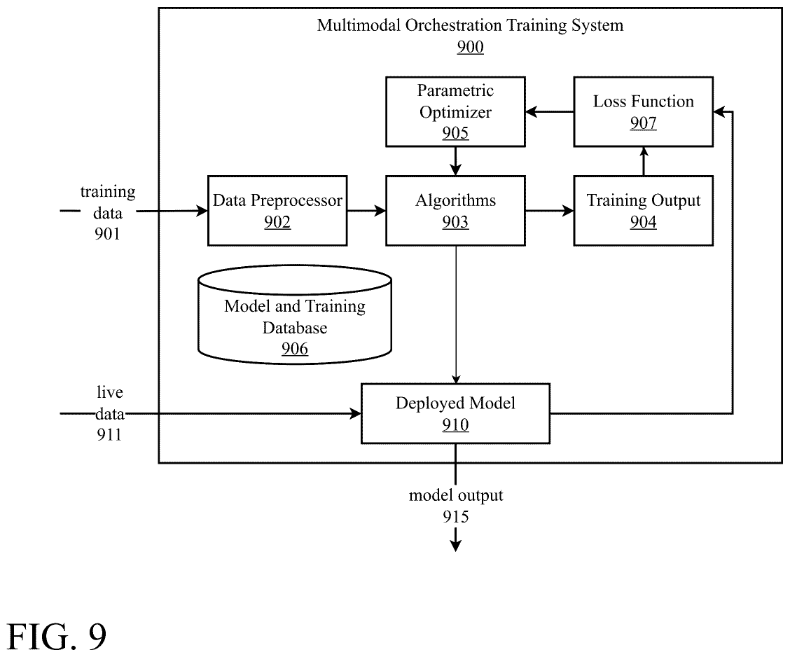

FIG. 9 is a block diagram illustrating an exemplary training system for multi-modal orchestration for human-animal-robot collaborative task execution, in accordance with one or more embodiments. In embodiments, system 900 may comprise a model training stage comprising a data preprocessor 902, one or more machine and/or deep learning algorithms 903, training output 904, a parametric optimizer 905, and a model deployment stage comprising a deployed and fully trained model 910 configured to perform tasks described herein such as enabling multi-modal orchestration for human-animal-robot collaborative task execution. The system 900 may be used to train and deploy a plurality of AI subsystems in order to support the services provided by the system for multi-modal orchestration for human-animal-robot collaborative task execution.

At the model training stage, a plurality of training data 901 may be received by the training system 900. Data preprocessor 902 may receive the input data (e.g., human feedback, human input data, animal input data, animal feedback, robot/sensor inputs, and the like) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 902 may also be configured to create a training dataset, a validation dataset, and/or a test set from the plurality of input data 901. For example, a training dataset may comprise 80% of the preprocessed input data, the validation set 10%, and the test dataset may comprise the remaining 10% of the data. The preprocessed training dataset may be fed as input into one or more machine and/or deep learning algorithms 903 to train a predictive model for tasks that can include interspecies communication, geospatial mapping, and/or object monitoring and detection.

During model training, training output 904 is produced and used to measure the accuracy and usefulness of the predictive outputs. During this process a parametric optimizer 905 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the training system 900 to evaluate a model's performance. Metrics can include, but are not limited to, word error rate (WER), word information loss, cetacean response times, predicted animal response compared with actual animal response, and normalization error rate, to name a few. In one embodiment, the system may utilize a loss function 907 to measure the system's performance. The loss function 907 compares the training outputs with an expected output and determines how the algorithm needs to be changed in order to improve the quality of the model output. During the training stage, all outputs may be passed through the loss function 907 on a continuous loop until the algorithms 903 are in a position where they can effectively be incorporated into a deployed model 915.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 910 in a production environment making predictions based on live input data 911 (e.g., user preferences, user feedback, user inputs). Further, model correlations and restorations made by deployed model can be used as feedback and applied to model training in the training stage, wherein the model is continuously learning over time using both training data and live data and predictions. A model and training database 906 is present and configured to store training/test datasets and developed models. Database 906 may also store previous versions of models.

According to some embodiments, the one or more machine and/or deep learning models may comprise any suitable algorithm known to those with skill in the art including, but not limited to, LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 903 may comprise a deep learning algorithm such as neural networks (e.g., recurrent, convolutional, long short-term memory networks, etc.).

In some implementations, the training system 900 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 906.

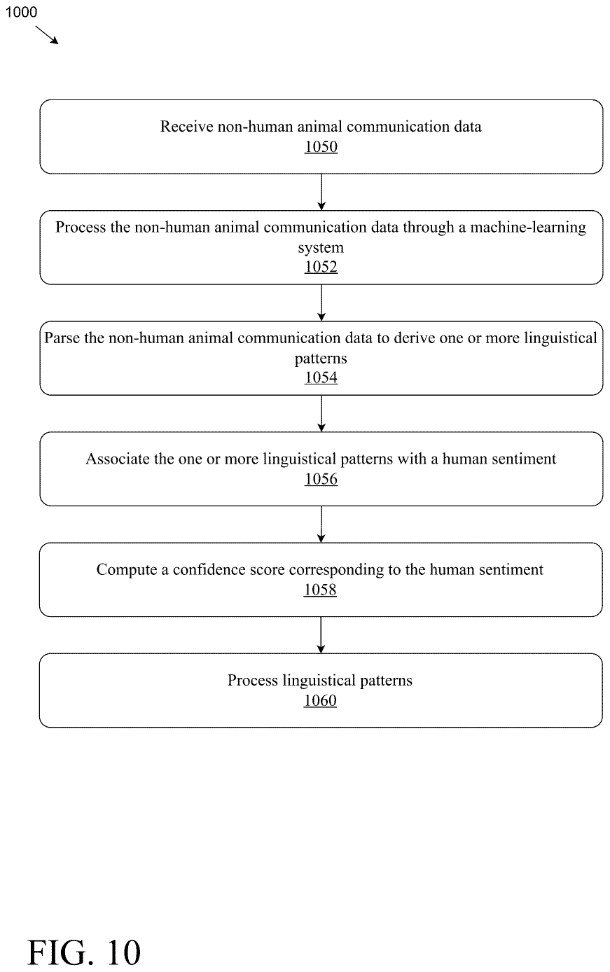

FIG. 10 is a flow diagram illustrating an exemplary method 1000 for multi-modal orchestration for human-animal-robot collaborative task execution, in accordance with one or more embodiments. At block 1050, non-human animal communication data is received. The non-human animal communication data can include audio communication, such as vocalizations, clicks, songs, barks, and the like, visual communication such as expressions and/or gestures, and/or other forms of non-human animal communication. The method 1000 continues to block 1052 where the non-human animal communication data is processed through a machine learning system. The machine learning system can include a convolutional neural network (CNN), a deep learning neural network, a feedforward neural network (FNN), a recurrent neural network (RNN), autoencoder, and/or other suitable machine learning system. The method 1000 continues to block 1054 with parsing the non-human animal communication to derive one or more linguistic patterns. The linguistic patterns can include audio waveforms representing clicks, songs, grunts, howls, barks, and/or other audio sounds generated by animals as communication. The method 1000 continues to block 1056 where the one or more linguistic patterns can be associated with a human sentiment, meaning, or instruction. As an example, a particular pattern of clicks can be associated with a human sentiment, meaning, or instruction, meaning, or instruction of fear, curiosity, concern, and/or other human sentiment, meaning, or instruction/emotion. In one or more embodiments, a machine learning model is trained to derive a human sentiment, meaning, or instruction, human emotion, and/or human language meaning based on the parsed non-human animal communication data. Embodiments can include parsing the non-human animal communication data to derive one or more linguistic patterns from cetaceans. The method 1000 continues to block 1058, where a confidence score corresponding to the human sentiment, meaning, or instruction is computed. The confidence score can be indicative of how likely the parsed non-human animal communication data refers to the human sentiment, meaning, or instruction. Computing a confidence score for a machine learning prediction involves estimating how likely it is that the prediction is correct. Various mathematical techniques can be used depending on the model type, data characteristics, and application. One embodiment may utilize a softmax function for computing a confidence score. One or more embodiments may utilize Platt scaling to apply logistic regression to transform raw model outputs into calibrated probabilities. One or more embodiments may utilize Bayesian approaches to compute posterior probability distributions. One or more embodiments may utilize a Monte Carlo Dropout technique to apply dropout during inference multiple times and compute the variance of the outputs, where a higher variance can be indicative of a lower confidence. Other techniques, such as confidence intervals, entropy-based confidence, mutual information, likelihood ratios, and/or ensemble learning may also be used instead of, or in addition to, the aforementioned techniques. Embodiments can include, in response to the human sentiment, meaning, or instruction exceeding a predetermined threshold: rendering and presenting an audio/visual form of the human sentiment, meaning, or instruction on an electronic display. The human sentiment, meaning, or instruction can be translated from animal output, such as animal sounds, animal gestures, animal facial expressions, and so on. The method 1000 continues to block 1060 where the linguistic patterns are processed. The processing of the linguistic patterns can include converting the linguistic patterns into text, synthesized speech, and/or other format for rendering and presenting the linguistic patterns to humans. Thus, disclosed embodiments can present animal communication in a form that is easily understood by humans, thereby facilitating communication between humans and non-humans.

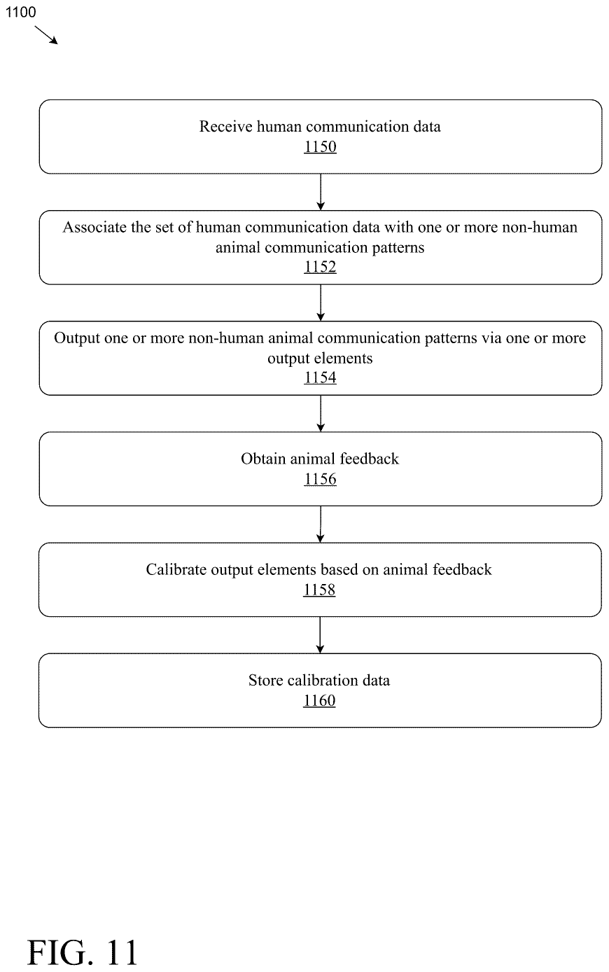

FIG. 11 is a flow diagram illustrating an exemplary method 1100 for processing non-human animal communication patterns, in accordance with one or more embodiments. At block 1150, human communication data is received. The human communication can be received as text, speech, gestures, and so on. The human communication can include directional-based information. The directional-based information can include commands and/or requests for cetaceans, such as a request to surface, dive, swim to a specified location, and so on. The method 1100 continues to block 1152, where the set of human communication data is associated with one or more non-human animal communication patterns. As an example, a request for a dolphin to come to the surface can be translated into an audio pattern, such as clicks and squeaks that may be associated with sounds dolphins may make as they approach the surface of the water. The method continues to block 1154 where one or more hon-human animal communication patterns are output via one or more output elements. The output elements can include speakers, underwater speakers, underwater transducers, lights, electronic displays, and so on.

The method 1100 continues with obtaining animal feedback 1156. The animal feedback can be obtained via microphones, on-body wearable sensors, cameras, and/or other suitable interfaces. The animal feedback can include sounds, gestures, facial expressions, and the like. The method 1100 continues to block 1158 for calibrating the output elements based on animal feedback. The calibrating can include adjusting volume, frequency, and/or other audio attributes to optimize the response of the animals. As an example, if the targeted animals do not follow the requests, the volume can be increased, the frequency can be adjusted, and so on, in an effort to find the optimal parameters to elicit the desired response from the animals. The method 1100 continues to block 1160, where the calibration data is stored in a non-transitory computer-readable medium such as non-volatile memory, so that it can be used for future human-animal-robot collaborative task execution sessions.

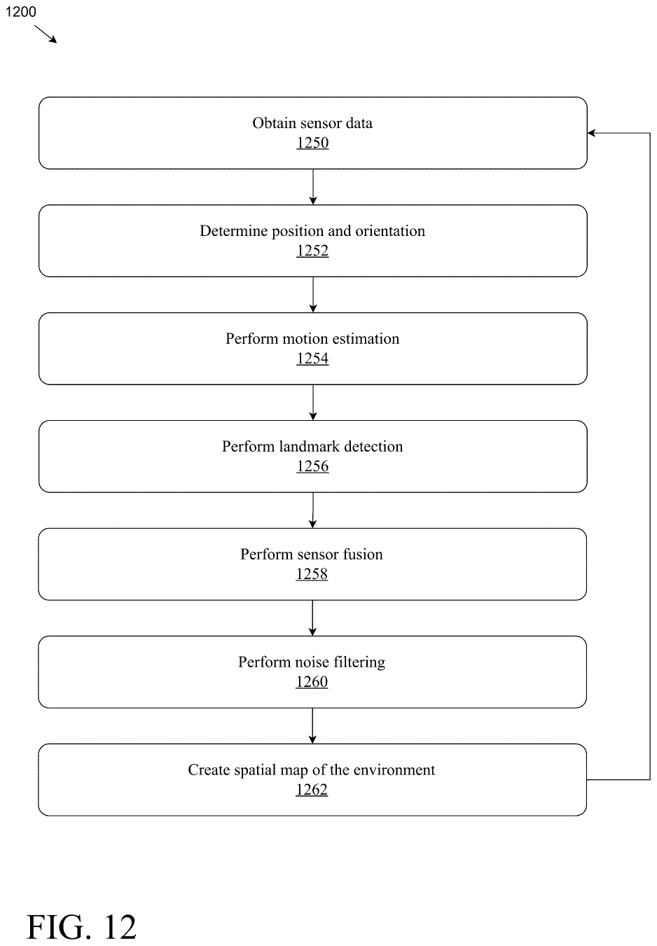

FIG. 12 is a flow diagram illustrating an exemplary method 1200 for SLAM processing in accordance with one or more embodiments. Embodiments can include a Simultaneous Localization and Mapping (SLAM) system. The method 1200 starts with obtaining sensor data at block 1250. The sensors can include accelerometers, gyroscopes, magnetometers, cameras, radar, lidar, acoustic sensors, microphones, and so on. The method 1200 continues with determining position and orientation at block 1252. In one or more embodiments, the position is determined via a satellite positioning system, such as GPS. The determining of position may utilize an acoustic-based positioning system, especially in underwater environments. The acoustic-based positioning system can include an Ultra-Short Baseline (USBL) system, Short Baseline (SBL) system, Long Baseline (LBL) system, Doppler Velocity Log (DVL), and/or other suitable system. In one or more embodiments, the acoustic-based positioning system may be used in conjunction with an internal navigation system (INS) that includes one or more gyroscopes and/or accelerometers. The orientation may be determined via accelerometers, tilt sensors, gyroscopes, and or other suitable devices. One or more embodiments may utilize sensor fusion to combine one or more data sources, such as a combination of accelerometers, gyroscopes, and magnetometers, in order to determine position and/or orientation.

The method 1200 continues to block 1254, where motion estimation is performed based on the obtained sensor data, and determined position and/or orientation. This can include performing dead reckoning (e.g., from wheel encoders or Inertial Measurement Units (IMUs)) to estimate movement of an object. The method 1200 continues to block 1256 where landmark detection is performed. This can include identifying unique features or landmarks in the environment (e.g., rocks, geological features, and/or specific objects). The landmark detection can serve to help correct drift and improve localization. The method 1200 then continues to block 1258, where sensor fusion is performed. The sensor fusion can serve to combine data from multiple sensors to improve accuracy, reduce noise, and compensate for weaknesses in individual sensors. The sensors can include an inertial measurement unit (IMU), GPS (Global Positioning System), Doppler Velocity Log (DVL), sonar, cameras, radar, lidar, acoustic positioning systems, and/or other types of sensors. The method 1200 continues to block 1260 where noise filtering is performed. The noise filtering can include low-pass filtering, high-pass filtering, Kalman filtering, particle filtering techniques, and/or other suitable types of filtering. The method 1200 continues to block 1262, where a spatial map of the environment is created. In one or more embodiments, the spatial map can include vector data formats such as GeoJSON, GPKG, Shapefile, and so on. In one or more embodiments, the spatial map can include raster data formats such as GeoTIFF, Erdas Imagine, ASCII Grid, and so on. The spatial map can include 3D data formats such as lidar point cloud data that includes elevation and/or bathymetry. Other formats may be used in one or more embodiments. The method 1200 continues back to block 1250 as a continuous process of simultaneous location and mapping. Embodiments can include processing directional-based information that is obtained from the SLAM system, such as objects moving towards the water surface, objects moving deeper into the water, and so on.

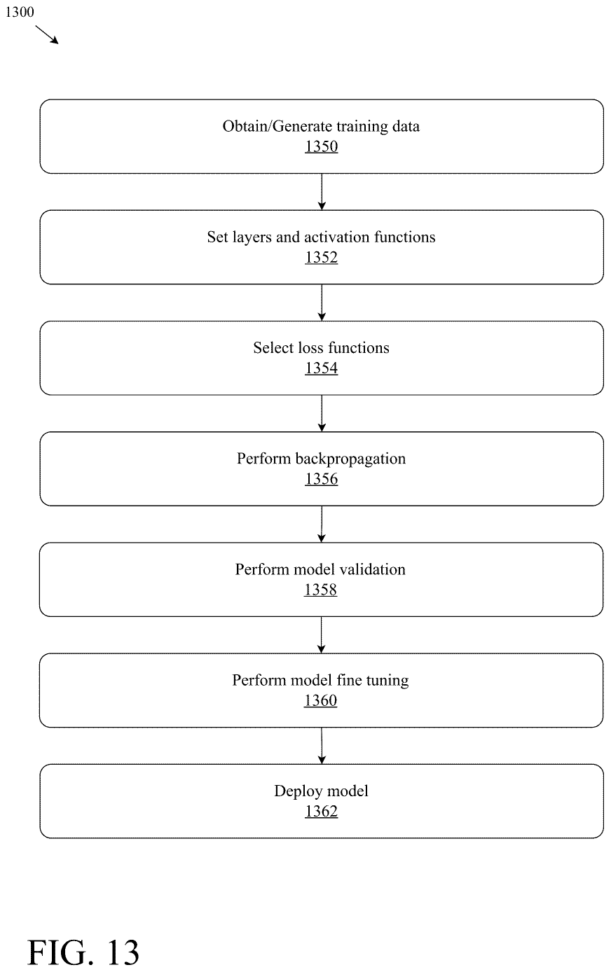

FIG. 13 is a flow diagram illustrating an exemplary method for training a system for multi-modal orchestration for human-animal-robot collaborative task execution, according to one or more embodiments. The method 1300 starts with obtaining and/or generating training data at block 1350. The training data can include human communication data, non-human animal communication data, as well as synthesized data that is generated for supplementing human communication data and/or non-human animal communication data. The synthesized data can be derived from a generative AI network, such as a GAN. The method 1300 continues with setting layers and activation functions at block 1352. In a neural network, layers are the building blocks that form the structure of the network. Each layer consists of a collection of neurons (also called nodes or units), and each neuron performs a specific computation on the input data. The output of one layer becomes the input to the next layer, creating a series of transformations from the input to the output. The layers can include input layers, output layers, and/or hidden layers. The activation functions introduce non-linearity into the model, allowing it to learn and represent complex patterns in the data. In embodiments, the activation functions can include a sigmoid function, a hyperbolic tangent function, a rectified linear unit (ReLU), a Leaky ReLU, softmax function, and/or other suitable activation function. The method 1300 continues to block 1354 for selecting loss functions. The loss functions are mathematical functions used in machine learning to measure the difference between the predicted values produced by the model and the actual target values from the training data. In one or more embodiments, the loss functions can include Mean Squared Error (MSE), Mean Absolute Error (MAE), Categorical Cross-Entropy, and/or other suitable loss functions. The loss functions can be used to determine if the model is sufficiently trained. The method 1300 continues to block 1356 for training the model using backpropagation. The backpropagation process can include computing gradients of the loss with respect to the weights and biases in the output layer. These gradients are propagated backward through the neural network to the hidden layer. The method 1300 continues to block 1358, where the model is validated. The validation can include using an additional set of non-human animal communication data that was not part of the original training dataset as a test dataset. The non-human animal communication data can be translated to human communication data to confirm proper operation of the model. The method 1300 can include model fine-tuning at block 1360. The model fine-tuning can include adjusting weights and/or other hyperparameters as needed to improve model output. The method 1300 continues to block 1362, where the model is deployed for use in orchestration for human-animal-robot collaborative task execution.

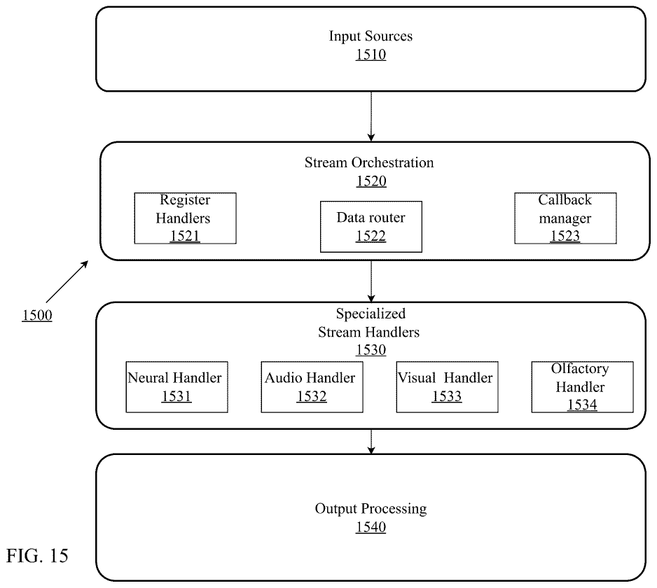

FIG. 15 is a block diagram illustrating a partial output stream processor designed as a multi-layered system that contains diverse input sources 1500. At the input layer 1510, the system accepts data from neural sensors that capture real-time neural signals from animal subjects, audio microphones and record vocalizations and environmental sounds, visual cameras that capture behavioral and environmental context, and olfactory sensors that detect chemical signatures and scents. All these input feed continuously into the system, providing real-time data streams that need immediate processing.

The stream orchestrator 1520 serves as the central coordination unit. The orchestrator contains three primary components: a registration system 1521 for managing specialized stream handlers, a sophisticated data router 1522 that directs incoming data streams to appropriate processing units, and a callback manager 1523 that coordinates output processing and event handling. This orchestration layer ensures that data flows efficiently through the system while maintaining proper synchronization and timing.

The system implements specialized stream handlers 1530 for each type of input data. The neural handler 1531 processes incoming neural signals through a three-stage pipeline: first, a neural buffer temporarily stores incoming signal chunks; second, a neural processor performs real-time signal processing; and finally, a feature extractor derives meaningful patterns from the neural data. Similarly, the audio handler 1532 processes sound data through its own buffer, processor, and spectral analysis components, focusing on frequency and amplitude characteristics. The visual handler 1533 manages visual data through a frame buffer, image processor, and pattern analysis system, while the Olfactory handler 1534 processes chemical sensor data through its specialized buffer, processor, and chemical analysis components.

The output processing layer 1540 represents the final stage where all processed data streams converge. This layer performs multi-modal fusion, combining data from multiple handlers into a coherent representation. A feature aggregation system consolidates features across different modalities, while real-time analysis components provide immediate insights from the processed data. This layer ensures that the system can produce useful outputs without waiting for complete patterns to emerge, enabling rapid response times.

The entire system operates with parallel processing capabilities, where each handler runs independently in its own thread. This parallel architecture minimizes latency and prevents bottlenecks, allowing the system to handle multiple high-bandwidth data streams simultaneously. The buffering system employs circular buffers for efficient memory usage, with configurable sizes for different data types and automatic overflow handling. Real-time processing ensures that partial data chunks are processed immediately, without waiting for complete patterns, resulting in low-latency output generation.

The architecture maintains flexibility through its modular design, allowing easy addition of new handlers for different sensor types and configuration of processing parameters. Error handling is robust, managing data gaps and timing variations gracefully, while maintaining system stability under high load conditions. The system can automatically recover from temporary sensor failures, ensuring continuous operation even when individual components experience issues.

In operation, the workflow proceeds continuously: sensors stream data to the system, the Stream Orchestrator routes this data to appropriate handlers, and each handler processes its data stream in real-time. Processed features from all handlers feed into the multi-modal fusion system, which generates immediate insights available through the callback system. This continuous processing pipeline ensures that insights are available as quickly as possible while maintaining high data throughput and processing accuracy.

The system implements sliding window buffers for each modality to enable sophisticated temporal analysis and context awareness. For neural data, the system maintains both a short-term buffer capturing 1-2 seconds of high-frequency EEG-like signals and a longer-term state tracker covering 30-60 seconds, summarized into low-dimensional embeddings. Similar dual-window approaches are used for audio data, maintaining high-fidelity recent frames alongside a rolling 30-second history of spectral embeddings, and for gestural/movement data, combining high-frequency kinematic data for sudden change detection with down sampled historical data for baseline behavior analysis. A fusion layer periodically aligns and merges these modality-specific buffers every 100 ms using timestamps, ensuring proper cross-referencing of neural, vocal, and gestural events. This produces a unified “context embedding” that captures both immediate signals and aggregated longer-term patterns, enabling the system to adapt its processing parameters based on environmental conditions and stress levels. The Adaptive Decision-Making Module uses these context embeddings to dynamically adjust its lookback and lookahead strategies, modifying branching factors based on available computational resources and scenario complexity.

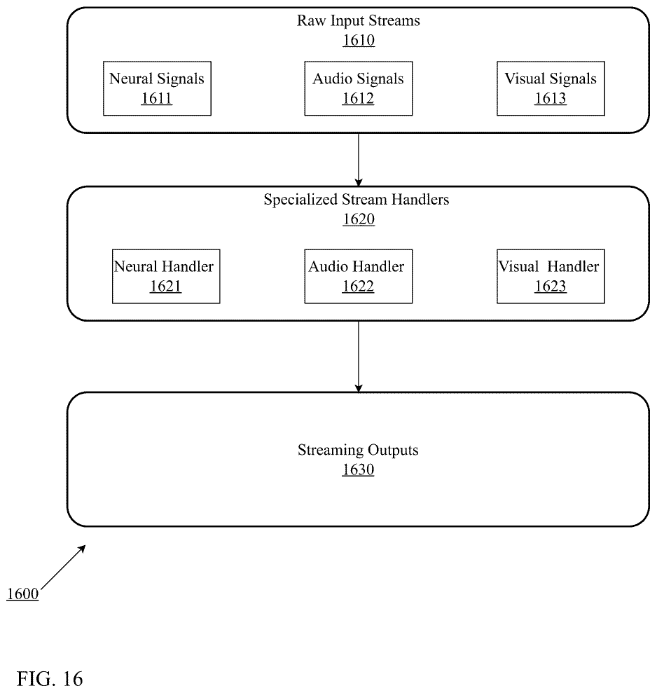

FIG. 16 is a block diagram illustrating a specialized stream handler representing a sophisticated real-time processing system consisting of three parallel but interconnected processing pathways 1600. The specialized stream handler 1600 represents a sophisticated implementation of ALTO's token streaming principles extended beyond traditional text processing to handle diverse sensor data streams. Unlike conventional systems that wait for complete data patterns, these handlers process partial outputs (“tokens”) from each modality as soon as they become available, significantly reducing latency and enabling near-immediate downstream processing.

The Neural Stream Handler 1621 processes partial neural signal data through a sophisticated windowing system. Instead of waiting for complete neural patterns, it processes data in small windows (typically 1-2 seconds) of high-frequency EEG-like signals, while simultaneously maintaining a longer-term state tracker (30-60 seconds) for behavioral pattern analysis. The handler employs a rolling buffer that continuously updates with new neural data chunks, computing features like mean power and peak frequencies in real-time. This approach allows for immediate detection of significant neural state changes while maintaining context through longer-term pattern analysis.

The audio stream handler 1622 implements a dynamic streaming approach for processing vocalization and environmental sound data. It operates on small audio frames (typically 25 milliseconds) to minimize latency while maintaining sufficient context for meaningful acoustic analysis. The handler performs real-time spectral analysis using Welch's method for power spectral density estimation, enabling immediate detection of significant acoustic events or changes in vocalization patterns. This continuous streaming approach allows for rapid detection of animal communications or environmental changes without waiting for complete utterances or sound patterns.

The Visual Stream Handler 1623 manages continuous streams of visual data, processing partial frame data as it arrives rather than waiting for complete image sequences. It employs a frame-by-frame analysis approach that extracts immediate features like mean intensity and standard deviation, enabling rapid detection of movement or environmental changes. This handler can be particularly crucial in scenarios requiring immediate response to visual cues, such as detecting sudden changes in animal behavior or environmental conditions.

Each handler implements the ALTO-inspired streaming architecture through a consistent interface that includes buffering, processing, and output generation components. The handlers utilize an aggregation-aware routing interface that ensures partial outputs are correctly combined before being passed to downstream processing stages. This approach enables hierarchical processing where initial feature extraction occurs immediately at the handler level, while more complex pattern analysis can occur as additional data becomes available.

A key in these handlers is their ability to dynamically adjust processing parameters based on computational load and data complexity. When detecting complex patterns or high-stress situations, the handlers can automatically adjust their processing windows and feature extraction parameters to maintain optimal performance while ensuring critical information is not missed. This adaptive approach allows the system to maintain low latency even under varying computational loads and data complexity levels.

The implementation includes sophisticated error handling and data quality assessment mechanisms. Each handler continuously monitors the quality of incoming data streams and adjusts its processing accordingly. For instance, if neural signals become noisy, the handler can automatically adjust its filtering parameters or rely more heavily on other modalities until signal quality improves. This robust approach ensures reliable operation even in challenging real-world conditions where sensor data quality may vary.

Through this integrated approach to partial output streaming and processing, the specialized handlers provide a foundation for real-time, multi-modal analysis of animal behavior and communication. They enable immediate response to changing conditions while maintaining the context necessary for accurate interpretation of complex behavioral patterns.

The specialized stream handlers represent a sophisticated real-time processing system consisting of three parallel raw input 1610 interconnected processing streams-Neural 1611, Audio 1612, and Visual 1613 streams. Each pathway is carefully engineered to handle continuous data streams while maintaining both immediate responsiveness and longer-term pattern recognition capabilities.

The specialized stream handlers 1620 may comprise the neural stream handler 1621, the audio handler 1622, and the visual handler 1623. The neural stream handler 1621 operates with a dual-buffer architecture—a short-term buffer processing 1-2 second windows of immediate neural signals, alongside a long-term buffer tracking 30-60 seconds of historical data. This dual-temporal approach allows the system to detect both rapid neural state changes and gradual shifts in baseline activity. The neural processor sits between these buffers, continuously extracting features through three parallel analysis streams: power analysis for measuring signal strength and neural activation levels, frequency analysis for detecting specific neural oscillation patterns, and pattern detection for identifying complex neural signatures associated with different behavioral states.

The audio stream handler 1622 employs a more granular approach with 25-millisecond frame buffers, optimized for capturing and processing vocalization patterns and environmental sounds. The audio processor feeds its data through a three-component spectral analysis system: spectral features extraction identifies key frequency components and energy distributions, waveform analysis examines temporal patterns and amplitude variations, and vocalization pattern recognition identifies specific types of animal communications or environmental signals. This high-temporal-resolution processing enables near-instantaneous detection of significant acoustic events while maintaining the context necessary for interpreting complex vocalizations.

The visual stream handler 1623 processes incoming visual data on a frame-by-frame basis through its dedicated buffer system. The visual processor feeds each frame through three parallel analysis pathways: intensity analysis measures brightness patterns and contrast variations, motion detection tracks dynamic changes between frames, and pattern recognition identifies specific visual features or behaviors of interest. This continuous visual processing stream enables immediate detection of relevant behavioral cues or environmental changes.

All three handlers feed their processed outputs 1630 into a sophisticated multi-modal fusion layer, where the system integrates information across all modalities. This fusion process feeds into a real-time analysis engine that can make immediate decisions or predictions based on the combined sensor data. The final stage involves an adaptive learning component that continuously refines the system's processing parameters based on observed patterns and outcomes.

Critical to the system's effectiveness is its streaming architecture, where data flows continuously through each processing stage without waiting for complete patterns to emerge. Each handler maintains its own quality control and error detection mechanisms, allowing it to adjust processing parameters in real-time based on data quality and computational load. The system's parallel processing architecture ensures that delays or issues in one stream don't impact the others, while the multi-modal fusion layer can compensate for temporary degradation in any single modality by relying more heavily on the others.

The entire system operates under the principle of continuous partial processing, where insights are generated and updated as new data arrives rather than waiting for complete patterns or sequences. This approach enables rapid response times while maintaining the context necessary for accurate interpretation of complex behavioral patterns.

The specialized stream handlers fundamentally extend ALTO's token streaming principles from language processing into multi-modal sensor data. While ALTO traditionally handles text tokens in language models, our system adapts these concepts to process “tokens” of neural signals, audio snippets, and visual frames. This represents a novel expansion of ALTO's partial output streaming architecture into the domain of animal-computer interaction.

Just as ALTO streams text tokens to enable early processing, each handler implements streaming of partial sensor data. For example, the neural stream handler doesn't wait for complete neural patterns but instead processes partial neural “tokens” (small windows of neural activity) as soon as they become available. These partial outputs are immediately routed downstream through an ALTO-inspired aggregation-aware routing interface, which ensures that even incomplete neural patterns can contribute to early decision-making.

The system incorporates ALTO's distributed prompt-aware scheduling concepts but extends them beyond text. In our implementation, “prompts” can be rapid bursts of neural activity, complex audio frames, or sporadic visual updates. The scheduling system dynamically detects these heterogeneous prompts and distributes processing load across multiple instances, preventing bottlenecks when multiple species or communication channels are active simultaneously.

ALTO's aggregation-aware routing principles are adapted to handle multi-modal data fusion. For instance, three partial scent signatures from an animal's neural decoding might be aggregated with one partial human instruction before being passed to a decision-making stage. This hierarchical approach to partial output combination ensures that semantic fidelity is maintained even as data streams continuously and asynchronously.

The system also extends ALTO's token-based streaming concept to enable early specialization. As partial embeddings of audio-video data or neural signals become available, the scheduler uses Monte Carlo tree search (MCTS) or upper confidence bound applied to trees (UCT) to decide whether to send them immediately to a specialist combiner or wait for more context. This dynamic branching ensures that heavy compute resources are only engaged when necessary.

Each handler implements look-ahead scheduling inspired by ALTO but adapted for sensor data. For example, if the audio handler detects the beginning of a complex vocalization pattern, it can preemptively allocate additional resources to handle the expected increase in processing demands, similar to how ALTO handles varying sizes and complexities of text prompts.

The system's implementation of partial output streaming and adaptive decision-making is particularly effective in high-stress environments such as search-and-rescue operations. In these scenarios, the system performs real-time fusion of short-term neural and audio data to detect sudden spikes in neural activity associated with stress, matching them against audio patterns indicating distress. The adaptive decision-making module increases its lookback periods in worsening conditions, such as when encountering loud noises or irregular terrain, to ensure no recent cues are missed. The system runs multiple branching hypotheses simultaneously to determine whether the animal is responding to specific scents, structural instability, or attempting to locate human victims while struggling with navigation. Based on these interpretations, the system can trigger immediate handler alerts or activate gentle neural stimulation patterns to calm or refocus the animal's attention. In therapeutic settings, such as with therapy dogs in hospitals, the system leverages its multi-modal cross-checking capabilities to compensate for noisy signals in any single modality, using its long-term windows to distinguish meaningful behavioral changes from sensor glitches. The policy network, trained offline on diverse scenarios, continuously adjusts lookback/lookahead lengths and branching factors based on the current environmental conditions and system load, ensuring optimal performance even in challenging operational environments.

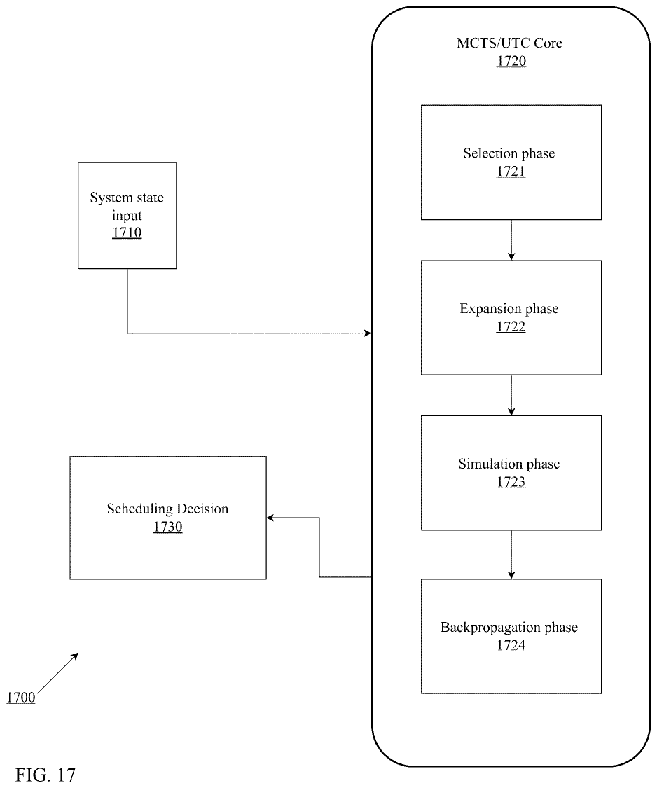

FIG. 17 is a block diagram illustrating a MCTS/UCT dynamic scheduling system 1700. At its foundation, the system state input layer 1710 serves as the comprehensive monitoring backbone, continuously tracking and updating five critical system metrics. This layer maintains an up-to-date snapshot of the entire system's configuration through the current state component, while simultaneously monitoring utilization across CPU, GPU, memory, and network resources via the resource levels tracker. It keeps precise counts of pending tasks for each processor type through queue lengths monitoring, maintains an active registry of executing tasks and their progress, and measures current processing delays and response times through the current latency component.

The MCTS/UCT Core 1720, implementing Monte Carlo tree search with upper confidence bound for trees through four sophisticated phases. The selection phase 1721 begins this process by implementing the UCT formula to balance exploration and exploitation of possible scheduling options. This phase navigates the search tree from root to leaf based on UCT values and identifies the most promising nodes for expansion. Following selection, the expansion phase 1722 creates new child nodes representing possible future states, produces valid scheduling actions based on the current state, and verifies that generated states remain feasible within system constraints. The process continues through the simulation phase 1723, where the system performs rapid simulations of possible future states, projects resource usage for different scheduling decisions, and estimates processing delays for various scheduling options. The final phase, backpropagation 1724, updates node values based on simulation results, maintains visit counts and value estimates, and propagates new information up the tree to inform future selections.

The Scheduling Decision Layer 1730 represents the culmination of the MCTS analysis, translating complex simulations into concrete scheduling decisions. This layer begins with Best Action Selection, which evaluates simulation results to identify optimal scheduling choices while considering both immediate and projected future system states, carefully balancing multiple competing objectives. Within the scheduling decision layer 1730 the resource Allocation then assigns system resources based on selected actions, ensuring efficient distribution of computing power while maintaining resource utilization within safe bounds. Task distribution implements the selected scheduling decisions by routing tasks to appropriate processors and managing task priorities and dependencies. The layer's effectiveness is measured through three key optimization metrics: latency optimization minimizes processing and response delays, resource utilization maximizes efficient use of available resources, and queue balance maintains equilibrium across processing queues.

The entire system operates in a continuous, dynamic cycle where each scheduling decision feeds back into the system state, triggering a new round of MCTS/UCT analysis. This creates a highly adaptive scheduling system that continuously optimizes resource allocation while minimizing processing latency. The system's ability to balance system load and adapt to changing conditions in real-time makes it particularly effective for complex computing environments where resource demands fluctuate frequently. Through its predictive scheduling capabilities, the system can anticipate potential bottlenecks and adjust resource allocation proactively, ensuring smooth operation even under challenging conditions. This sophisticated approach to scheduling demonstrates how advanced tree search algorithms can be effectively applied to real-world resource management challenges, providing a robust solution for modern computing systems.

This MCTS/UCT scheduling approach proves particularly effective when managing multiple streams of heterogeneous data from neural interfaces, audio sensors, and visual inputs. For example, when processing therapy dog interactions in hospital settings, the system dynamically explores multiple interpretations of ambiguous signals through increased branching factors. If the signals suggest potential anxiety—such as a slight whine combined with muscle tension—the scheduler allocates additional computing resources to process a 2-3 second window of micro-expressions across all modalities while maintaining a 30-second trailing window of calm baseline signals for comparison. The system uses the simulation phase to evaluate multiple hypotheses simultaneously: whether the dog is becoming fearful, excited by a new friendly presence, or momentarily confused. Each hypothesis is tested against both short-term and long-term window data, with the backpropagation phase updating the scheduling policy based on the outcomes. During search-and-rescue operations, where computational demands can spike suddenly, the scheduler uses its predictive capabilities to anticipate resource needs. If partial embeddings from any modality indicate upcoming complex sequences—such as a lengthy video segment or difficult acoustic environment—the MCTS core can proactively allocate GPUS, adjust batch sizes, or modify processing parameters before performance bottlenecks occur. This adaptive scheduling ensures that critical real-time processing capabilities are maintained even as environmental complexity and computational demands fluctuate.

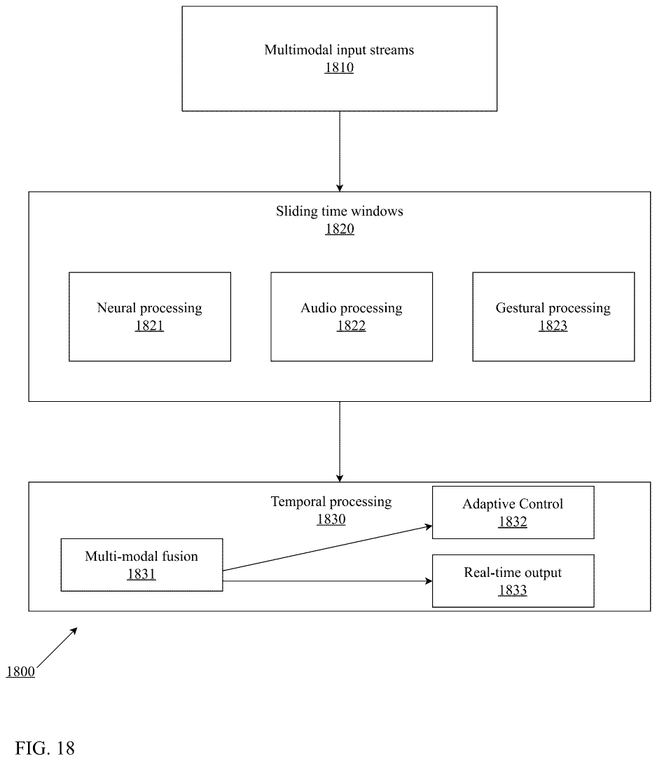

FIG. 18 is a block diagram illustrating an enhanced contextual orchestration system with sliding time windows 1800. At its core, the system processes multi-modal 1810 input streams: neural signals captured from sensors, audio input from vocalizations and environmental sounds, and gestural data from movement and posture tracking. Each of these streams is processed through specialized sliding window subsystems 1820 that operate at multiple time scales.

The neural processing stream 1821 implements a dual-buffer architecture, with a short-term buffer processing 1-2 seconds of immediate neural activity and a long-term buffer tracking 30-60 seconds of historical data. This temporal division enables the system to detect both rapid neural state changes and gradual shifts in baseline activity. The neural analysis pipeline extracts key features including power spectrum measurements for signal strength, frequency patterns that may indicate specific cognitive states, and overall cognitive state assessment based on the integration of these features across different time windows.

The audio processing stream 1822 operates with a similarly structured but differently timed approach, maintaining a recent buffer of 2-3 seconds for immediate vocalization analysis and a historical buffer extending to 30 seconds for pattern recognition. The spectral analysis component continuously processes these buffers to extract vocalization characteristics, pitch patterns that may indicate emotional states, and overall emotional valence from audio cues. This multi-temporal approach allows the system to capture both immediate vocal expressions and longer-term patterns in communication.

Gestural processing 1823 employs the most varied temporal windows, with an immediate buffer capturing sudden movements and posture changes over a few seconds, while the pattern buffer extends to minutes to capture behavioral sequences and activity patterns. The movement analysis pipeline extracts motion patterns, assesses posture states, and classifies behavior types by analyzing data across these different time scales. This enables the system to differentiate between momentary gestures and sustained behavioral patterns.

The temporal integration layer 1830 represents the sophisticated fusion of these multi-modal data streams. The multi-modal fusion 1831 combines inputs from all three processing streams, while maintaining temporal alignment through the Temporal Correlation module. A state classification system then integrates this information to produce a unified understanding of the subject's state. The Adaptive Control subsystem 1832 continuously monitors system performance through window size control, load monitoring, and quality control, adjusting processing parameters in real-time to maintain optimal performance.

The Real-time Output layer 1832 produces three key streams of information: the current behavioral state based on integrated multi-modal analysis, the emotional state derived from correlation across all input modalities, and a predictive state that anticipates future behavior patterns based on historical analysis. This output system maintains continuous updates as new data arrives through the sliding windows, enabling real-time response to changing conditions while maintaining historical context.

The entire system operates as a continuous, adaptive pipeline where window sizes and processing parameters are dynamically adjusted based on both computational load and the complexity of observed patterns. This adaptive approach ensures efficient resource utilization while maintaining the temporal resolution necessary for accurate state assessment and prediction. The integration of multiple time scales across different modalities enables the system to capture both immediate state changes and longer-term patterns, providing a comprehensive understanding of behavior and state that it would be impossible with single-modality or fixed-window approaches.

The system's adaptive temporal integration proves particularly valuable in challenging operational environments. In stable, familiar training environments, the system can rely on shorter lookback windows of a few seconds since the animal's state and external environment remain relatively constant. However, when operating in dynamic or high-stress scenarios, such as navigating disaster rubble during search-and-rescue operations, the system automatically extends its lookback windows to capture the onset of anxiety, stress behaviors, or changes in neural patterns that might diverge from recently established baselines. The multi-modal cross-checking capabilities become especially critical when individual sensor streams face reliability challenges—if neural signals become temporarily noisy due to movement artifacts, the system can dynamically adjust its weight to rely more heavily on stable audio and gestural trends in the short-term window while maintaining the longer-term context through the extended buffers. In therapeutic settings, this adaptive approach enables the system to distinguish between momentary startle responses and genuine anxiety states by correlating brief neural/vocal changes over 2-3 second windows with the 30-second trailing window of baseline signals. The predictive modeling elements use this multi-temporal data to project possible future states, implementing brief lookahead for immediate hazard avoidance in navigation scenarios, while extending to 1-2 second forecasts when anticipating and preemptively mitigating potential stress responses in complex environments.

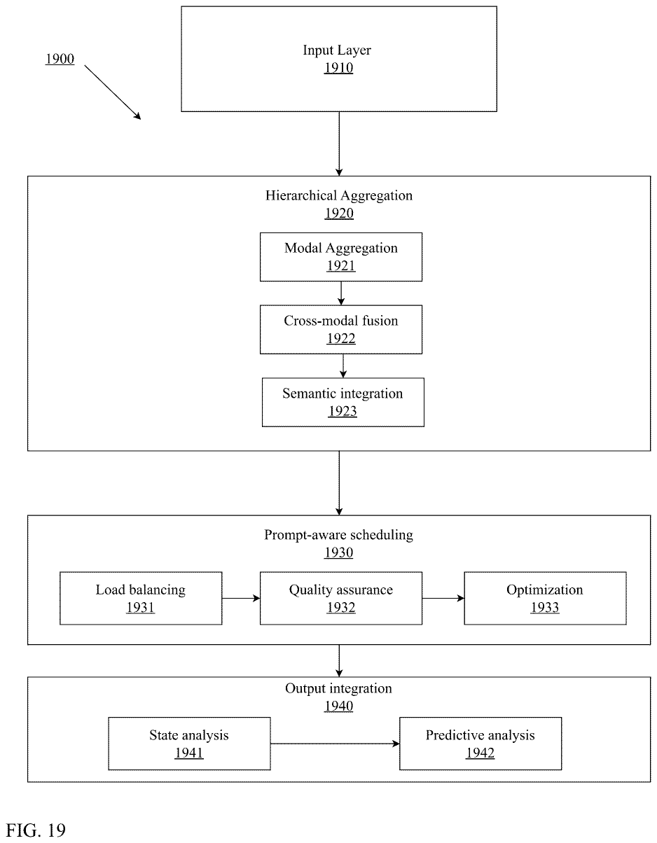

FIG. 19 is a block diagram illustrating a hierarchical multi-modal aggregation and distributed prompt-aware scheduling system 1900. This subsystem represents a sophisticated approach to processing and integrating multiple data streams while maintaining optimal performance through intelligent resource management. The subsystem is structured into four main layers: input Layer 1910, hierarchical aggregation 1920, prompt-aware scheduling 1930, and output Integration 1940, each serving distinct but interconnected functions in the processing pipeline.

The input layer 1910 handles the initial ingestion of multi-modal data through three parallel pathways: neural Inputs, audio Inputs, and visual inputs. Each pathway processes data at three granularity levels: raw signals captured directly from sensors, extracted features that represent meaningful patterns in the data, and computed states that provide initial interpretations of the input streams. This multi-level input processing ensures that information is preserved at multiple abstraction levels, enabling more nuanced analysis in subsequent stages.

The hierarchical aggregation layer 1920 implements a three-tier processing structure. Level 1 (modal aggregation) contains specialized aggregators for each input modality, combining the different granularity levels within each mode. The neural aggregator fuses raw neural signals with extracted features and computed states, while parallel processes occur in the audio and visual aggregators. Level 2 (Cross-Modal Fusion) integrates information across modalities through three stages: modal fusion combines the aggregated streams, context integration incorporates environmental and historical context, and temporal fusion aligns and synchronizes information across different time scales. Level 3 (Semantic Integration) performs high-level interpretation through the semantic analyzer, context interpreter, and pattern integrator, producing coherent, multi-modal representations of the observed phenomena.

The prompt-aware scheduling layer 1930 manages system resources and processing priorities through three main components. The load balancing subsystem 1931 continuously monitors system load, controls resource allocation, and maintains processing priorities based on current demands and data importance. Quality assurance 1932 ensures processing integrity through continuous quality monitoring, error correction, and adaptive control mechanisms that adjust processing parameters based on observed performance. The optimization 1933 subsystem manages resource allocation, controls processing throughput, and predicts processing latency to maintain optimal system performance.

The output integration layer 1940 produces comprehensive analysis results through two main subsystems. The state analysis 1941 generates current assessments of behavioral, cognitive, and emotional states based on the integrated multi-modal data. The predictive analysis subsystem 1942 leverages this information to generate predictions about future behaviors, intentions, and actions, providing a forward-looking perspective that can inform decision-making processes.

This hierarchical and distributed architecture offers several key advantages. The multi-level aggregation approach ensures that information is preserved and integrated at appropriate granularity levels, preventing loss of important details while maintaining computational efficiency. The prompt-aware scheduling system enables dynamic resource allocation based on current processing demands and data importance, ensuring optimal performance under varying conditions. The sophisticated output integration provides both current state assessment and predictive capabilities, enabling both reactive and proactive system responses.

The entire system operates as a continuous pipeline, with feedback loops enabling adaptive optimization of processing parameters based on observed performance and results. This adaptive capability, combined with the hierarchical processing structure and intelligent resource management, makes the system particularly effective for complex, real-time applications requiring sophisticated multi-modal integration and analysis.

This hierarchical approach proves particularly effective when managing complex multispecies interactions. For example, when an animal neural “query” (indicating confusion or stress) arrives simultaneously with multilingual human requests and environmental sensor data, the system's prompt-aware scheduling determines the optimal processing pathway for each data stream. The hierarchical aggregation first combines multiple neural signals into a stable “intention vector” before merging it with human language partial translations, ensuring semantic fidelity even as data streams continuously and asynchronously. Just as ALTO enables token streaming for language models, the system treats neural and sensory data as streaming “quanta,” allowing three partial scent signatures from the animal's neural decoding to be aggregated with one partial human instruction before passing to decision-making stages. The load balancing subsystem can dynamically detect when certain pipeline stages, such as the neural decoding or sensory integration units, become overloaded with complex prompts—for instance, when multiple dogs are communicating simultaneously with a team of humans. In such cases, the system scales out decoding instances, routing partial embeddings to the least-loaded instance while maintaining the ability to correctly aggregate results. This ability to handle heterogeneous data streams while maintaining both immediate responsiveness and longer-term pattern recognition capabilities enables the system to support full-duplex interaction among multiple species and languages simultaneously, dynamically adjusting to semantic complexity and integration requirements.

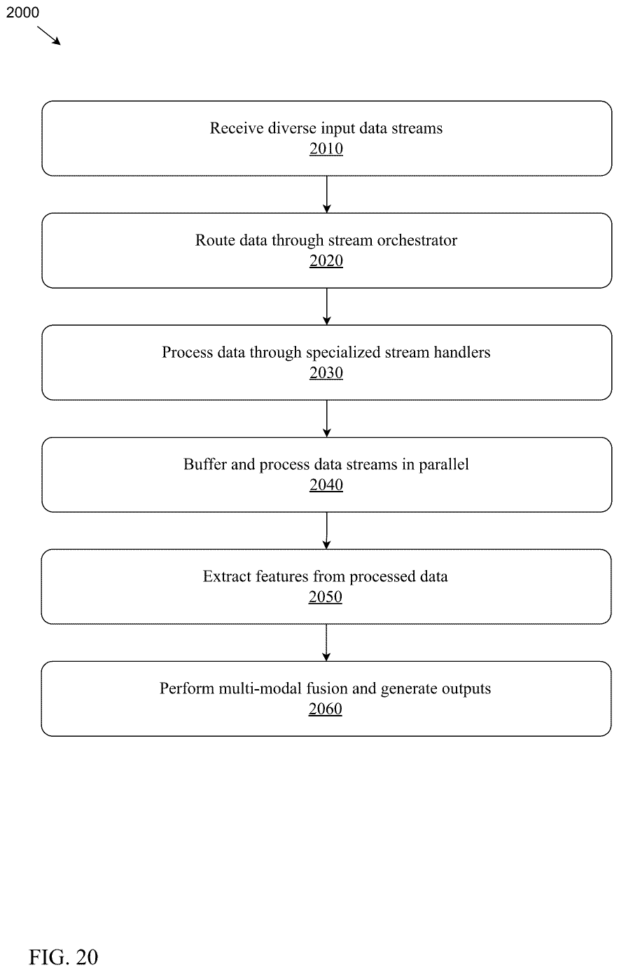

FIG. 20 is a flow diagram illustrating an exemplary method for a multi-layered stream processing system. In step 2010, The process begins with the continuous reception of diverse data streams from multiple input sources. The system receives real-time neural signals from animal subjects through neural sensors, captures vocalizations and environmental sounds via audio microphones, collects behavioral and environmental context through visual cameras, and detects chemical signatures and scents using olfactory sensors. These input sources feed data continuously into the system, requiring immediate processing.

In step 2020, once data is received, the stream orchestrator takes control as the central coordination unit. Through its registration system, it manages the specialized stream handlers needed for each data type. The data router then directs each incoming data stream to its appropriate processing unit. Meanwhile, the callback manager coordinates the output processing and event handling, ensuring proper synchronization and timing of all data flows.

In step 2030, after orchestration, each data stream enters its specialized handler for processing. The neural handler processes neural signals through its three-stage pipeline: first buffering the signal chunks, then performing real-time signal processing, and finally extracting meaningful patterns. Similarly, the audio handler processes sound data through its buffer, processor, and spectral analysis components. The visual handler processes visual data through its frame buffer, image processor, and pattern analysis system, while the olfactory handler processes chemical sensor data through its specialized components.

In step 2040, the system then implements parallel processing of all data streams, with each handler operating independently in its own thread. During this stage, the system maintains dual-window buffers for sophisticated temporal analysis. For neural data, it keeps both a short-term buffer (1-2 seconds) of high-frequency signals and a longer-term tracker (30-60 seconds) of summarized data. Similar dual-window approaches process audio and gestural data, combining immediate high-fidelity data with historical context.

In step 2050, following parallel processing, the system extracts relevant features from each data stream. This stage involves analyzing the processed data to identify significant patterns, characteristics, and events within each modality. The system derives meaningful features from neural patterns, audio spectral characteristics, visual patterns, and chemical signatures.

In step 2060, all processed data streams converge in the output processing layer. The system performs multi-modal fusion, combining features from multiple handlers into a coherent representation. Every 100 ms, the fusion layer aligns and merges the modality-specific buffers using timestamps, ensuring proper cross-referencing of all events. This produces a unified “context embedding” that captures both immediate signals and longer-term patterns. The system then generates immediate insights available through the callback system, enabling rapid response times while maintaining high data throughput and processing accuracy.

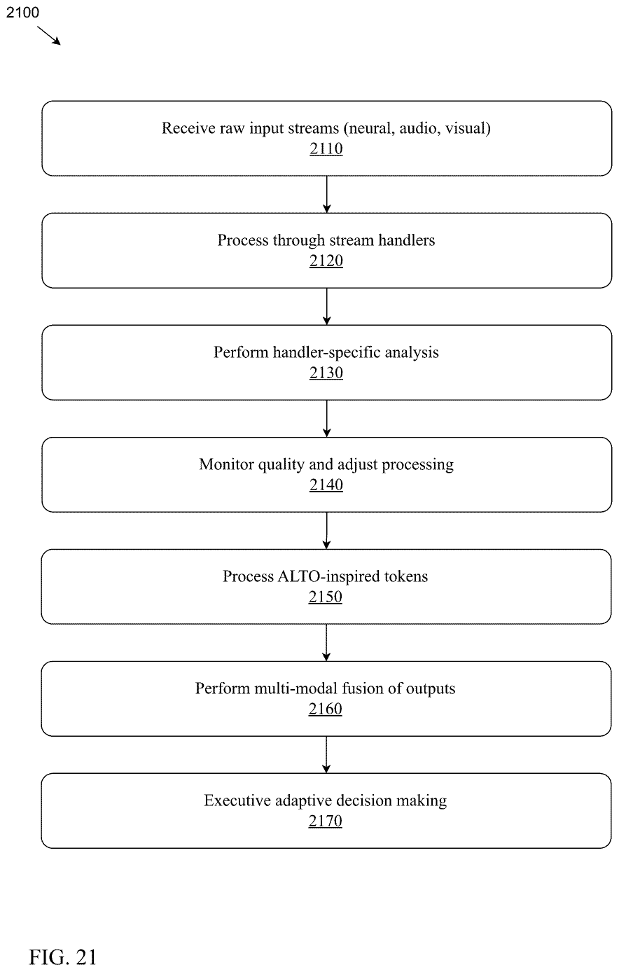

FIG. 21 is a flow diagram illustrating an exemplary method for a specialized stream handlers' system. In step 2110, the system begins with the reception of raw input data through three parallel streams: neural, audio, and visual data. These streams flow continuously into the system, with each carrying its own unique type of data that requires immediate and specialized processing. In step 2120, rather than waiting for complete patterns to emerge, the system is designed to process these inputs through stream handlers as they arrive, ensuring real-time processing capabilities.

In step 2130, the data moves into three specialized handlers that operate simultaneously. The neural stream handler employs a sophisticated dual-buffer architecture that processes neural signals in two temporal windows. Its short-term buffer handles immediate neural signals in 1-2 second windows, while a long-term buffer tracks 30-60 seconds of historical data. This handler runs three parallel analyses: power analysis to measure signal strength, frequency analysis to detect neural oscillation patterns, and pattern detection to identify complex neural signatures associated with different behavioral states. The Audio Stream Handler takes a more granular approach, processing sound data in 25-millisecond frame buffers optimized for capturing vocalization patterns and environmental sounds. This handler performs three key functions: spectral features extraction to identify key frequency components and energy distributions, waveform analysis to examine temporal patterns and amplitude variations, and vocalization pattern recognition to identify specific types of animal communications or environmental signals. This high-temporal-resolution processing enables near-instantaneous detection of significant acoustic events while maintaining the context necessary for interpreting complex vocalizations. The Visual Stream Handler processes incoming visual data on a frame-by-frame basis through its dedicated buffer system. Each frame passes through three parallel analysis pathways: intensity analysis to measure brightness patterns and contrast variations, motion detection to track dynamic changes between frames, and pattern recognition to identify specific visual features or behaviors of interest. This continuous visual processing stream enables immediate detection of relevant behavioral cues or environmental changes.

In step 2140, each handler implements sophisticated quality control and error detection mechanisms. They continuously monitor data quality, computational load, and processing parameters, making dynamic adjustments as needed. This adaptive approach ensures reliable operation even in challenging real-world conditions where sensor data quality may vary. In a step 2150, the system implements ALTO's token streaming principles, processing partial outputs (“tokens”) from each modality immediately and using aggregation-aware routing to ensure correct combination of these partial outputs.

In step 2160, all processed outputs converge in a sophisticated multi-modal fusion layer, where information from all modalities is integrated. This fusion process feeds into a real-time analysis engine that can make immediate decisions or predictions based on the combined sensor data. The system's adaptive learning component continuously refines processing parameters based on observed patterns and outcomes. In step 2170, The adaptive decision-making process adjusts lookback and lookahead periods based on conditions, runs multiple branching hypotheses simultaneously, and compensates for degraded signals in any single modality by relying more heavily on others.

The entire system operates under the principle of continuous partial processing, where insights are generated and updated as new data arrives rather than waiting for complete patterns or sequences. This approach, combined with the system's parallel processing architecture, ensures that delays or issues in one stream don't impact the others, while the multi-modal fusion layer can compensate for temporary degradation in any single modality. This sophisticated implementation of ALTO's token streaming principles, extended beyond traditional text processing, enables rapid response times while maintaining the context necessary for accurate interpretation of complex behavioral patterns.

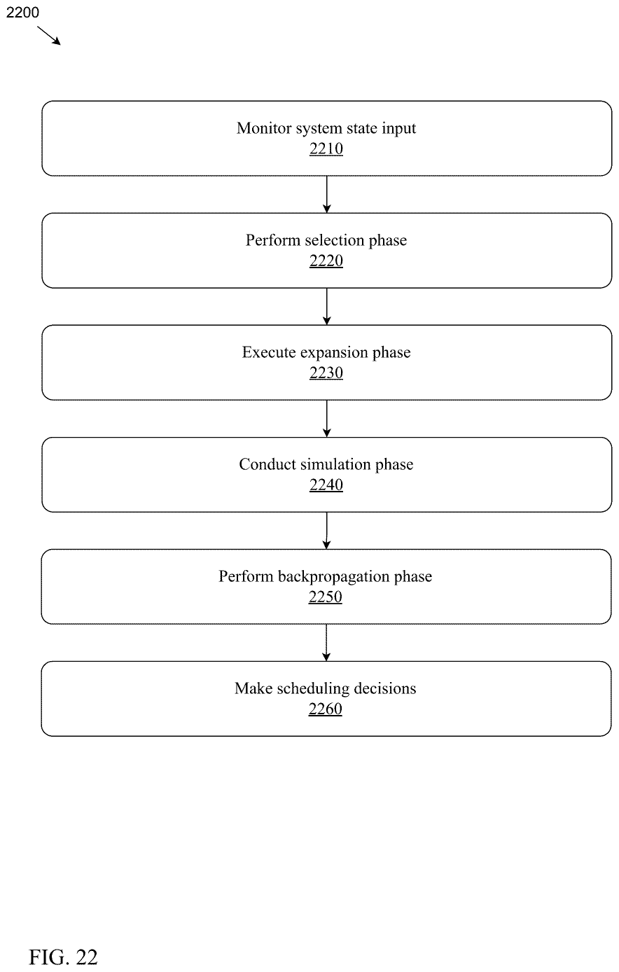

FIG. 22 is a flow diagram of the MCTS/UCT dynamic scheduling system. In a step 2210, the system begins with the monitor system state input which serves as the foundation for all scheduling decisions. This initial stage continuously monitors five critical system metrics to maintain a comprehensive view of the system's current state. The system tracks the current configuration through the Current State component, monitors resource utilization across CPU, GPU, memory, and network resources via the Resource Levels tracker, maintains queue lengths for each processor type, keeps an active registry of executing tasks and their progress, and measures current processing delays and response times through the Current Latency component. In step 2220, the selection phase of the MCTS/UCT implements the UCT formula to balance the exploration and exploitation of possible scheduling options. During this phase, the system navigates through the search tree from root to leaf based on UCT values, carefully identifying the most promising nodes for expansion. This selection process ensures that the system considers both well-performing known paths and potentially beneficial unexplored options.

In step 2230, the expansion phase follows where the system creates new child nodes that represent possible future states. During this phase, the system produces valid scheduling actions based on the current state and verifies that all generated states remain feasible within the system's constraints. This expansion ensures that the system explores realistic and achievable scheduling options while maintaining operational boundaries.

In step 2240, in the simulation phase, the system performs rapid simulations of possible future states. These simulations project resource usage for different scheduling decisions and estimate processing delays for various scheduling options. This phase is crucial for understanding the potential outcomes of different scheduling choices before committing to any particular decision.

In step 2250, the backpropagation phase then updates the system's knowledge based on simulation results. During this phase, the system maintains visit counts and value estimates for each node and propagates new information up the tree to inform future selections. This ensures that the system learns from each simulation and improves its decision-making capabilities over time.

Finally, in step 2260, the scheduling decision layer translates all this analysis into concrete actions. This layer begins with Best Action Selection, evaluating simulation results to identify optimal scheduling choices while considering both immediate and projected future system states. The system then proceeds with resource allocation, assigning system resources based on selected actions and ensuring efficient distribution of computing power while maintaining resource utilization within safe bounds. Task distribution follows, implementing the selected scheduling decisions by routing tasks to appropriate processors and managing task priorities and dependencies.

The entire process operates in a continuous cycle, with each scheduling decision feeding back into the system state to trigger a new round of MCTS/UCT analysis. This creates a highly adaptive scheduling system that proves particularly effective in complex scenarios, such as managing therapy dog interactions in hospital settings or coordinating search-and-rescue operations. The system's ability to anticipate resource needs and proactively adjust processing parameters ensures optimal performance even as environmental complexity and computational demands fluctuate.

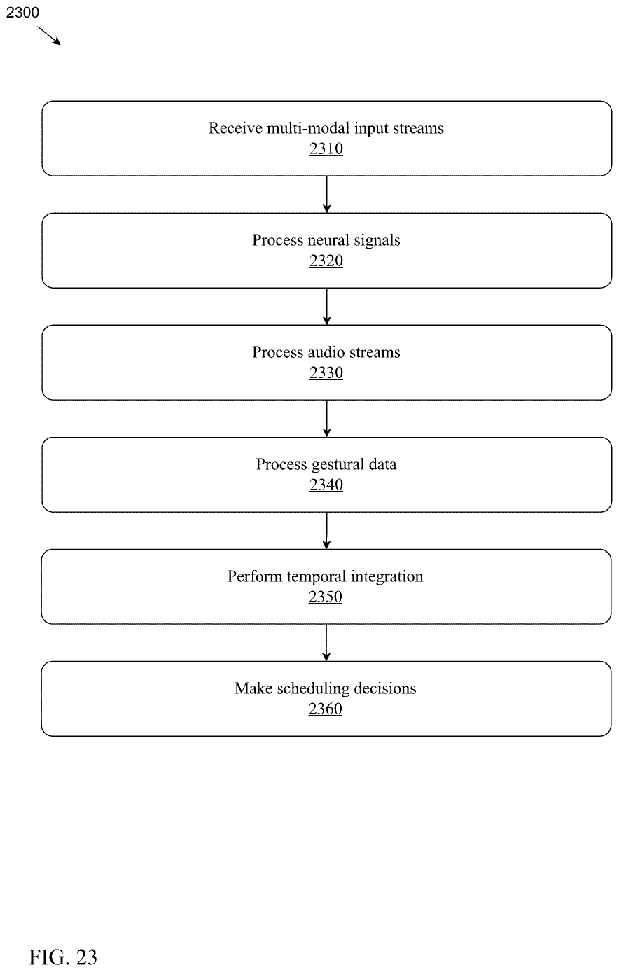

FIG. 23 is a flow diagram illustrating an exemplary method for an enhanced contextual orchestration system. In step 2310, it begins with the reception of multi-modal input streams, gathering data from three primary sources. These include neural signals captured from sensors, audio input from vocalizations and environmental sounds, and gestural data from movement and posture tracking. Each of these input streams flow continuously into the system, requiring sophisticated processing through specialized sliding window subsystems that operate at multiple time scales.

In step 2320, the Neural Processing stream represents the first specialized processing pathway, implementing a dual-buffer architecture for comprehensive signal analysis. This stream maintains a short-term buffer that processes 1-2 seconds of immediate neural activity, capturing rapid state changes and immediate responses. Simultaneously, it maintains a long-term buffer tracking 30-60 seconds of historical data to identify gradual shifts in baseline activity. The neural analysis pipeline extracts key features including power spectrum measurements for signal strength, frequency patterns indicating specific cognitive states, and overall cognitive state assessment based on the integration of these features across different time windows.

In step 2330, in the audio processing stream, the system employs a similarly structured but differently timed approach. This stream maintains a recent buffer of 2-3 seconds for immediate vocalization analysis, enabling quick detection of sudden vocal changes or expressions. Additionally, it keeps a historical buffer extending to 30 seconds for pattern recognition, allowing the system to identify longer-term patterns in communication. The spectral analysis component continuously processes these buffers to extract vocalization characteristics, pitch patterns that may indicate emotional states, and overall emotional valence from audio cues.

In step 2340, the gestural processing stream implements the most varied temporal windows of the three streams. It employs an immediate buffer for capturing sudden movements and posture changes over a few seconds, while maintaining a pattern buffer that extends to minutes for capturing behavioral sequences and activity patterns. The movement analysis pipeline within this stream extracts motion patterns, assesses posture states, and classifies behavior types by analyzing data across these different time scales, enabling the system to differentiate between momentary gestures and sustained behavioral patterns.

In step 2350, the temporal integration layer represents the sophisticated fusion of these multi-modal data streams. Through its multi-modal fusion component, it combines inputs from all three processing streams while maintaining temporal alignment through the Temporal Correlation module. The state classification system then integrates this information to produce a unified understanding of the subject's state. The Adaptive Control subsystem continuously monitors system performance, adjusting processing parameters in real-time through window size control, load monitoring, and quality control to maintain optimal performance.

Finally, in step 2360, the real-time output layer produces three key streams of information that represent the culmination of all previous processing. It generates the current behavioral state based on integrated multi-modal analysis, the emotional state derived from correlation across all input modalities, and a predictive state that anticipates future behavior patterns based on historical analysis. This layer maintains continuous updates as new data arrives through the sliding windows, enabling real-time response to changing conditions while maintaining historical context. The system's adaptive temporal integration proves particularly valuable in challenging operational environments, automatically extending its lookback windows in high-stress scenarios and adjusting its reliance on different modalities based on signal quality and environmental conditions.

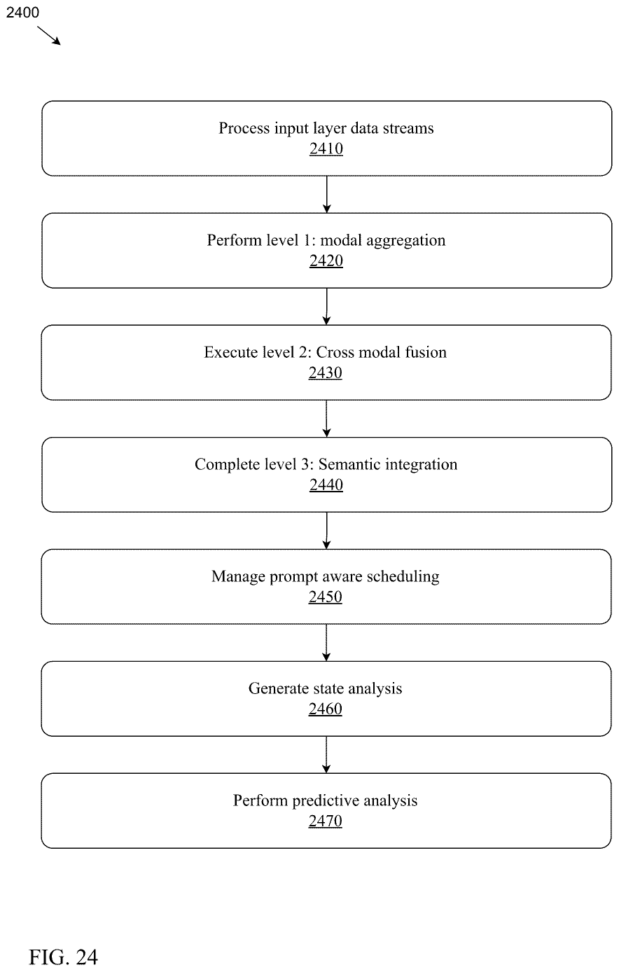

FIG. 24 is a hierarchical multi-modal aggregation and distributed prompt-aware scheduling system. In step 2410, the input Layer processes three parallel data streams: neural, audio, and visual inputs. Each of these streams is processed at three distinct granularity levels: raw signals directly from sensors, extracted features representing meaningful patterns, and computed states providing initial interpretations. This multi-level approach ensures that information is preserved at multiple abstraction levels, enabling more sophisticated analysis in later stages.

In step 2420, the system moves to the hierarchical aggregation layer where the system first implements Level 1 modal aggregation, where specialized aggregators process each input modality separately. The neural aggregator combines raw neural signals with extracted features and computed states, while parallel processes occur in the audio and visual aggregators. This initial aggregation ensures that all information within each modality is properly integrated before cross-modal processing begins.

In step 2430, the system then progresses to Level 2 cross-modal fusion where information is integrated across different modalities through three sequential stages. The modal fusion component combines the aggregated streams from different sources, followed by context integration which may incorporate environmental and historical context. The temporal fusion stage then aligns and synchronizes information across different time scales, ensuring temporal coherence in the processed data.

In step 2440, the system proceeds to Level 3 semantic integration representing the highest level of data processing in the aggregation layer. Here, the semantic analyzer, Context Interpreter, and Pattern Integrator may work together to perform high-level interpretation of the data, producing coherent, multi-modal representations of the observed phenomena. This level ensures that the system maintains semantic fidelity even as data streams continue to flow asynchronously.

In step 2450, the system proceeds to the prompt-aware scheduling layer which then manages system resources and processing priorities. This layer operates through three main components: the load balancing subsystem monitors system load and controls resource allocation, the quality assurance component ensures processing integrity through continuous monitoring and error correction, and the optimization subsystem manages resource allocation and predicts processing latency to maintain optimal performance.

In step 2460, The state analysis component of the output integration layer processes the integrated data to generate current assessments of behavioral, cognitive, and emotional states. This analysis provides a comprehensive understanding of the current situation based on all available input streams and their interactions.

Finally, in step 2470, the predictive analysis subsystem leverages all previously processed information to generate predictions about future behaviors, intentions, and actions. This forward-looking perspective enables proactive decision-making and response planning. The entire system operates as a continuous pipeline with feedback loops, enabling adaptive optimization of processing parameters based on observed performance and results. This sophisticated architecture proves particularly effective in complex scenarios involving multispecies interactions, where the system must handle heterogeneous data streams while maintaining both immediate responsiveness and longer-term pattern recognition capabilities.

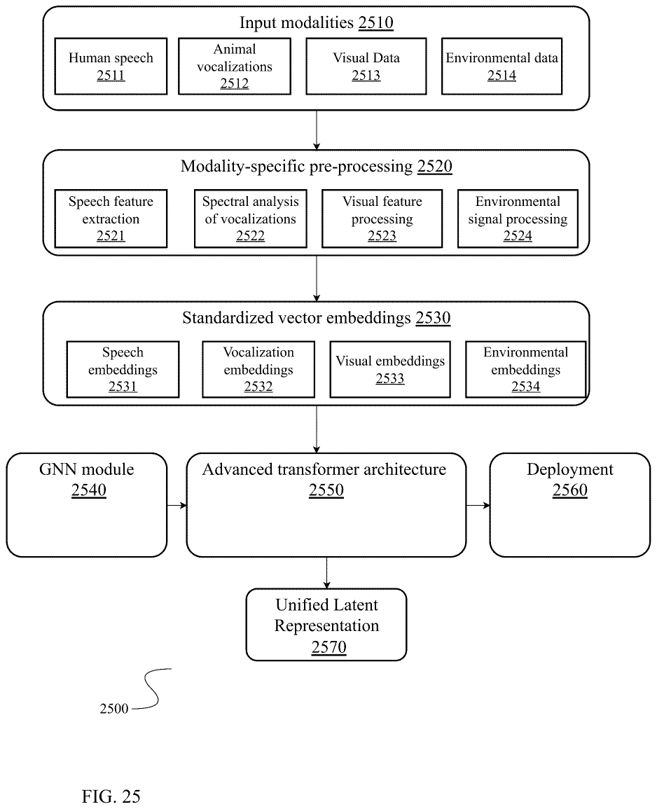

FIG. 25 is a block diagram illustrating an advanced transformer-based multi-modal fusion module 2500. This subsystem comprises a comprehensive architecture designed for integrating heterogeneous sensor streams into a unified latent representation. The system begins with four distinct input modalities 2510: human speech 2511 captured via high-fidelity microphones, animal vocalizations 2512 obtained from wearable acoustic sensors or ambient hydrophones, visual data 2513 acquired from robotic cameras and onboard imaging systems, and environmental sensor outputs 2514 such as temperature, humidity, and chemical concentration data. Each input modality undergoes specialized pre-processing 2520 through dedicated front-end processors. Human speech inputs are subjected to speech feature extraction 2521 techniques, animal vocalizations undergo spectral analysis 2522, visual data is processed through feature extraction algorithms 2523, and environmental data is filtered through appropriate signal processing methods 2524.

Following pre-processing, each modality's data is transformed into standardized vector embeddings 2530 that serve as inputs to the core transformer network. These embeddings maintain modality-specific characteristics while conforming to a common format suitable for cross-modal integration 2531-34. The central component of the system is the Advanced Transformer Architecture 2550, which employs a multi-layer design to handle long, sequential data streams with high-dimensional embeddings. This architecture incorporates specialized adapter layers inserted between standard self-attention layers, which are parameterized to modify raw embeddings based on modality-specific characteristics. The temporal alignment subsystem ensures that inputs from different sensors—often operating at varied sampling rates—are resampled and synchronized before attention computation.

At the heart of the fusion mechanism is the multi-head cross-attention component, which enables the transformer to dynamically correlate features across different input modalities. This mechanism allows query, key, and value matrices to be computed not only from homogeneous embedding spaces but also by cross-referencing signals from distinct modalities, facilitating the inference of correlations between different sensor inputs. Complementing the transformer is a Graph Neural Network (GNN) Module 2540, integrated into the global latent processing layer. This GNN captures relational dependencies and inter-agent interactions among all participating entities through agent node embeddings and relation edge embeddings. The GNN's outputs are integrated with the transformer's latent vectors to maintain an up-to-date, dynamic communication graph reflecting the operational environment.

The system supports dual deployment configurations: a compact edge device implementation optimized via pruning and quantization techniques for operation with low-power neuromorphic accelerators, and a full-scale cloud system deployment 2560 for processing larger batches of sensor data with higher precision. The culmination of the processing pipeline is a unified latent representation 2570 that encapsulates the comprehensive operational state, enabling rapid production of actionable outputs for coordinating tasks among humans, animals, and robotic agents. This advanced architecture represents a significant advancement in multi-modal orchestration systems, overcoming traditional limitations in sensor fusion, real-time processing, and multi-agent coordination for applications in defense, biotechnology, precision agriculture, and environmental monitoring.

Advanced Transformer-Based Multi-Modal Fusion Module. In one exemplary embodiment, the system is configured to integrate an advanced transformer variant that serves as the central engine for fusing heterogeneous sensor streams into a unified latent representation. The module is designed to process inputs from a diverse array of modalities, including human speech captured via high-fidelity microphones, animal vocalizations obtained from wearable acoustic sensors or ambient hydrophones, visual data acquired from robotic cameras and onboard imaging systems, and environmental sensor outputs such as temperature, humidity, and chemical concentration data. Each of these sensor streams is initially pre-processed using modality-specific front-end processors that perform tasks such as noise reduction, feature extraction, and temporal alignment. The outputs of these processors are then converted into standardized vector embeddings that serve as inputs to the transformer module. At the heart of the module is a transformer network that employs a multi-layer architecture designed to handle long, sequential data streams with high-dimensional embeddings. This transformer network is an enhanced variant inspired by state-of-the-art models such as Hyena and the PaLM-E series, which are known for their efficiency in processing multi-modal data. Unlike conventional transformer architectures that primarily operate on tokenized text, this variant has been extended to accept continuous numerical embeddings derived from non-textual sources. To achieve this, the transformer is augmented with specialized adapter layers inserted between the standard self-attention layers. These adapter layers are parameterized to modify the raw embeddings based on modality-specific characteristics; for example, the adapter associated with visual data will incorporate convolutional projection matrices to account for spatial hierarchies, while the adapter processing animal vocalizations will integrate spectral features extracted from time-frequency representations.

Central to the fusion process is a multi-head cross-attention mechanism, which allows the transformer to dynamically correlate features across the different input modalities. In each multi-head attention sub-layer, the query, key, and value matrices are computed not only from the homogeneous embedding space but also by cross-referencing signals from distinct modalities. For instance, a human speech embedding may serve as a query that retrieves related information from an animal vocalization key matrix, thereby enabling the system to infer if a particular auditory pattern from a dog correlates with an urgent command from a human operator. The cross-attention mechanism is designed to be highly time-synchronized; a dedicated temporal alignment submodule ensures that inputs from different sensors—often operating at varied sampling rates—are resampled and aligned in time before attention computation. This temporal fusion guarantees that the spatial and spectral features, along with contextual timing information, are jointly considered, resulting in a robust unified latent space representation. Complementing the transformer is a specialized Graph Neural Network (GNN) sub-network, which is integrated into the global latent processing layer. This GNN module is responsible for capturing the relational dependencies and inter-agent interactions among all participating entities, which include humans, animals, and robotic systems. The GNN is architected with iterative message-passing layers that compute node embeddings representing individual agents and edge embeddings that encode the dynamic relationships between these agents. The integration of the GNN into the transformer framework is achieved by concatenating or fusing the GNN-generated relational embeddings with the transformer's latent vectors. This dual encoding mechanism ensures that the overall system can not only extract and fuse sensor-specific features but also maintain an up-to-date, dynamic communication graph that reflects changes in the operational environment. As agents enter or exit the network—due to mobility, failure, or task reallocation—the GNN sub-network automatically recalculates the connectivity weights and updates the latent representation, thereby enabling real-time reconfiguration of the communication graph and ensuring seamless multi-agent coordination.

The combined architecture, which unifies the advanced transformer with adapter-augmented multi-head cross-attention and a dedicated GNN sub-network, offers a marked improvement in decision-making speed and robustness for real-time task orchestration. This module is engineered to support scalable deployment across both edge devices and cloud-based systems. In edge deployments, a compact version of the transformer, optimized via pruning and quantization techniques, operates in conjunction with low-power neuromorphic accelerators. Conversely, in cloud environments, the full-scale model can be utilized to process larger batches of sensor data with higher precision. The overall design ensures that, regardless of deployment context, the system can dynamically fuse heterogeneous multi-modal inputs, generate a comprehensive latent representation of the operational state, and rapidly produce actionable outputs that coordinate tasks among humans, animals, and robotic agents.

This Advanced Transformer-Based Multi-Modal Fusion Module is thus a cornerstone of the multi-modal orchestration system, providing the technical means to overcome traditional limitations in sensor fusion, real-time processing, and multi-agent coordination. Its detailed enablement, spanning advanced transformer variants, modality-specific adapter layers, time-synchronized cross-attention mechanisms, and an integrated graph neural network, exemplifies a robust and scalable solution for applications in defense, biotechnology, precision agriculture, and environmental monitoring.

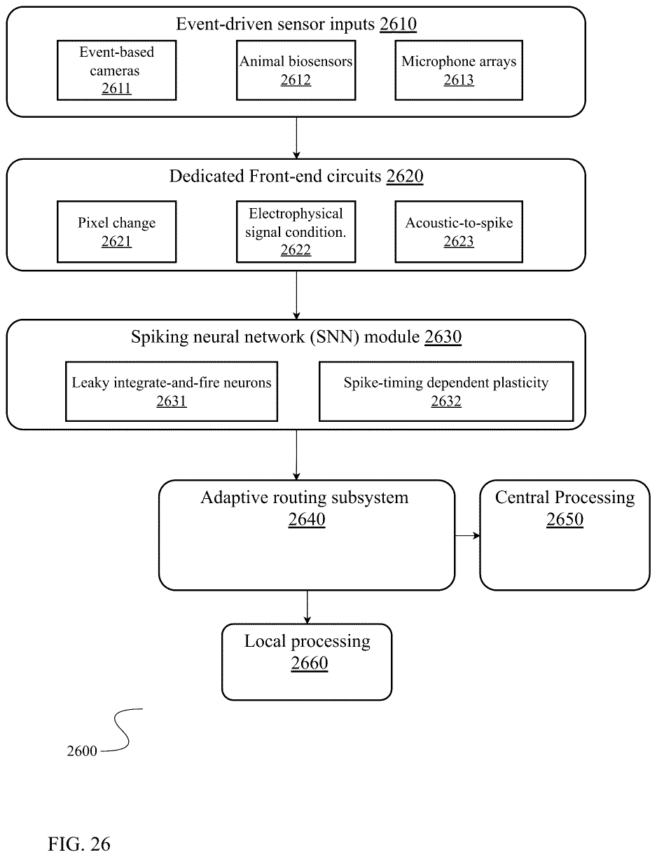

FIG. 26 is a block diagram illustrating a neuromorphic co-processor module for event-driven processing 2600. This subsystem represents an independent processing pathway designed to operate in parallel with the conventional digital processing pipeline. The system begins with various event-driven sensor inputs 2610, specifically event-based cameras 2611 that produce asynchronous events indicating changes in pixel intensity rather than full image frames, wearable animal biosensors 2612 that capture high-frequency electrophysiological signals and biopotentials, and microphone arrays 2613 that convert acoustic waveforms into discrete spike trains. These diverse input modalities feed into dedicated front-end circuits 2620 that perform specialized pre-processing operations tailored to each sensor type. The pixel change event 2621 detection circuit normalizes and filters camera inputs, the electrophysiological signal conditioning circuit 2622 processes biosensor data, and the acoustic-to-spike conversion 2623 circuit transforms sound waves into neuromorphic spike representations.

The pre-processed signals are then directed to the core spiking neural network (SNN) module 2630 implemented on specialized neuromorphic hardware platforms such as Intel Loihi or IBM TrueNorth. Within this module, computational elements are realized as leaky integrate-and-fire (LIF) 2631 neurons that emulate biological neural behavior by integrating incoming spike inputs over time while experiencing gradual decay. When accumulated potential exceeds a preset threshold, these neurons fire spikes to downstream neurons, effectively transforming continuous high-bandwidth sensor streams into sparse, event-driven representations. A critical component of the SNN architecture is the Spike-Timing-Dependent Plasticity (STDP) 2632 mechanism, which adaptively adjusts synaptic weights based on the precise timing of pre-synaptic and post-synaptic spikes. This biologically-inspired learning rule enables the network to automatically strengthen connections that consistently contribute to significant features while attenuating less informative pathways.

The output of the SNN module consists of compact, highly informative spike patterns that efficiently represent the original sensor inputs. These patterns flow into an adaptive routing subsystem 2640 that continuously monitors system load, task urgency, and energy consumption metrics to determine optimal processing pathways. Based on real-time assessments, this router directs spike pattern outputs either to local processing for time-critical reflexive responses or to central processing 2650 for fusion with other modalities. The local processing path 2660 enables near-instantaneous reactions to critical events, such as a sudden threat detection from an animal's biosensor triggering an automated alert, while the central processing path facilitates comprehensive analysis through integration with other system components.

This parallel processing architecture delivers significant system benefits, including dramatically reduced processing latency for time-sensitive applications, substantial energy conservation through efficient neuromorphic computation-particularly critical for battery-operated field units- and the generation of sparse representations that minimize bandwidth requirements. By implementing this biologically inspired computational approach, the Neuromorphic Co-Processor Module enhances the overall system's robustness and responsiveness, providing a scalable solution for real-time applications in dynamic, resource-constrained environments where both ultra-low latency responses and optimal energy utilization are essential performance metrics.

Neuromorphic Co-Processor Module for Event-Driven Processing: In one exemplary embodiment, the system incorporates an independent neuromorphic co-processor module that operates in parallel with the conventional digital processing pipeline. This module is designed to process raw, event-driven sensor data with minimal latency and power consumption, enabling rapid reflexive responses in time-critical scenarios. Raw sensor data from various modalities—such as event-based cameras, wearable animal biosensors, and microphone spike streams—are first pre-processed by dedicated front-end circuits that normalize and filter the incoming signals. In the case of event-based cameras, rather than producing full image frames, these sensors output asynchronous “events” that denote changes in pixel intensity. Similarly, wearable biosensors capture high-frequency electrophysiological signals (e.g., EEG-like data) and other biopotentials, while microphone circuits convert analog acoustic waveforms into discrete spike trains using threshold-based mechanisms.

These conditioned signals are then fed directly into the spiking neural network (SNN) module implemented on neuromorphic hardware platforms such as Intel Loihi or IBM TrueNorth. Within the SNN, individual processing elements are realized as leaky integrate-and-fire (LIF) neurons. Each LIF neuron integrates incoming spike inputs over time while experiencing a gradual decay, emulating the leakiness of a biological membrane potential. When the accumulated potential exceeds a preset threshold, the neuron fires a spike, which is transmitted to downstream neurons. This mechanism transforms continuous high-bandwidth sensor streams into a sparse, event-driven representation.

A key feature of the SNN module is the incorporation of spike-timing-dependent plasticity (STDP), a biologically inspired learning rule whereby the synaptic weights between neurons are adjusted based on the precise timing of pre-synaptic and post-synaptic spikes. STDP enables the network to automatically strengthen synapses that consistently contribute to significant features—such as abrupt motion changes, rapid acoustic transients, or critical fluctuations in biosignal patterns—while attenuating those that are less informative. This adaptive learning capability allows the SNN to dynamically tune itself to the temporal structure inherent in the sensor data, ensuring that only the most salient features are encoded in the output spike patterns.

The output of the neuromorphic co-processor is a series of compact, highly informative spike patterns that serve as an efficient representation of the original sensor inputs. These spike patterns are subsequently conveyed to the central orchestration engine through an adaptive routing subsystem. This router continuously monitors system load, task urgency, and energy consumption metrics to determine the optimal processing pathway. Based on these real-time assessments, the router decides whether the neuromorphic output should be processed locally within the co-processor module or forwarded to the central processing unit for further fusion with other modalities. This adaptive decision-making ensures that critical events—such as the sudden onset of a potential threat detected by an animal's biosensor-trigger near-instantaneous responses, while routine processing is handled in an energy-efficient manner.

By offloading high-bandwidth, event-driven computations to the neuromorphic co-processor, the system significantly reduces the overall processing latency and conserves power, a particularly vital advantage for battery-operated, field-deployed units. In practical applications, this module enables rapid reflexive responses; for example, in a security scenario, the immediate detection of an anomalous spike pattern from an animal-worn sensor could trigger an automated alert or defensive maneuver without waiting for centralized analysis.

In summary, this Neuromorphic Co-Processor Module for Event-Driven Processing is integrated as a parallel processing pathway within the overall multi-modal orchestration system. It leverages neuromorphic hardware and biologically inspired SNN architectures—featuring leaky integrate-and-fire neurons and STDP—to convert raw sensor inputs into sparse, energy-efficient spike representations. These outputs are then adaptively routed to ensure that the system achieves both ultra-low latency responses and optimal energy utilization. The inclusion of this module enhances the overall robustness and responsiveness of the system, providing a scalable solution for real-time applications in dynamic, resource-constrained environments.

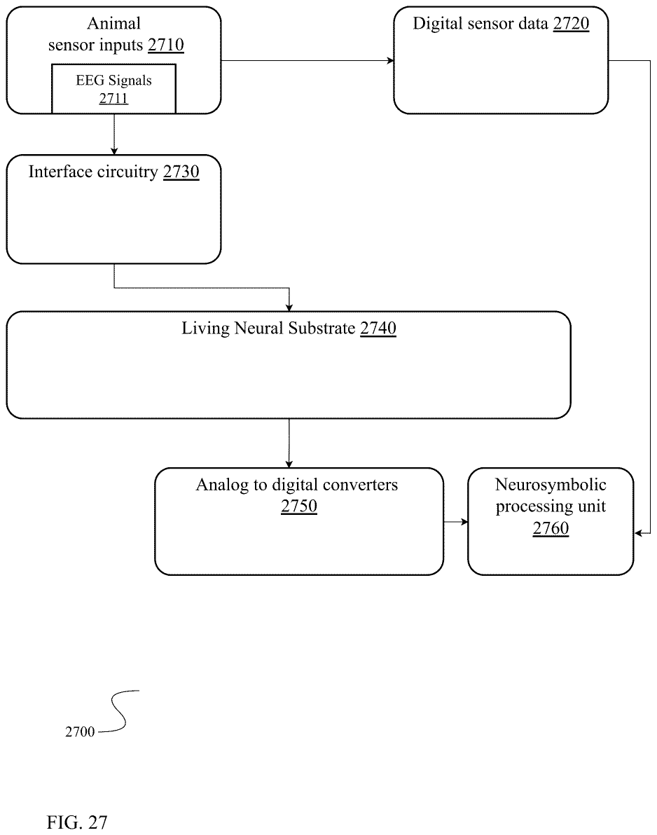

FIG. 27 is a block diagram illustrating a biological computing interface module 2700. This subsystem represents innovative augmentation to the multi-modal orchestration architecture, leveraging living neural substrates as adaptive co-processors. The system begins with the acquisition of animal sensor inputs 2710, specifically EEG and other neurophysiological signals 2711 captured from wearable sensors attached to animals. These raw biological signals are directed to a specialized interface circuitry 2730 that performs initial signal pre-processing to extract key features such as amplitude thresholds, frequency bands, and temporal patterns. This interface circuitry then converts the processed signals into bio-compatible formats—specifically low-amplitude electrical pulses—that closely mimic the native signaling conditions required by living neural tissue. The conversion is facilitated through biocompatible electrodes and microfluidic channels that ensure stable, long-term communication between the electronic system and the biological material.

At the core of the module is the living neural substrate 2740, implemented either as a three-dimensional brain organoid or a cultured neural network grown on a microelectrode array. This biological component processes incoming stimuli through intrinsic synaptic plasticity mechanisms, operating in an analog, highly parallel manner. The neural network dynamically adjusts its synaptic connections based on the timing and intensity of incoming signals through Hebbian learning processes, whereby connections between simultaneously active neurons are strengthened. As the biological substrate processes these stimuli, it generates complex, adaptive output signals that reflect a form of “biological intuition.” These outputs embody the network's pattern recognition capabilities, particularly for subtle behavioral cues, stress indicators, or emotional states present in the original animal neurophysiological data.

The analog output 2750 from the biological module is then digitized using high-resolution analog-to-digital converters specifically tailored for bioelectrical signals. These converters preserve both the temporal and amplitude variations inherent in the biological response, capturing the nuanced waveforms that represent the biological computation results. In parallel, the system processes conventional digital sensor data from various sources 2720, including video, audio, and environmental sensors. The digitized biological outputs and conventional digital sensor data are then integrated within the neurosymbolic reasoning unit 2760, where multi-modal data fusion occurs. Within this reasoning framework, the biological co-processor's output is treated as an additional modality that contributes a layer of adaptive learning and error tolerance to the overall system.

This biological computing interface delivers several technical advantages that enhance the system's capabilities. First, it introduces an inherent adaptive learning mechanism that evolves over time with minimal reprogramming requirements. Second, the biological module provides natural fault tolerance and non-linear processing capabilities that improve the system's robustness, particularly when interpreting subtle animal behavioral cues or stress signals that might be overlooked by conventional digital processing methods. Third, by fusing biological outputs with other digital sensor data, the system achieves a more holistic and context-aware representation of the operational environment. This integrated approach enables enhanced decision-making in dynamic scenarios such as search-and-rescue operations, wildlife monitoring, and therapeutic interventions, where the nuanced interpretation of animal behavior and physiological states is critical for successful outcomes.

Biological Computing Interface Module: In one exemplary embodiment, the system is augmented by a biological computing interface that leverages living neural substrates—such as brain organoids or cultured neural networks grown in vitro—as adaptive co-processors integrated within the multi-modal orchestration architecture. This module is designed to harness the inherent adaptive learning, fault tolerance, and pattern recognition capabilities of living neural tissue to supplement and enhance conventional digital processing.

The biological computing interface begins with a dedicated interface circuitry that is engineered to translate simplified electrical stimuli into signals compatible with the living neural substrate. This interface employs biocompatible electrodes and microfluidic channels to ensure stable, long-term communication between the electronic system and the biological material. For instance, wearable sensors attached to an animal may capture EEG or other neurophysiological signals, which are then pre-processed by the interface circuitry to extract key features such as amplitude thresholds, frequency bands, and temporal patterns. These pre-processed signals are converted into low-amplitude electrical pulses that mimic the native signaling conditions of the cultured neural network, thereby ensuring that the biological co-processor can readily interpret and integrate these inputs.

Once the signals are delivered to the biological module, the living neural substrate—cultured as a three-dimensional organoid or an engineered network of neurons on a microelectrode array—processes the incoming stimuli using its intrinsic synaptic plasticity mechanisms. The biological network operates in an analog, highly parallel manner, dynamically adjusting its synaptic connections based on the timing and intensity of the incoming pulses through processes analogous to Hebbian learning. As the substrate processes these stimuli, it generates a complex, adaptive output signal that reflects a form of “biological intuition.” This output embodies the network's pattern recognition of subtle behavioral cues, stress indicators, or emotional states that may be present in the original animal EEG data. The analog nature of this output captures non-linear relationships and emergent properties that are difficult to model using conventional digital algorithms alone.

The analog output from the biological module is then digitized using high-resolution analog-to-digital converters (ADCs) tailored for bioelectrical signals. These converters capture the nuanced output waveforms, preserving both the temporal and amplitude variations inherent in the biological response. The digitized output, which may be represented as a vector of adaptive features, is subsequently fused with digital sensor data—such as video, audio, and environmental signals—in the system's neurosymbolic reasoning unit. Within this reasoning unit, the biological co-processor output is treated as an additional modality, contributing a layer of adaptive learning and error tolerance. In effect, the system benefits from a hybrid intelligence: the rigorous, high-throughput processing of conventional AI models is enhanced by the nuanced, context-sensitive insights derived from the living neural substrate.

This integrated biological computing interface provides several technical advantages. First, it introduces an additional layer of adaptive pattern recognition that is inherently capable of learning and evolving over time with minimal reprogramming. Second, the biological module's natural fault tolerance and non-linear processing capabilities improve the overall robustness of the orchestration system, particularly when interpreting subtle animal behavioral cues or stress signals that may be lost in conventional processing pipelines. Third, by fusing the biological outputs with other digital sensor data, the system achieves a more holistic and context-aware representation of the operational environment, thereby enhancing decision-making in dynamic scenarios such as search-and-rescue operations, wildlife monitoring, or therapeutic interventions.

In summary, this Biological Computing Interface Module is implemented as a dedicated co-processor that integrates living neural substrates into the multi-modal orchestration system. Through a dedicated interface that converts electrical stimuli into bio-compatible signals, the module enables the biological network to process animal neurophysiological data and generate adaptive, analog outputs. These outputs, when fused with conventional digital sensor data in the neurosymbolic reasoning unit, enhance the system's ability to interpret subtle and non-linear cues from animals. This hybrid approach not only provides additional adaptive learning capacity but also significantly improves the robustness and responsiveness of the overall system in complex, dynamic environments, thereby driving both technological novelty and commercial applicability in high-value applications.

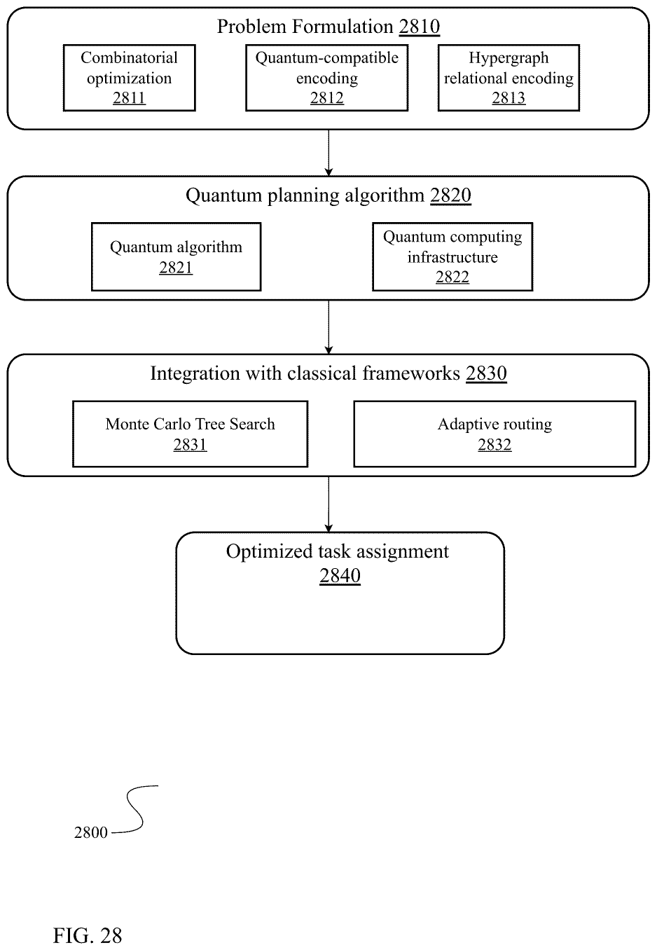

FIG. 28 is a block diagram illustrating a quantum planning and optimization engine 2800. This subsystem represents a sophisticated augmentation to the multi-modal orchestration system designed to address complex combinatorial optimization challenges in multi-agent task scheduling. The system architecture begins with a comprehensive problem formulation stage 2810 that transforms scheduling challenges into well-defined optimization instances. This formulation process encompasses three parallel components: combinatorial optimization 2811 modeling, which defines task scheduling parameters, resource constraints, and temporal dependencies as mathematical constructs; quantum-compatible encoding 2812, which maps these optimization problems onto Ising models or quadratic unconstrained binary optimization (QUBO) formulations where the objective function becomes a hamiltonian to be minimized; and hypergraph relational encoding 2813, which captures complex multi-way relationships among agents through advanced techniques such as hypergraph random walk positional encodings (H-k-RWPE) and hypergraph curvature profiles.

At the core of the system is the Quantum Planning Module 2820, which leverages quantum computing technologies to efficiently explore vast solution spaces. This module implements quantum algorithms 2821, specifically the quantum approximate optimization algorithm (QAOA) and quantum annealing techniques. In QAOA implementations, the system constructs parameterized quantum circuits where quantum states evolve through alternating layers of problem-specific hamiltonians and mixing operators, with parameters iteratively tuned via classical optimization loops to approximate optimal solutions. Alternatively, quantum annealing gradually reduces quantum fluctuations to guide the system toward ground states representing optimal task assignments. Critical to the quantum module's performance is the incorporation of topologically protected qubits, which significantly suppress noise and error rates during quantum operations, enhancing the reliability of computed solutions even in the presence of environmental interference.

The quantum computing infrastructure 2822 operates through two deployment models: cloud-based quantum services that transmit encoded problems to remote quantum processing units (QPUs) via secure API interfaces, or on-premises quantum accelerators that provide tighter integration with minimal communication latency. Both approaches produce quantum solution candidates—represented as binary strings corresponding to potential task assignments—which are then directed to classical integration frameworks for further refinement and implementation.

The integration with classical frameworks 2830 occurs primarily through a Monte Carlo Tree Search (MCTS) system 2831 that governs dynamic scheduling and routing. The quantum-derived solutions serve as high-quality starting points for the MCTS algorithm, significantly reducing the computational burden associated with exhaustive search while maintaining near-optimal decision policies. This integration is complemented by an adaptive routing subsystem 2832 that continuously monitors system load and task urgency to dynamically select processing pathways, ensuring time-critical operations receive prioritized handling.

The culmination of this processing pipeline is an optimized task assignment solution 2840 tailored for heterogeneous agent networks comprising humans, animals, and robotic units. This quantum-enhanced approach delivers substantial system benefits, including improved decision quality through exploration of larger solution spaces, significantly reduced processing latency for time-critical operations, enhanced scalability across varying problem complexities, and a future-proof architecture designed to evolve with advancements in quantum hardware. The technology is particularly applicable to high-value domains such as defense operations, logistics management, and large-scale environmental monitoring, where complex dynamic scheduling challenges are prevalent and the commercial advantages of superior optimization are substantial. By unifying quantum computing with advanced relational modeling and classical search techniques, this quantum planning and optimization Engine establishes a novel hybrid framework that transcends conventional optimization approaches, providing both technological superiority and commercial differentiation in markets demanding highly efficient multi-agent coordination.

In one exemplary embodiment, the system is augmented with a quantum planning and optimization engine specifically designed to address the inherent combinatorial optimization challenges encountered in multi-agent task scheduling. This engine is integrated as a dedicated module that works in tandem with classical decision-making processes to solve complex assignment and routing problems when conventional algorithms face scalability or latency limitations.

When the system encounters a decision problem—such as allocating tasks among a heterogeneous network of agents (humans, animals, and robotic units) under variable constraints—it first formulates the problem as an optimization instance. In this formulation, task scheduling is encoded as a combinatorial optimization problem. Variables representing task assignments, resource constraints, and temporal dependencies are mathematically modeled as binary decision variables. A cost function, which may include factors such as response latency, energy consumption, and operational risk, is then defined to capture the overall quality of a particular scheduling configuration. This optimization problem is further translated into a quantum-compatible formulation, often by mapping it onto an Ising model or a quadratic unconstrained binary optimization (QUBO) problem. In this representation, the objective function becomes the hamiltonian of the system, and the goal is to minimize this energy function to obtain an optimal or near-optimal solution.

Once the problem is formulated, it is offloaded to a quantum solver via a quantum planning module. This module leverages quantum-inspired algorithms—such as the Quantum Approximate Optimization Algorithm (QAOA) or quantum annealing techniques—to explore the vast solution space in superposition. In the case of QAOA, a parameterized quantum circuit is constructed where the quantum state evolves through alternating layers of problem-specific hamiltonians and mixing operators. The parameters of this circuit are iteratively tuned using a classical optimization loop to progressively lower the expected energy of the state, thereby approximating the optimal solution. Alternatively, if the system utilizes a quantum annealer, the device gradually reduces quantum fluctuations (controlled by a transverse magnetic field) while maintaining thermal equilibrium, guiding the quantum system toward a ground state that represents an optimal task assignment.

This quantum module can be accessed either via a cloud-based quantum computing service or an on-premises quantum accelerator. In the cloud-based implementation, a secure API interface transmits the encoded QUBO or Ising model to a quantum processing unit (QPU) provided by a vendor, such as IBM Quantum or D-Wave Systems. The quantum results—often a set of bit strings corresponding to task allocation configurations—are then returned over the network with associated energy values or confidence metrics. In the case of an on-premises solution, the system is equipped with a dedicated quantum co-processor integrated into its hardware architecture, ensuring minimal communication latency and tighter integration with the overall orchestration engine.

The output from the quantum planning module is then integrated back into the central decision-making framework, particularly within a Monte Carlo Tree Search (MCTS) system that governs dynamic scheduling and routing. The quantum-derived solution serves as a high-quality candidate or a set of promising starting points for the MCTS algorithm, effectively guiding the exploration of decision branches. By using the quantum solution as an input to MCTS, the system achieves a significant reduction in the computational burden associated with exhaustive search, while maintaining a near-optimal decision policy that can rapidly adapt to changing operational conditions.

This Quantum Planning and Optimization Engine not only enhances decision quality by exploring a far larger solution space than classical methods alone but also dramatically improves latency in time-critical operations. Its design ensures future-proofing of the system as quantum hardware continues to mature, providing a competitive edge in high-value markets such as defense, logistics, and large-scale environmental monitoring. Through detailed integration—spanning problem formulation, quantum algorithm implementation, cloud or on-premises deployment, and seamless interfacing with classical MCTS-based orchestration—the engine provides a robust and technically enabled solution for complex multi-agent task scheduling, driving both operational efficiency and commercial differentiation.

In one exemplary embodiment, the system is augmented with a quantum planning module that addresses the formidable combinatorial optimization challenges arising in multi-agent task scheduling. This embodiment builds on advanced concepts from both topological fault-tolerant quantum computing and higher-order relational learning to achieve a robust, adaptive, and future-proof solution. The design synergistically integrates quantum-inspired algorithms, topologically protected qubit architectures, and hypergraph-based relational encodings into a unified framework.

At its core, the module reformulates complex scheduling problems—such as optimally allocating tasks among heterogeneous agents (humans, animals, and robotic units) under variable operational constraints—as well-defined optimization instances. These problems are encoded into a quantum-compatible framework by mapping them onto a quadratic unconstrained binary optimization (QUBO) formulation. In this formulation, each decision variable represents a potential task assignment, and the overall objective function is expressed as a hamiltonian whose minimization corresponds to an optimal routing or scheduling strategy. The cost function is constructed to include contributions from resource limitations, temporal dependencies, and interaction constraints, with weights dynamically determined by higher-order relational data obtained via hypergraph encodings.

Drawing inspiration from recent advancements in fault-tolerant quantum computation using topological qubit arrays—as detailed in the Microsoft Quantum roadmap—our quantum module leverages topologically protected qubits (tetrons) to significantly suppress noise and error rates during quantum operations. In this architecture, the optimization problem is embedded into a quantum circuit using algorithms such as the Quantum Approximate Optimization Algorithm (QAOA) or quantum annealing techniques. For instance, QAOA is implemented via a parameterized quantum circuit that alternates between applying the problem hamiltonian and a mixing hamiltonian. A classical optimization loop then iteratively adjusts the circuit parameters to drive the system toward a state of minimal energy, thereby approximating an optimal solution with high fidelity even in the presence of residual noise.

A distinctive feature of this embodiment is its incorporation of hypergraph-based relational encodings, inspired by recent breakthroughs in higher-order information utilization. Prior to formulating the QUBO, the system processes multi-agent interaction data using hypergraph encodings—such as hypergraph random walk positional encodings (H-k-RWPE) or hypergraph curvature profiles (HCP)—which capture complex, multi-way relationships beyond simple pairwise interactions. These encodings enhance the expressivity of the optimization model by assigning adaptive weights to different constraints based on the structural and positional characteristics of the agents within the network. Consequently, the resulting QUBO instance is enriched with higher-order contextual information, enabling the quantum solver to consider nuanced interdependencies during its search for an optimal scheduling configuration.

Once the quantum circuit has been executed—either on a cloud-based quantum computing service or on an on-premises quantum accelerator—the quantum module rapidly outputs a set of candidate solutions, represented as binary strings that correspond to potential task assignments. These quantum-derived candidates are then seamlessly integrated into a classical Monte Carlo tree search (MCTS) framework, where they serve as high-quality starting points that significantly reduce the depth and computational complexity of the subsequent search process. An adaptive routing subsystem monitors system load and task urgency, dynamically choosing between processing pathways to ensure that time-critical operations receive near-instantaneous responses.

By unifying topologically protected qubit technology with quantum optimization and hypergraph-enhanced relational learning, this Quantum Planning and Optimization Engine not only achieves improved decision quality and reduced latency in real-time operations but also offers remarkable scalability and fault tolerance. The design is inherently future-proof: as quantum hardware matures and error correction protocols evolve, the module can seamlessly transition to next-generation fault-tolerant quantum processors while retaining its core capabilities. Moreover, the integration of higher-order relational data ensures that the system is well-suited for high-value applications in defense, logistics, and environmental monitoring—markets where complex, dynamic scheduling challenges are prevalent and the commercial advantages of superior optimization are substantial.

This embodiment, therefore, represents a bold and innovative leap beyond conventional classical optimization techniques by harnessing the transformative potential of quantum computation combined with advanced relational learning. It establishes a novel, hybrid framework that pushes the boundaries of current technology and provides a competitive edge in both performance and commercial applicability.

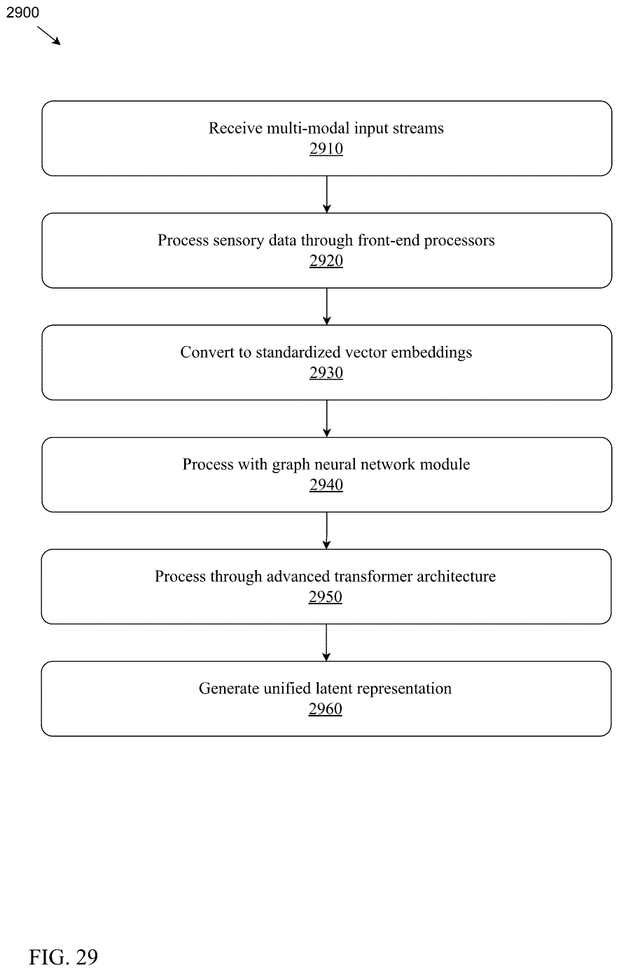

FIG. 29 is a flow diagram illustrating an exemplary method for an enhanced contextual orchestration system 2900. The process begins at step 2910 with receiving multi-modal input streams from various sources. These input streams comprise human speech captured via high-fidelity microphones, animal vocalizations obtained from wearable acoustic sensors or ambient hydrophones, visual data acquired from robotic cameras and onboard imaging systems, and environmental sensor outputs such as temperature, humidity, and chemical concentration data.

At step 2920, the system processes the sensory data through dedicated front-end processors. During this step, human speech inputs undergo speech feature extraction techniques, animal vocalizations are subjected to spectral analysis, visual data is processed through feature extraction algorithms, and environmental data is filtered through appropriate signal processing methods. Each modality receives specialized pre-processing tailored to its unique characteristics and information content.

At step 2930, the pre-processed data is converted into standardized vector embeddings. These embeddings maintain modality-specific characteristics while conforming to a common format suitable for cross-modal integration. The standardization process ensures that inputs from disparate sources can be effectively compared and combined in subsequent processing stages, despite their inherent differences in dimensionality and feature representation.

At step 2940, where the system processes these embeddings through a Graph Neural Network (GNN) Module. This GNN captures relational dependencies and inter-agent interactions among all participating entities through agent node embeddings and relation edge embeddings. The GNN processing maintains an up-to-date, dynamic communication graph reflecting the operational environment and the relationships between agents.

At step 2950, the standardized embeddings and GNN outputs are processed through the Advanced Transformer Architecture. This architecture employs a multi-layer design to handle long, sequential data streams with high-dimensional embeddings and incorporates specialized adapter layers inserted between standard self-attention layers. The transformer utilizes a multi-head cross-attention mechanism that enables it to dynamically correlate features across different input modalities. Additionally, a temporal alignment subsystem ensures that inputs from different sensors—often operating at varied sampling rates—are resampled and synchronized before attention computation.

Finally, at step 2960, the system generates a unified latent representation that encapsulates the comprehensive operational state. This representation integrates information across all modalities and enables rapid production of actionable outputs for coordinating tasks among humans, animals, and robotic agents. The unified representation serves as the foundation for downstream decision-making processes and can be deployed in various applications including defense, biotechnology, precision agriculture, and environmental monitoring.

Throughout this process, the system supports dual deployment configurations: a compact edge device implementation optimized via pruning and quantization techniques for operation with low-power neuromorphic accelerators, and a full-scale cloud system deployment for processing larger batches of sensor data with higher precision.

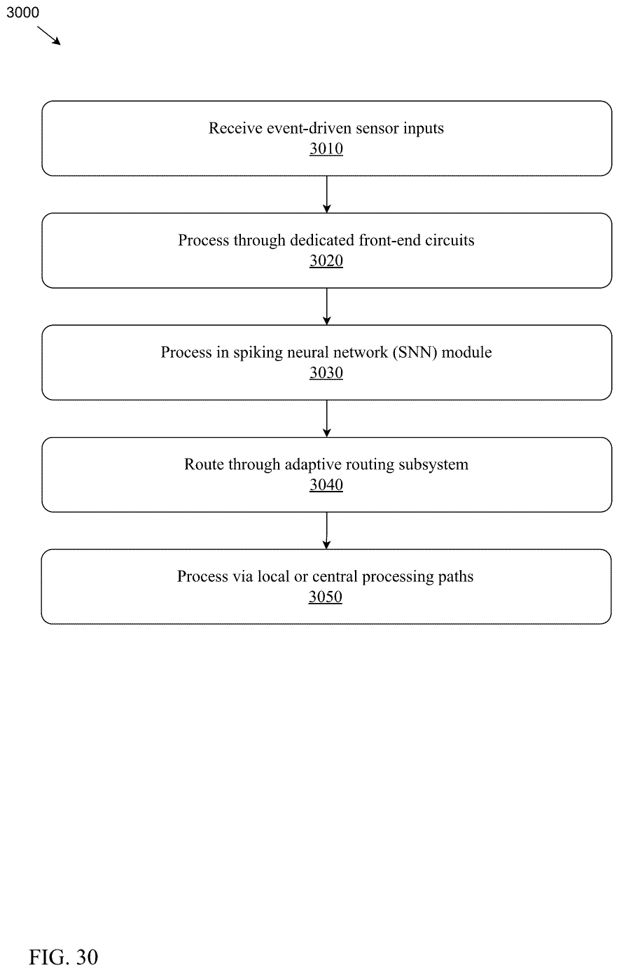

FIG. 30 is a flow diagram illustrating an exemplary method for an operation of a neuromorphic co-processor module for event-driven processing 3000. This method represents an independent processing pathway designed to operate in parallel with conventional digital processing pipelines, providing ultra-low latency responses for time-critical applications.

The process begins at step 3010 with receiving event-driven sensor inputs from various sources. These inputs include event-based cameras that produce asynchronous events indicating changes in pixel intensity rather than full image frames, wearable animal biosensors that capture high-frequency electrophysiological signals and biopotentials, and microphone arrays that convert acoustic waveforms into discrete spike trains. Unlike conventional sensors that produce continuous data streams, these event-driven sensors only generate outputs when significant changes occur in their environment.

At step 3020, the system processes these inputs through dedicated front-end circuits tailored to each sensor type. During this step, pixel change event detection circuits normalize and filter camera inputs, electrophysiological signal conditioning circuits process biosensor data, and acoustic-to-spike conversion circuits transform sound waves into neuromorphic spike representations. These specialized front-end processors ensure that each modality's data is appropriately conditioned for subsequent neuromorphic processing.

At step 3030, the pre-processed signals are directed to the core Spiking Neural Network (SNN) module implemented on specialized neuromorphic hardware platforms such as Intel Loihi or IBM TrueNorth. Within this module, computational elements are realized as Leaky Integrate-and-Fire (LIF) neurons that emulate biological neural behavior by integrating incoming spike inputs over time while experiencing gradual decay. When accumulated potential exceeds a preset threshold, these neurons fire spikes to downstream neurons, effectively transforming continuous high-bandwidth sensor streams into sparse, event-driven representations. A critical component of the SNN architecture is the Spike-Timing-Dependent Plasticity mechanism, which adaptively adjusts synaptic weights based on the precise timing of pre-synaptic and post-synaptic spikes, enabling the network to automatically strengthen connections that consistently contribute to significant features while attenuating less informative pathways.

At step 3040, the output spike patterns flow into an adaptive routing subsystem that continuously monitors system load, task urgency, and energy consumption metrics to determine optimal processing pathways. This routing subsystem makes real-time assessments to direct the neuromorphic processing outputs efficiently.

Finally, at step 3050, the system processes via either central or local processing paths based on the routing subsystem's decisions. The central processing path facilitates comprehensive analysis through integration with other system components and modalities. Conversely, the local processing path enables near-instantaneous reactions to critical events, such as a sudden threat detection from an animal's biosensor triggering an automated alert without waiting for central analysis.

This parallel processing architecture delivers significant system benefits, including dramatically reduced processing latency for time-sensitive applications, substantial energy conservation through efficient neuromorphic computation-particularly critical for battery-operated field units- and the generation of sparse representations that minimize bandwidth requirements. By implementing this biologically inspired computational approach, the neuromorphic co-processor module enhances the overall system's robustness and responsiveness, providing a scalable solution for real-time applications in dynamic, resource-constrained environments.

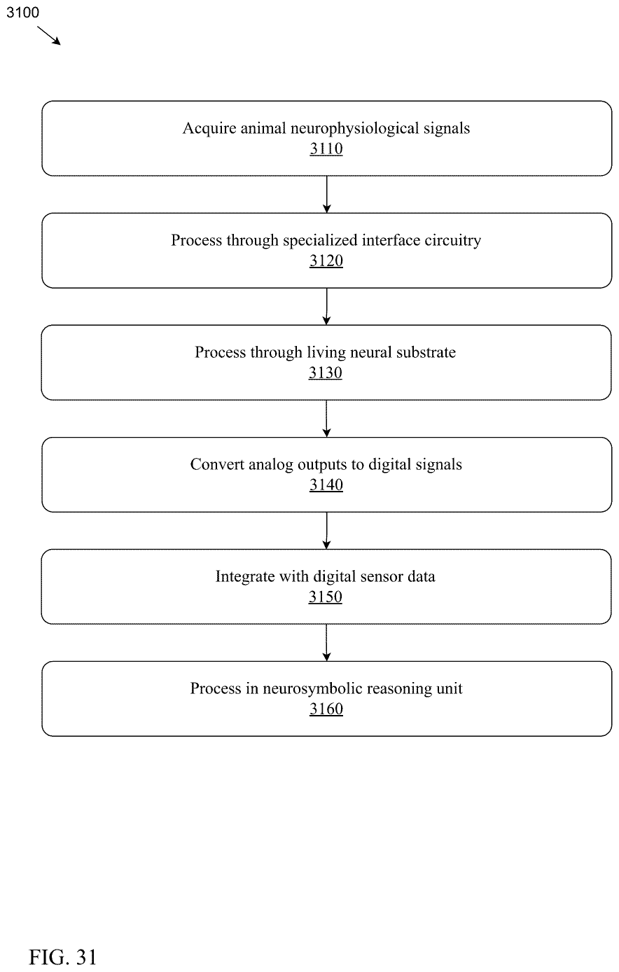

FIG. 31 is a flow diagram illustrating an exemplary method for an operation for a biological computing interface module 3100. This method represents an innovative augmentation to the multi-modal orchestration architecture that leverages living neural substrates as adaptive co-processors to enhance system capabilities.

The method begins at step 3110 with acquiring animal neurophysiological signals, specifically EEG and other neurophysiological data captured from wearable sensors attached to animals. These signals contain valuable information about the animal's physiological state, behavioral cues, stress indicators, and emotional responses that can be difficult to detect through conventional sensors and processing methods.

At step 3120, the system processes these raw biological signals through specialized interface circuitry. This circuitry performs initial signal pre-processing to extract key features such as amplitude thresholds, frequency bands, and temporal patterns. The interface then converts the processed signals into bio-compatible formats—specifically low-amplitude electrical pulses—that closely mimic the native signaling conditions required by living neural tissue. This biocompatible conversion is facilitated through specialized electrodes and microfluidic channels that ensure stable, long-term communication between the electronic system and the biological material.

At step 3130, the biocompatible signals are directed to the living neural substrate, implemented either as a three-dimensional brain organoid or a cultured neural network grown on a microelectrode array. This biological component processes incoming stimuli through intrinsic synaptic plasticity mechanisms, operating in an analog, highly parallel manner. The neural network dynamically adjusts its synaptic connections based on the timing and intensity of incoming signals through Hebbian learning processes, whereby connections between simultaneously active neurons are strengthened. As the biological substrate processes these stimuli, it generates complex, adaptive output signals that reflect a form of “biological intuition,” embodying the network's pattern recognition capabilities.

At step 3140, the analog outputs from the biological module are converted to digital signals using high-resolution analog-to-digital converters specifically tailored for bioelectrical signals. These converters preserve both the temporal and amplitude variations inherent in the biological response, capturing the nuanced waveforms that represent the biological computation results.

At step 3150, the system integrates the digitized biological outputs with conventional digital sensor data from various sources, including video, audio, and environmental sensors. This integration combines the complementary strengths of both biological and digital processing systems.

Finally, at step 3160, the combined data is processed in the neurosymbolic reasoning unit, where multi-modal data fusion occurs. Within this reasoning framework, the biological co-processor's output is treated as an additional modality that contributes a layer of adaptive learning and error tolerance to the overall system.

This biological computing interface delivers several technical advantages that enhance the system's capabilities. First, it introduces an inherent adaptive learning mechanism that evolves over time with minimal reprogramming requirements. Second, the biological module provides natural fault tolerance and non-linear processing capabilities that improve the system's robustness, particularly when interpreting subtle animal behavioral cues or stress signals that might be overlooked by conventional digital processing methods. Third, by fusing biological outputs with other digital sensor data, the system achieves a more holistic and context-aware representation of the operational environment, enabling enhanced decision-making in dynamic scenarios such as search-and-rescue operations, wildlife monitoring, and therapeutic interventions.

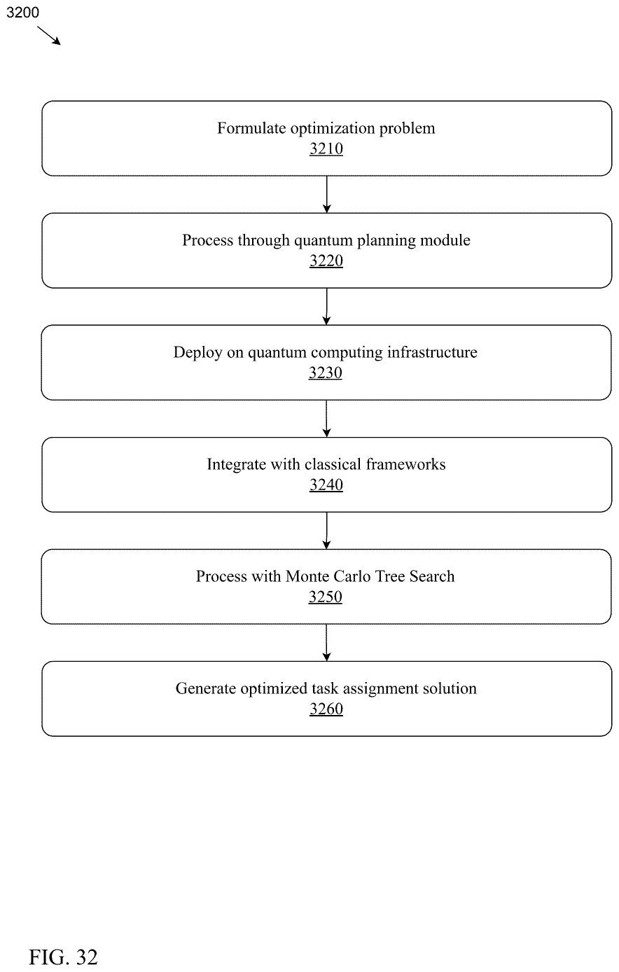

FIG. 32 is a flow diagram illustrating an exemplary method for the operation of a quantum planning and optimization engine 3200. This method represents a sophisticated augmentation to the multi-modal orchestration system designed to address complex combinatorial optimization challenges in multi-agent task scheduling.

The method begins at step 3210 with formulating the optimization problem. During this stage, the system transforms scheduling challenges into well-defined optimization instances through three parallel components: combinatorial optimization modeling, which defines task scheduling parameters, resource constraints, and temporal dependencies as mathematical constructs; quantum-compatible encoding, which maps these optimization problems onto Ising models or quadratic unconstrained binary optimization (QUBO) formulations where the objective function becomes a hamiltonian to be minimized; and hypergraph relational encoding, which captures complex multi-way relationships among agents through advanced techniques such as hypergraph random walk positional encodings (H-k-RWPE) and hypergraph curvature profiles.

At step 3220, the system processes the formulated problem through the quantum planning module. This module implements quantum algorithms, specifically the Quantum Approximate Optimization Algorithm (QAOA) and quantum annealing techniques. In QAOA implementations, the system constructs parameterized quantum circuits where quantum states evolve through alternating layers of problem-specific hamiltonians and mixing operators, with parameters iteratively tuned via classical optimization loops to approximate optimal solutions. Alternatively, quantum annealing gradually reduces quantum fluctuations to guide the system toward ground states representing optimal task assignments. Critical to the quantum module's performance is the incorporation of topologically protected qubits, which significantly suppress noise and error rates during quantum operations, enhancing the reliability of computed solutions even in the presence of environmental interference.

At step 3230, the system deploys the quantum algorithms on quantum computing infrastructure. This infrastructure operates through two deployment models: cloud-based quantum services that transmit encoded problems to remote quantum processing units (QPUs) via secure API interfaces, or on-premises quantum accelerators that provide tighter integration with minimal communication latency. Both approaches produce quantum solution candidates-represented as binary strings corresponding to potential task assignments-which are then directed to classical integration frameworks for further refinement and implementation.

At step 3240, the system integrates the quantum-derived solutions with classical frameworks. This integration serves as a bridge between quantum computation and practical implementation, ensuring that the quantum solutions can be effectively utilized within the broader orchestration system.

At step 3250, the system processes the integrated solutions through a Monte Carlo Tree Search (MCTS) system that governs dynamic scheduling and routing. The quantum-derived solutions serve as high-quality starting points for the MCTS algorithm, significantly reducing the computational burden associated with exhaustive search while maintaining near-optimal decision policies. This integration is complemented by an adaptive routing subsystem that continuously monitors system load and task urgency to dynamically select processing pathways, ensuring time-critical operations receive prioritized handling.

Finally, at step 3260, the system generates an optimized task assignment solution tailored for heterogeneous agent networks comprising humans, animals, and robotic units. This quantum-enhanced approach delivers substantial system benefits, including improved decision quality through exploration of larger solution spaces, significantly reduced processing latency for time-critical operations, enhanced scalability across varying problem complexities, and a future-proof architecture designed to evolve with advancements in quantum hardware.

This quantum planning and optimization engine is particularly applicable to high-value domains such as defense operations, logistics management, and large-scale environmental monitoring, where complex dynamic scheduling challenges are prevalent and the commercial advantages of superior optimization are substantial. By unifying quantum computing with advanced relational modeling and classical search techniques, this method establishes a novel hybrid framework that transcends conventional optimization approaches, providing both technological superiority and commercial differentiation in markets demanding highly efficient multi-agent coordination.

### Exemplary Computing Environment

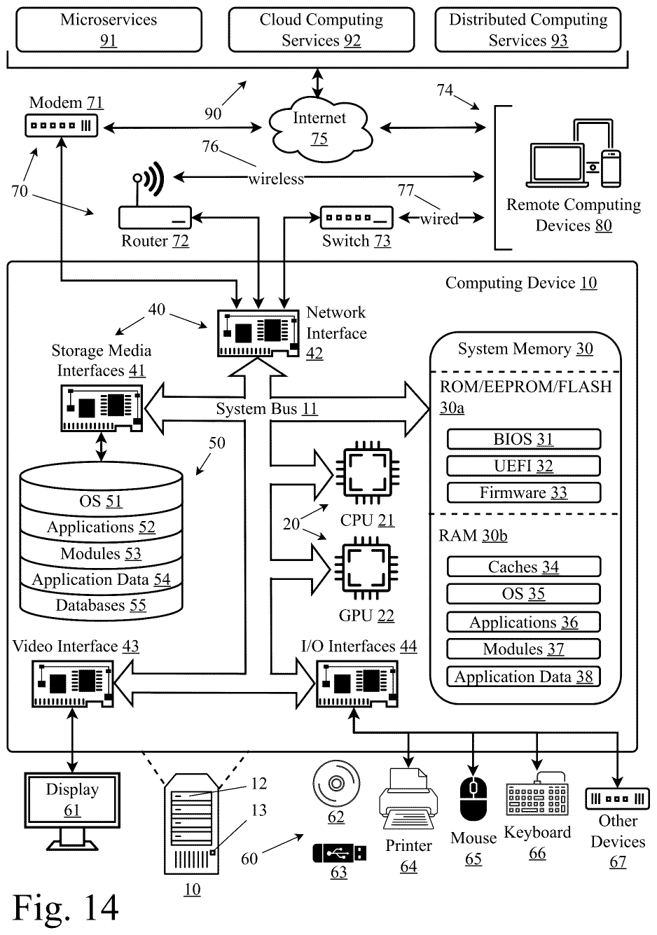

FIG. 14 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that enables packaging and running applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for AI-enabled multispecies coordinated task execution, comprising:
a computing device comprising at least a memory and a processor; and
a plurality of programming instructions that, when operating on the processor, cause the computing device to:
receive non-human animal communication data;
process the non-human animal communication data through a machine-learning system, wherein the machine-learning system is configured to:
parse the non-human animal communication data to derive one or more linguistic patterns;
associate the one or more linguistic patterns with a human sentiment, meaning, or instruction; and
compute a confidence score corresponding to the human sentiment, meaning, or instruction; and
in response to the human sentiment, meaning, or instruction exceeding a predetermined threshold:
render and present an audio/visual form of the human sentiment, meaning, or instruction on an electronic display;
receive a set of human communication data in response to the human sentiment, meaning, or instruction;
associate the set of human communication data with one or more non-human animal communication patterns; and
output the one or more non-human animal communication patterns via one or more output elements.

2. The system of claim 1, wherein the one or more output elements comprise underwater transducers.

3. The system of claim 1, wherein the plurality of programming instructions further includes instructions to receive human communication data that includes directional-based information.

4. The system of claim 3, further comprising a Simultaneous Localization and Mapping (SLAM) system, and wherein the plurality of programming instructions further includes instructions to process directional-based information that is obtained from the SLAM system.

5. The system of claim 1, wherein the plurality of programming instructions further includes instructions to receive additional human communication data, and output the additional human communication data to one or more electromechanical devices.

6. The system of claim 1, wherein the plurality of programming instructions further includes instructions to receive additional human communication data, and output the additional human communication data to one or more electronic devices.

7. The system of claim 1, wherein the machine-learning system includes a large language model (LLM).

8. The system of claim 1, wherein the plurality of programming instructions further includes instructions to generate a directed acyclic graph to represent a plurality of reasoning steps corresponding to the multispecies coordinated task execution.

9. The system of claim 1, wherein the plurality of programming instructions further includes instructions to parse the non-human animal communication data to derive one or more linguistic patterns from cetaceans.

10. A computer-implemented method for AI-enabled multispecies coordinated task execution, comprising the steps of:
receiving non-human animal communication data;
processing the non-human animal communication data through a machine-learning system, wherein the machine-learning system is configured to:
parsing the non-human animal communication data to derive one or more linguistic patterns;
associating the one or more linguistic patterns with a human sentiment, meaning, or instruction; and
computing a confidence score corresponding to the human sentiment, meaning, or instruction; and
in response to the human sentiment, meaning, or instruction exceeding a predetermined threshold:
rendering and present an audio/visual form of the human sentiment, meaning, or instruction on an electronic display;
receiving a set of human communication data in response to the human sentiment, meaning, or instruction;
associate the set of human communication data with one or more non-human animal communication patterns; and
outputting the one or more non-human animal communication patterns via one or more output elements.

11. The method of claim 10, further comprising receiving human communication data that includes directional-based information.

12. The method of claim 11, further comprising processing directional-based information that is obtained from a Simultaneous Localization and Mapping (SLAM) system.

13. The method of claim 10, further comprising the steps of:
receiving additional human communication data; and
outputting the additional human communication data to one or more electromechanical devices.

14. The method of claim 10, further comprising the steps of:
receiving additional human communication data; and
outputting the additional human communication data to one or more electronic devices.

15. The method of claim 10, wherein processing the non-human animal communication data through a plurality of machine-learning system comprises processing the non-human animal communication data using a large language model (LLM).

16. The method of claim 10, further comprising generating a directed acyclic graph to represent a plurality of reasoning steps corresponding to the coordinated task execution.

17. The method of claim 10, wherein parsing the non-human animal communication data to derive one or more linguistic patterns includes parsing animal communication from cetaceans.

18. A non-transitory, computer-readable medium comprising programming instructions for an electronic computation device executable by a processor to cause the electronic computation device to:
receive non-human animal communication data;
process the data through a machine-learning system, wherein the machine-learning system is configured to:
parse the non-human animal communication data to derive one or more linguistic patterns;
associate the one or more linguistic patterns with a human sentiment, meaning, or instruction;
compute a confidence score corresponding to the human sentiment, meaning, or instruction;
in response to the human sentiment, meaning, or instruction exceeding a predetermined threshold:
render and present an audio/visual form of the human sentiment, meaning, or instruction on an electronic display;
receive a set of human communication data in response to the human sentiment, meaning, or instruction;
associate the set of human communication data with one or more non-human animal communication patterns; and
output the one or more non-human animal communication patterns via one or more output elements.

19. The computer-readable medium of claim 18, wherein the computer-readable medium further comprises programming instructions that, when executed by the processor, cause the electronic computation device to perform steps of:
receiving a second set of human communication data; and
outputting the second set of human communication data to one or more electromechanical devices.

20. The computer-readable medium of claim 18, wherein the computer-readable medium further comprises programming instructions that, when executed by the processor, cause the electronic computation device to perform steps of processing directional-based information that is obtained from a Simultaneous Localization and Mapping (SLAM) system.
